(19) United States
(12) Patent Application Publication
(10) Pub. No.: US 2023/0269779 A1
(43) Pub. Date: Aug. 24, 2023

(54) Random Access Process Enhancement

(71) Applicant: Alireza Babaei, Fairfax, VA (US)

(72) Inventor: Alireza Babaei, Fairfax, VA (US)

(21) Appl. No.: 18/109,323

(22) Filed: Feb. 14, 2023

Related U.S. Application Data
(60) Provisional application No. 63/309,968, filed on Feb. 14, 2022.

(51) Int. Cl. H04W 74/08

(52) U.S. Cl. CPC H04W 74/0833

(57) ABSTRACT

A wireless device may receive configuration parameter(s) indicating that a first random access occasion and a second random access occasion are used jointly in a random access process. In response to initiating the random access process and based on the configuration parameter(s): the wireless device may transmit a random access preamble in the first random access occasion and a random access preamble in the second random access occasion.

### CROSS-REFERENCE TO RELATED APPLICATIONS

This application claims the benefit of U.S. Provisional Application No. 63/309,968, filed Feb. 14, 2022, which is hereby incorporated by reference in its entirety.

### BRIEF DESCRIPTION OF THE DRAWINGS

FIG. 1A and FIG. 1B show examples of mobile communications systems in accordance with several of various embodiments of the present disclosure.

FIG. 2A and FIG. 2B show examples of user plane and control plane protocol layers in accordance with several of various embodiments of the present disclosure.

FIG. 3 shows example functions and services offered by protocol layers in a user plane protocol stack in accordance with several of various embodiments of the present disclosure.

FIG. 4 shows example flow of packets through the protocol layers in accordance with several of various embodiments of the present disclosure.

FIG. 5A shows example mapping of channels between layers of the protocol stack and different physical signals in downlink in accordance with several of various embodiments of the present disclosure.

FIG. 5B shows example mapping of channels between layers of the protocol stack and different physical signals in uplink in accordance with several of various embodiments of the present disclosure.

FIG. 6 shows example physical layer processes for signal transmission in accordance with several of various embodiments of the present disclosure.

FIG. 7 shows examples of RRC states and RRC state transitions in accordance with several of various embodiments of the present disclosure.

FIG. 8 shows an example time domain transmission structure in NR by grouping OFDM symbols into slots, subframes and frames in accordance with several of various embodiments of the present disclosure.

FIG. 9 shows an example of time-frequency resource grid in accordance with several of various embodiments of the present disclosure.

FIG. 10 shows example adaptation and switching of bandwidth parts in accordance with several of various embodiments of the present disclosure.

FIG. 11A shows example arrangements of carriers in carrier aggregation in accordance with several of various embodiments of the present disclosure.

FIG. 11B shows examples of uplink control channel groups in accordance with several of various embodiments of the present disclosure.

FIG. 12A, FIG. 12B and FIG. 12C show example random access processes in accordance with several of various embodiments of the present disclosure.

FIG. 13A shows example time and frequency structure of SSBs and their associations with beams in accordance with several of various embodiments of the present disclosure.

FIG. 13B shows example time and frequency structure of CSI-RSs and their association with beams in accordance with several of various embodiments of the present disclosure.

FIG. 14A, FIG. 14B and FIG. 14C show example beam management processes in accordance with several of various embodiments of the present disclosure.

FIG. 15 shows example components of a wireless device and a base station that are in communication via an air interface in accordance with several of various embodiments of the present disclosure.

FIG. 16A shows an example random access occasion bundle/group with different uplink beams (e.g., spatial settings/filters) in accordance with several of various embodiments of the present disclosure.

FIG. 16B shows an example random access occasion bundle/group with the same uplink beam (e.g., spatial filter/setting) in accordance with several of various embodiments of the present disclosure.

FIG. 17 shows an example process in accordance with several of various embodiments of the present disclosure.

FIG. 18 shows an example process in accordance with several of various embodiments of the present disclosure.

FIG. 19 shows an example process in accordance with several of various embodiments of the present disclosure.

FIG. 20 shows an example process in accordance with several of various embodiments of the present disclosure.

FIG. 21 shows an example process in accordance with several of various embodiments of the present disclosure.

FIG. 22 shows an example process in accordance with several of various embodiments of the present disclosure.

FIG. 23 shows an example process in accordance with several of various embodiments of the present disclosure.

FIG. 24 shows an example process in accordance with several of various embodiments of the present disclosure.

FIG. 25 shows an example process in accordance with several of various embodiments of the present disclosure.

FIG. 26 shows an example process in accordance with several of various embodiments of the present disclosure.

FIG. 27 shows an example process in accordance with several of various embodiments of the present disclosure.

FIG. 28 shows an example process in accordance with several of various embodiments of the present disclosure.

FIG. 29 shows an example process in accordance with several of various embodiments of the present disclosure.

FIG. 30 shows an example process in accordance with several of various embodiments of the present disclosure.

FIG. 31 shows an example flow diagram in accordance with several of various embodiments of the present disclosure.

FIG. 32 shows an example flow diagram in accordance with several of various embodiments of the present disclosure.

FIG. 33 shows an example flow diagram in accordance with several of various embodiments of the present disclosure.

FIG. 34 shows an example flow diagram in accordance with several of various embodiments of the present disclosure.

FIG. 35 shows an example flow diagram in accordance with several of various embodiments of the present disclosure.

FIG. 36 shows an example flow diagram in accordance with several of various embodiments of the present disclosure.

FIG. 37 shows an example flow diagram in accordance with several of various embodiments of the present disclosure.

FIG. 38 shows an example flow diagram in accordance with several of various embodiments of the present disclosure.

FIG. 39 shows an example flow diagram in accordance with several of various embodiments of the present disclosure.

FIG. 40 shows an example flow diagram in accordance with several of various embodiments of the present disclosure.

FIG. 41 shows an example flow diagram in accordance with several of various embodiments of the present disclosure.

FIG. 42 shows an example flow diagram in accordance with several of various embodiments of the present disclosure.

### DETAILED DESCRIPTION

The exemplary embodiments of the disclosed technology enhance random access processes in a wireless device and/or one or more base stations. The exemplary disclosed embodiments may be implemented in the technical field of wireless communication systems. More particularly, the embodiments of the disclosed technology enhance random access processes by allowing multiple random access preambles transmission via the same or different transmit beams in response to the initiation of the random access process.

The devices and/or nodes of the mobile communications system disclosed herein may be implemented based on various technologies and/or various releases/versions/amendments of a technology. The various technologies include various releases of long-term evolution (LTE) technologies, various releases of 5G new radio (NR) technologies, various wireless local area networks technologies and/or a combination thereof and/or alike. For example, a base station may support a given technology and may communicate with wireless devices with different characteristics. The wireless devices may have different categories that define their capabilities in terms of supporting various features. The wireless device with the same category may have different capabilities. The wireless devices may support various technologies such as various releases of LTE technologies, various releases of 5G NR technologies and/or a combination thereof and/or alike. At least some of the wireless devices in the mobile communications system of the present disclosure may be stationary or almost stationary. In this disclosure, the terms “mobile communications system” and “wireless communications system” may be used interchangeably.

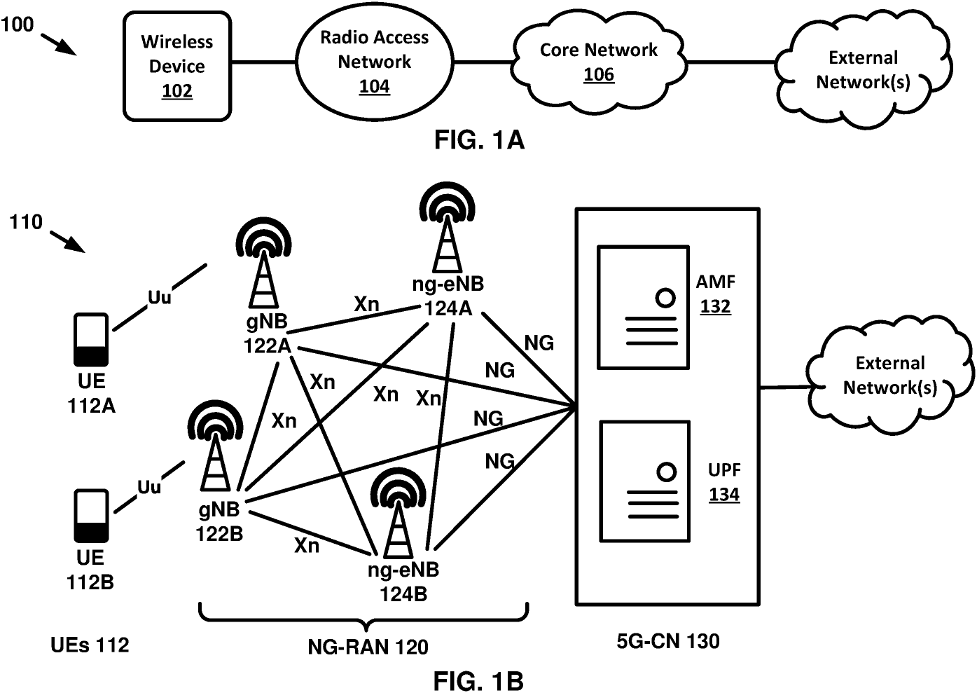

FIG. 1A shows an example of a mobile communications system 100 in accordance with several of various embodiments of the present disclosure. The mobile communications system 100 may be, for example, run by a mobile network operator (MNO) or a mobile virtual network operator (MVNO). The mobile communications system 100 may be a public land mobile network (PLMN) run by a network operator providing a variety of service including voice, data, short messaging service (SMS), multimedia messaging service (MMS), emergency calls, etc. The mobile communications system 100 includes a core network (CN) 106, a radio access network (RAN) 104 and at least one wireless device 102.

The CN 106 connects the RAN 104 to one or more external networks (e.g., one or more data networks such as the Internet) and is responsible for functions such as authentication, charging and end-to-end connection establishment. Several radio access technologies (RATs) may be served by the same CN 106.

The RAN 104 may implement a RAT and may operate between the at least one wireless device 102 and the CN 106. The RAN 104 may handle radio related functionalities such as scheduling, radio resource control, modulation and coding, multi-antenna transmissions and retransmission protocols. The wireless device and the RAN may share a portion of the radio spectrum by separating transmissions from the wireless device to the RAN and the transmissions from the RAN to the wireless device. The direction of the transmissions from the wireless device to the RAN is known as the uplink and the direction of the transmissions from the RAN to the wireless device is known as the downlink. The separation of uplink and downlink transmissions may be achieved by employing a duplexing technique. Example duplexing techniques include frequency division duplexing (FDD), time division duplexing (TDD) or a combination of FDD and TDD.

In this disclosure, the term wireless device may refer to a device that communicates with a network entity or another device using wireless communication techniques. The wireless device may be a mobile device or a non-mobile (e.g., fixed) device. Examples of the wireless device include cellular phone, smart phone, tablet, laptop computer, wearable device (e.g., smart watch, smart shoe, fitness trackers, smart clothing, etc.), wireless sensor, wireless meter, extended reality (XR) devices including augmented reality (AR) and virtual reality (VR) devices, Internet of Things (IoT) device, vehicle to vehicle communications device, road-side units (RSU), automobile, relay node or any combination thereof. In some examples, the wireless device (e.g., a smart phone, tablet, etc.) may have an interface (e.g., a graphical user interface (GUI)) for configuration by an end user. In some examples, the wireless device (e.g., a wireless sensor device, etc.) may not have an interface for configuration by an end user. The wireless device may be referred to as a user equipment (UE), a mobile station (MS), a subscriber unit, a handset, an access terminal, a user terminal, a wireless transmit and receive unit (WTRU) and/or other terminology.

The at least one wireless device may communicate with at least one base station in the RAN 104. In this disclosure, the term base station may encompass terminologies associated with various RATs. For example, a base station may be referred to as a Node B in a 3G cellular system such as Universal Mobile Telecommunication Systems (UMTS), an evolved Node B (eNB) in a 4G cellular system such as evolved universal terrestrial radio access (E-UTRA), a next generation eNB (ng-eNB), a Next Generation Node B (gNB) in NR and/or a 5G system, an access point (AP) in Wi-Fi and/or other wireless local area networks. A base station may be referred to as a remote radio head (RRH), a baseband unit (BBU) in connection with one or more RRHs, a repeater or relay for coverage extension and/or any combination thereof. In some examples, all protocol layers of a base station may be implemented in one unit. In some examples, some of the protocol layers (e.g., upper layers) of the base station may be implemented in a first unit (e.g., a central unit (CU)) and some other protocol layer (e.g., lower layers) may be implemented in one or more second units (e.g., distributed units (DUs)).

A base station in the RAN 104 includes one or more antennas to communicate with the at least one wireless device. The base station may communicate with the at least one wireless device using radio frequency (RF) transmissions and receptions via RF transceivers. The base station antennas may control one or more cells (or sectors). The size and/or radio coverage area of a cell may depend on the range that transmissions by a wireless device can be successfully received by the base station when the wireless device transmits using the RF frequency of the cell. The base station may be associated with cells of various sizes. At a given location, the wireless device may be in coverage area of a first cell of the base station and may not be in coverage area of a second cell of the base station depending on the sizes of the first cell and the second cell.

A base station in the RAN 104 may have various implementations. For example, a base station may be implemented by connecting a BBU (or a BBU pool) coupled to one or more RRHs and/or one or more relay nodes to extend the cell coverage. The BBU pool may be located at a centralized site like a cloud or data center. The BBU pool may be connected to a plurality of RRHs that control a plurality of cells. The combination of BBU with the one or more RRHs may be referred to as a centralized or cloud RAN (C-RAN) architecture. In some implementations, the BBU functions may be implemented on virtual machines (VMs) on servers at a centralized location. This architecture may be referred to as virtual RAN (vRAN). All, most or a portion of the protocol layer functions (e.g., all or portions of physical layer, medium access control (MAC) layer and/or higher layers) may be implemented at the BBU pool and the processed data may be transmitted to the RRHs for further processing and/or RF transmission. The links between the BBU pool and the RRHs may be referred to as fronthaul.

In some deployment scenarios, the RAN 104 may include macrocell base stations with high transmission power levels and large coverage areas. In other deployment scenarios, the RAN 104 may include base stations that employ different transmission power levels and/or have cells with different coverage areas. For example, some base station may be macrocell base stations with high transmission powers and /or large coverage areas and other base station may be small cell base stations with comparatively smaller transmission powers and/or coverage areas. In some deployment scenarios, a small cell base station may have coverage that is within or has overlap with coverage area of a macrocell base station. A wireless device may communicate with the macrocell base station while within the coverage area of the macrocell base station. For additional capacity, the wireless device may communicate with both the macrocell base station and the small cell base station while in the overlapped coverage area of the macrocell base station and the small cell base station. Depending on their coverage areas, a small cell base station may be referred to as a microcell base station, a picocell base station, a femtocell base station or a home base station.

Different standard development organizations (SDOs) have specified, or may specify in future, mobile communications systems that have similar characteristics as the mobile communications system 100 of FIG. 1A. For example, the Third-Generation Partnership Project (3GPP) is a group of SDOs that provides specifications that define 3GPP technologies for mobile communications systems that are akin to the mobile communications system 100. The 3GPP has developed specifications for third generation (3G) mobile networks, fourth generation (4G) mobile networks and fifth generation (5G) mobile networks. The 3G, 4G and 5G networks are also known as Universal Mobile Telecommunications System (UMTS), Long Term Evolution (LTE) and 5G system (5GS), respectively. In this disclosure, embodiments are described with respect to the RAN implemented in a 3GPP 5G mobile network that is also referred to as next generation RAN (NG-RAN). The embodiments may also be implemented in other mobile communications systems such as 3G or 4G mobile networks or mobile networks that may be standardized in future such as sixth generation (6G) mobile networks or mobile networks that are implemented by standards bodies other than 3GPP. The NG-RAN may be based on a new RAT known as new radio (NR) and/or other radio access technologies such as LTE and/or non-3GPP RATs.

FIG. 1B shows an example of a mobile communications system 110 in accordance with several of various embodiments of the present disclosure. The mobile communications system 110 of FIG. 1B is an example of a 5G mobile network and includes a 5G CN (5G-CN) 130, an NG-RAN 120 and UEs (collectively 112 and individually UE 112A and UE 112B). The 5G-CN 130, the NG-RAN 120 and the UEs 112 of FIG. 1B operate substantially alike the CN 106, the RAN 104 and the at least one wireless device 102, respectively, as described for FIG. 1A.

The 5G-CN 130 of FIG. 1B connects the NG-RAN 120 to one or more external networks (e.g., one or more data networks such as the Internet) and is responsible for functions such as authentication, charging and end-to-end connection establishment. The 5G-CN has new enhancements compared to previous generations of CNs (e.g., evolved packet core (EPC) in the 4G networks) including service-based architecture, support for network slicing and control plane/user plane split. The service-based architecture of the 5G-CN provides a modular framework based on service and functionalities provided by the core network wherein a set of network functions are connected via service-based interfaces. The network slicing enables multiplexing of independent logical networks (e.g., network slices) on the same physical network infrastructure. For example, a network slice may be for mobile broadband applications with full mobility support and a different network slice may be for non-mobile latency-critical applications such as industry automation. The control plane/user plane split enables independent scaling of the control plane and the user plane. For example, the control plane capacity may be increased without affecting the user plane of the network.

The 5G-CN 130 of FIG. 1B includes an access and mobility management function (AMF) 132 and a user plane function (UPF) 134. The AMF 132 may support termination of non-access stratum (NAS) signaling, NAS signaling security such as ciphering and integrity protection, inter-3GPP access network mobility, registration management, connection management, mobility management, access authentication and authorization and security context management. The NAS is a functional layer between a UE and the CN and the access stratum (AS) is a functional layer between the UE and the RAN. The UPF 134 may serve as an interconnect point between the NG-RAN and an external data network. The UPF may support packet routing and forwarding, packet inspection and Quality of Service (QoS) handling and packet filtering. The UPF may further act as a Protocol Data Unit (PDU) session anchor point for mobility within and between RATs.

The 5G-CN 130 may include additional network functions (not shown in FIG. 1B) such as one or more Session Management Functions (SMFs), a Policy Control Function (PCF), a Network Exposure Function (NEF), a Unified Data Management (UDM), an Application Function (AF), and/or an Authentication Server Function (AUSF). These network functions along with the AMF 132 and UPF 134 enable a service-based architecture for the 5G-CN.

The NG-RAN 120 may operate between the UEs 112 and the 5G-CN 130 and may implement one or more RATs. The NG-RAN 120 may include one or more gNBs (e.g., gNB 122A or gNB 122B or collectively gNBs 122) and/or one or more ng-eNBs (e.g., ng-eNB 124A or ng-eNB 124B or collectively ng-eNBs 124). The general terminology for gNBs 122 and/or an ng-eNBs 124 is a base station and may be used interchangeably in this disclosure. The gNBs 122 and the ng-eNBs 124 may include one or more antennas to communicate with the UEs 112. The one or more antennas of the gNBs 122 or ng-eNBs 124 may control one or more cells (or sectors) that provide radio coverage for the UEs 112.

A gNB and/or an ng-eNB of FIG. 1B may be connected to the 5G-CN 130 using an NG interface. A gNB and/or an ng-eNB may be connected with other gNBs and/or ng-eNBs using an Xn interface. The NG or the Xn interfaces are logical connections that may be established using an underlying transport network. The interface between a UE and a gNB or between a UE and an ng-eNBs may be referred to as the Uu interface. An interface (e.g., Uu, NG or Xn) may be established by using a protocol stack that enables data and control signaling exchange between entities in the mobile communications system of FIG. 1B. When a protocol stack is used for transmission of user data, the protocol stack may be referred to as user plane protocol stack. When a protocol stack is used for transmission of control signaling, the protocol stack may be referred to as control plane protocol stack. Some protocol layer may be used in both of the user plane protocol stack and the control plane protocol stack while other protocol layers may be specific to the user plane or control plane.

The NG interface of FIG. 1B may include an NG-User plane (NG-U) interface between a gNB and the UPF 134 (or an ng-eNB and the UPF 134) and an NG-Control plane (NG-C) interface between a gNB and the AMF 132 (or an ng-eNB and the AMF 132). The NG-U interface may provide non-guaranteed delivery of user plane PDUs between a gNB and the UPF or an ng-eNB and the UPF. The NG-C interface may provide services such as NG interface management, UE context management, UE mobility management, transport of NAS messages, paging, PDU session management, configuration transfer and/or warning message transmission.

The UEs 112 and a gNB may be connected using the Uu interface and using the NR user plane and control plane protocol stack. The UEs 112 and an ng-eNB may be connected using the Uu interface using the LTE user plane and control plane protocol stack.

In the example mobile communications system of FIG. 1B, a 5G-CN is connected to a RAN comprised of 4G LTE and/or 5G NR RATs. In other example mobile communications systems, a RAN based on the 5G NR RAT may be connected to a 4G CN (e.g., EPC). For example, earlier releases of 5G standards may support a non-standalone mode of operation where a NR based RAN is connected to the 4G EPC. In an example non-standalone mode, a UE may be connected to both a 5G NR gNB and a 4G LTE eNB (e.g., a ng-eNB) and the control plane functionalities (such as initial access, paging and mobility) may be provided through the 4G LTE eNB. In a standalone operation, the 5G NR gNB is connected to a 5G-CN and the user plane and the control plane functionalities are provided by the 5G NR gNB.

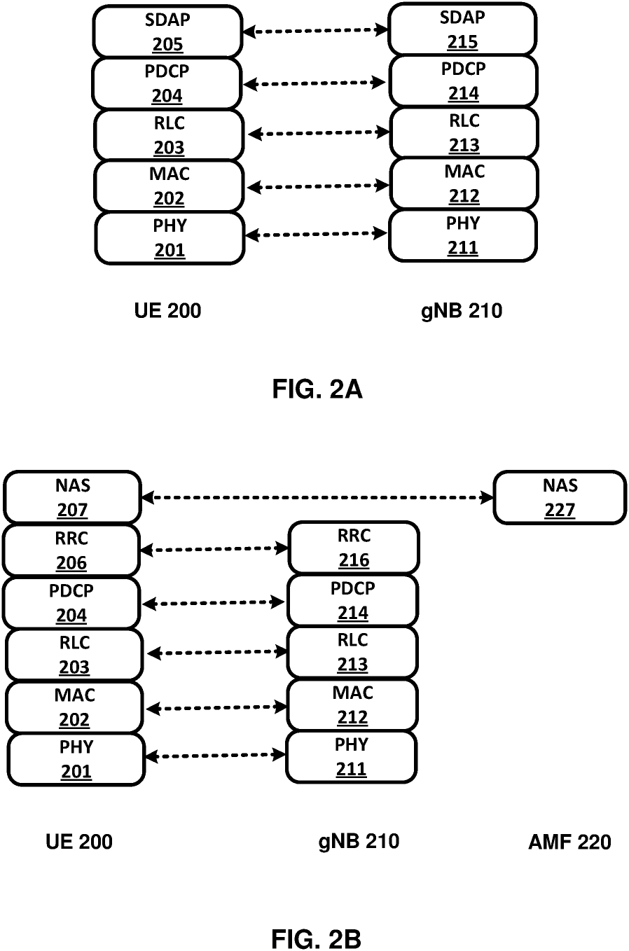

FIG. 2A shows an example of the protocol stack for the user plan of an NR Uu interface in accordance with several of various embodiments of the present disclosure. The user plane protocol stack comprises five protocol layers that terminate at the UE 200 and the gNB 210. The five protocol layers, as shown in FIG. 2A, include physical (PHY) layer referred to as PHY 201 at the UE 200 and PHY 211 at the gNB 210, medium access control (MAC) layer referred to as MAC 202 at the UE 200 and MAC 212 at the gNB 210, radio link control (RLC) layer referred to as RLC 203 at the UE 200 and RLC 213 at the gNB 210, packet data convergence protocol (PDCP) layer referred to as PDCP 204 at the UE 200 and PDCP 214 at the gNB 210, and service data application protocol (SDAP) layer referred to as SDAP 205 at the UE 200 and SDAP 215 at the gNB 210. The PHY layer, also known as layer 1 (L1), offers transport services to higher layers. The other four layers of the protocol stack (MAC, RLC, PDCP and SDAP) are collectively known as layer 2 (L2).

FIG. 2B shows an example of the protocol stack for the control plan of an NR Uu interface in accordance with several of various embodiments of the present disclosure. Some of the protocol layers (PHY, MAC, RLC and PDCP) are common between the user plane protocol stack shown in FIG. 2A and the control plan protocol stack. The control plane protocol stack also includes the RRC layer, referred to RRC 206 at the UE 200 and RRC 216 at the gNB 210, that also terminates at the UE 200 and the gNB 210. In addition, the control plane protocol stack includes the NAS layer that terminates at the UE 200 and the AMF 220. In FIG. 2B, the NAS layer is referred to as NAS 207 at the UE 200 and NAS 227 at the AMF 220.

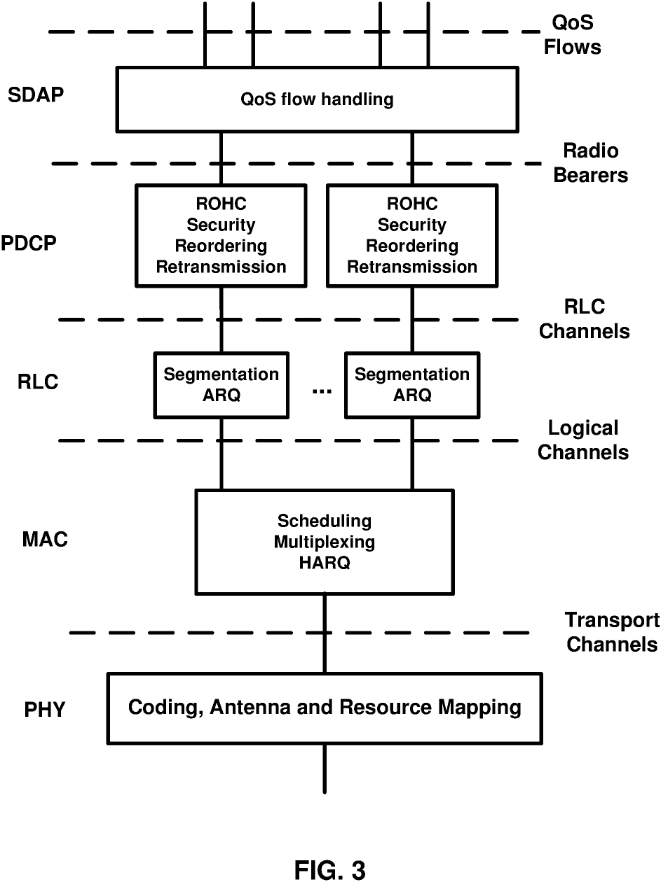

FIG. 3 shows example functions and services offered to other layers by a layer in the NR user plane protocol stack of FIG. 2A in accordance with several of various embodiments of the present disclosure. For example, the SDAP layer of FIG. 3 (shown in FIG. 2A as SDAP 205 at the UE side and SDAP 215 at the gNB side) may perform mapping and de-mapping of QoS flows to data radio bearers. The mapping and de-mapping may be based on QoS (e.g., delay, throughput, jitter, error rate, etc.) associated with a QoS flow. A QoS flow may be a QoS differentiation granularity for a PDU session which is a logical connection between a UE 200 and a data network. A PDU session may contain one or more QoS flows. The functions and services of the SDAP layer include mapping and de-mapping between one or more QoS flows and one or more data radio bearers. The SDAP layer may also mark the uplink and/or downlink packets with a QoS flow ID (QFI).

The PDCP layer of FIG. 3 (shown in FIG. 2A as PDCP 204 at the UE side and PDCP 214 at the gNB side) may perform header compression and decompression (e.g., using Robust Header Compression (ROHC) protocol) to reduce the protocol header overhead, ciphering and deciphering and integrity protection and verification to enhance the security over the air interface, reordering and in-order delivery of packets and discarding of duplicate packets. A UE may be configured with one PDCP entity per bearer.

In an example scenario not shown in FIG. 3, a UE may be configured with dual connectivity and may connect to two different cell groups provided by two different base stations. For example, a base station of the two base stations may be referred to as a master base station and a cell group provided by the master base station may be referred to as a master cell group (MCG). The other base station of the two base stations may be referred to as a secondary base station and the cell group provided by the secondary base station may be referred to as a secondary cell group (SCG). A bearer may be configured for the UE as a split bearer that may be handled by the two different cell groups. The PDCP layer may perform routing of packets corresponding to a split bearer to and/or from RLC channels associated with the cell groups.

In an example scenario not shown in FIG. 3, a bearer of the UE may be configured (e.g., with control signaling) with PDCP packet duplication. A bearer configured with PDCP duplication may be mapped to a plurality of RLC channels each corresponding to different one or more cells. The PDCP layer may duplicate packets of the bearer configured with PDCP duplication and the duplicated packets may be mapped to the different RLC channels. With PDCP packet duplication, the likelihood of correct reception of packets increases thereby enabling higher reliability.

The RLC layer of FIG. 3 (shown in FIG. 2A as RLC 203 at the UE side and RLC 213 at the gNB side) provides service to upper layers in the form of RLC channels. The RLC layer may include three transmission modes: transparent mode (TM), Unacknowledged mode (UM) and Acknowledged mode (AM). The RLC layer may perform error correction through automatic repeat request (ARQ) for the AM transmission mode, segmentation of RLC service data units (SDUs) for the AM and UM transmission modes and re-segmentation of RLC SDUs for AM transmission mode, duplicate detection for the AM transmission mode, RLC SDU discard for the AM and UM transmission modes, etc. The UE may be configured with one RLC entity per RLC channel.

The MAC layer of FIG. 3 (shown in FIG. 2A as MAC 202 at the UE side and MAC 212 at the gNB side) provides services to the RLC layer in form of logical channels. The MAC layer may perform mapping between logical channels and transport channels, multiplexing/demultiplexing of MAC SDUs belonging to one or more logical channels into/from transport blocks (TBs) delivered to/from the physical layer on transport channels, reporting of scheduling information, error correction through hybrid automatic repeat request (HARQ), priority handling between UEs by means of dynamic scheduling, priority handling between logical channels of one UE by means of logical channel prioritization and/or padding. In case of carrier aggregation, a MAC entity may comprise one HARQ entity per cell. A MAC entity may support multiple numerologies, transmission timings and cells. The control signaling may configure logical channels with mapping restrictions. The mapping restrictions in logical channel prioritization may control the numerology(ies), cell(s), and/or transmission timing(s)/duration(s) that a logical channel may use.

The PHY layer of FIG. 3 (shown in FIG. 2A as PHY 201 at the UE side and PHY 211 at the gNB side) provides transport services to the MAC layer in form of transport channels. The physical layer may handle coding/decoding, HARQ soft combining, rate matching of a coded transport channel to physical channels, mapping of coded transport channels to physical channels, modulation and demodulation of physical channels, frequency and time synchronization, radio characteristics measurements and indication to higher layers, RF processing, and mapping to antennas and radio resources.

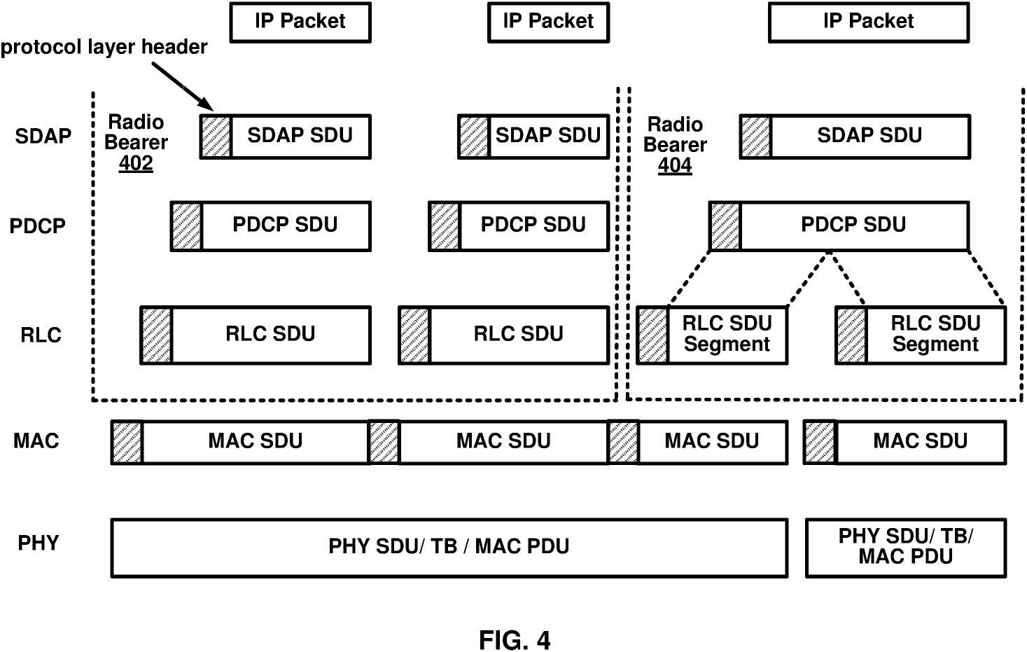

FIG. 4 shows example processing of packets at different protocol layers in accordance with several of various embodiments of the present disclosure. In this example, three Internet Protocol (IP) packets that are processed by the different layers of the NR protocol stack. The term SDU shown in FIG. 4 is the data unit that is entered from/to a higher layer. In contrast, a protocol data unit (PDU) is the data unit that is entered to/from a lower layer. The flow of packets in FIG. 4 is for downlink. An uplink data flow through layers of the NR protocol stack is similar to FIG. 4. In this example, the two leftmost IP packets are mapped by the SDAP layer (shown as SDAP 205 and SDAP 215 in FIG. 2A) to radio bearer 402 and the rightmost packet is mapped by the SDAP layer to the radio bearer 404. The SDAP layer adds SDAP headers to the IP packets which are entered into the PDCP layer as PDCP SDUs. The PDCP layer is shown as PDCP 204 and PDCP 214 in FIG. 2A. The PDCP layer adds the PDCP headers to the PDCP SDUs which are entered into the RLC layer as RLC SDUs. The RLC layer is shown as RLC 203 and RLC 213 in FIG. 2A. An RLC SDU may be segmented at the RLC layer. The RLC layer adds RLC headers to the RLC SDUs after segmentation (if segmented) which are entered into the MAC layer as MAC SDUs. The MAC layer adds the MAC headers to the MAC SDUs and multiplexes one or more MAC SDUs to form a PHY SDU (also referred to as a transport block (TB) or a MAC PDU).

In FIG. 4, the MAC SDUs are multiplexed to form a transport block. The MAC layer may multiplex one or more MAC control elements (MAC CEs) with zero or more MAC SDUs to form a transport block. The MAC CEs may also be referred to as MAC commands or MAC layer control signaling and may be used for in-band control signaling. The MAC CEs may be transmitted by a base station to a UE (e.g., downlink MAC CEs) or by a UE to a base station (e.g., uplink MAC CEs). The MAC CEs may be used for transmission of information useful by a gNB for scheduling (e.g., buffer status report (BSR) or power headroom report (PHR)), activation/deactivation of one or more cells, activation/deactivation of configured radio resources for or one or more processes, activation/deactivation of one or more processes, indication of parameters used in one or more processes, etc.

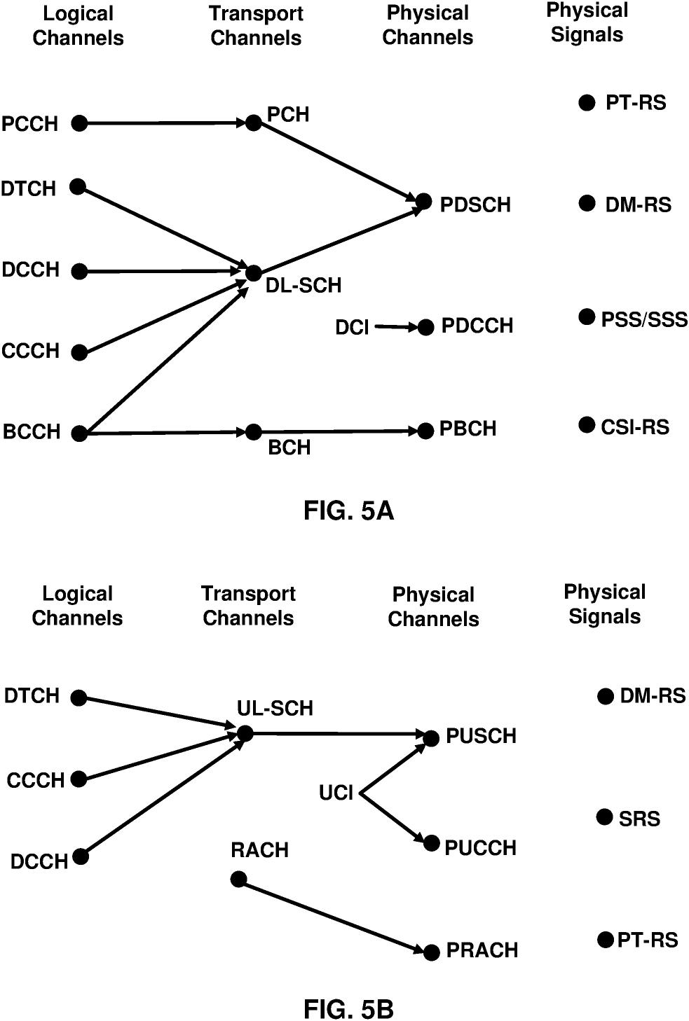

FIG. 5A and FIG. 5B show example mapping between logical channels, transport channels and physical channels for downlink and uplink, respectively in accordance with several of various embodiments of the present disclosure. As discussed before, the MAC layer provides services to higher layer in the form of logical channels. A logical channel may be classified as a control channel, if used for transmission of control and/or configuration information, or a traffic channel if used for transmission of user data. Example logical channels in NR include Broadcast Control Channel (BCCH) used for transmission of broadcast system control information, Paging Control Channel (PCCH) used for carrying paging messages for wireless devices with unknown locations, Common Control Channel (CCCH) used for transmission of control information between UEs and network and for UEs that have no RRC connection with the network, Dedicated Control Channel (DCCH) which is a point-to-point bi-directional channel for transmission of dedicated control information between a UE that has an RRC connection and the network and Dedicated Traffic Channel (DTCH) which is point-to-point channel, dedicated to one UE, for the transfer of user information and may exist in both uplink and downlink.

As discussed before, the PHY layer provides services to the MAC layer and higher layers in the form of transport channels. Example transport channels in NR include Broadcast Channel (BCH) used for transmission of part of the BCCH referred to as master information block (MIB), Downlink Shared Channel (DL-SCH) used for transmission of data (e.g., from DTCH in downlink) and various control information (e.g., from DCCH and CCCH in downlink and part of the BCCH that is not mapped to the BCH), Uplink Shared Channel (UL-SCH) used for transmission of uplink data (e.g., from DTCH in uplink) and control information (e.g., from CCCH and DCCH in uplink) and Paging Channel (PCH) used for transmission of paging information from the PCCH. In addition, Random Access Channel (RACH) is a transport channel used for transmission of random access preambles. The RACH does not carry a transport block. Data on a transport channel (except RACH) may be organized in transport blocks, wherein One or more transport blocks may be transmitted in a transmission time interval (TTI).

The PHY layer may map the transport channels to physical channels. A physical channel may correspond to time-frequency resources that are used for transmission of information from one or more transport channels. In addition to mapping transport channels to physical channels, the physical layer may generate control information (e.g., downlink control information (DCI) or uplink control information (UCI)) that may be carried by the physical channels. Example DCI include scheduling information (e.g., downlink assignments and uplink grants), request for channel state information report, power control command, etc. Example UCI include HARQ feedback indicating correct or incorrect reception of downlink transport blocks, channel state information report, scheduling request, etc. Example physical channels in NR include a Physical Broadcast Channel (PBCH) for carrying information from the BCH, a Physical Downlink Shared Channel (PDSCH) for carrying information form the PCH and the DL-SCH, a Physical Downlink Control Channel (PDCCH) for carrying DCI, a Physical Uplink Shared Channel (PUSCH) for carrying information from the UL-SCH and/or UCI, a Physical Uplink Control Channel (PUCCH) for carrying UCI and Physical Random Access Channel (PRACH) for transmission of RACH (e.g., random access preamble).

The PHY layer may also generate physical signals that are not originated from higher layers. As shown in FIG. 5A, example downlink physical signals include Demodulation Reference Signal (DM-RS), Phase Tracking Reference Signal (PT-RS), Channel State Information Reference Signal (CSI-RS), Primary Synchronization Signal (PSS) and Secondary Synchronization Signal (SSS). As shown in FIG. 5B, example uplink physical signals include DM-RS, PT-RS and sounding reference signal (SRS).

As indicated earlier, some of the protocol layers (PHY, MAC, RLC and PDCP) of the control plane of an NR Uu interface, are common between the user plane protocol stack (as shown in FIG. 2A) and the control plane protocol stack (as shown in FIG. 2B). In addition to PHY, MAC, RLC and PDCP, the control plane protocol stack includes the RRC protocol layer and the NAS protocol layer.

The NAS layer, as shown in FIG. 2B, terminates at the UE 200 and the AMF 220 entity of the 5G-C 130. The NAS layer is used for core network related functions and signaling including registration, authentication, location update and session management. The NAS layer uses services from the AS of the Uu interface to transmit the NAS messages.

The RRC layer, as shown in FIG. 2B, operates between the UE 200 and the gNB 210 (more generally NG-RAN 120) and may provide services and functions such as broadcast of system information (SI) related to AS and NAS as well as paging initiated by the 5G-C 130 or NG-RAN 120. In addition, the RRC layer is responsible for establishment, maintenance and release of an RRC connection between the UE 200 and the NG-RAN 120, carrier aggregation configuration (e.g., addition, modification and release), dual connectivity configuration (e.g., addition, modification and release), security related functions, radio bearer configuration/maintenance and release, mobility management (e.g., maintenance and context transfer), UE cell selection and reselection, inter-RAT mobility, QoS management functions, UE measurement reporting and control, radio link failure (RLF) detection and NAS message transfer. The RRC layer uses services from PHY, MAC, RLC and PDCP layers to transmit RRC messages using signaling radio bearers (SRBs). The SRBs are mapped to CCCH logical channel during connection establishment and to DCCH logical channel after connection establishment.

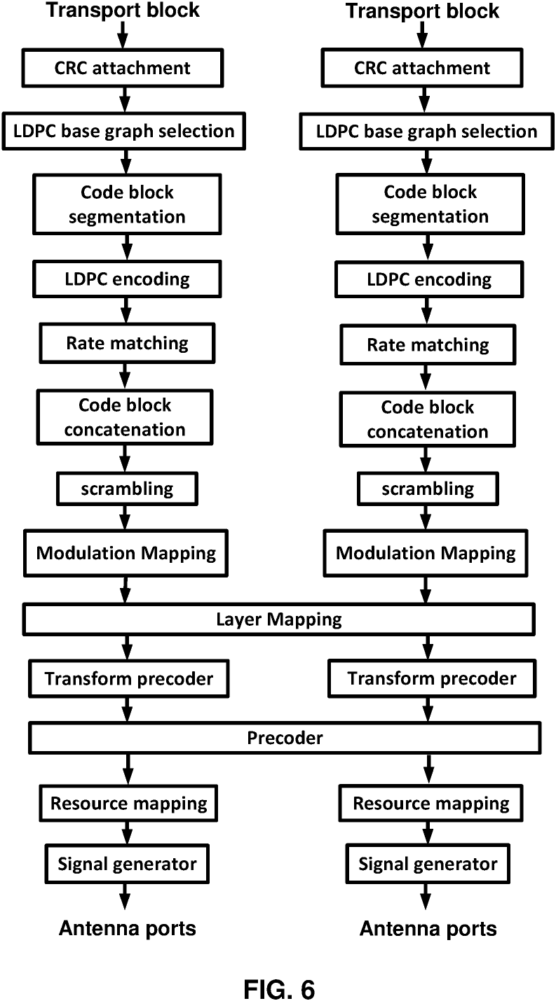

FIG. 6 shows example physical layer processes for signal transmission in accordance with several of various embodiments of the present disclosure. Data and/or control streams from MAC layer may be encoded/decoded to offer transport and control services over the radio transmission link. For example, one or more (e.g., two as shown in FIG. 6) transport blocks may be received from the MAC layer for transmission via a physical channel (e.g., a physical downlink shared channel or a physical uplink shared channel). A cyclic redundancy check (CRC) may be calculated and attached to a transport block in the physical layer. The CRC calculation may be based on one or more cyclic generator polynomials. The CRC may be used by the receiver for error detection. Following the transport block CRC attachment, a low-density parity check (LDPC) base graph selection may be performed. In example embodiments, two LDPC base graphs may be used wherein a first LDPC base graph may be optimized for small transport blocks and a second LDPC base graph may be optimized for comparatively larger transport blocks.

The transport block may be segmented into code blocks and code block CRC may be calculated and attached to a code block. A code block may be LDPC coded and the LDPC coded blocks may be individually rate matched. The code blocks may be concatenated to create one or more codewords. The contents of a codeword may be scrambled and modulated to generate a block of complex-valued modulation symbols. The modulation symbols may be mapped to a plurality of transmission layers (e.g., multiple-input multiple-output (MIMO) layers) and the transmission layers may be subject to transform precoding and/or precoding. The precoded complex-valued symbols may be mapped to radio resources (e.g., resource elements). The signal generator block may create a baseband signal and up-convert the baseband signal to a carrier frequency for transmission via antenna ports. The signal generator block may employ mixers, filters and/or other radio frequency (RF) components prior to transmission via the antennas. The functions and blocks in FIG. 6 are illustrated as examples and other mechanisms may be implemented in various embodiments.

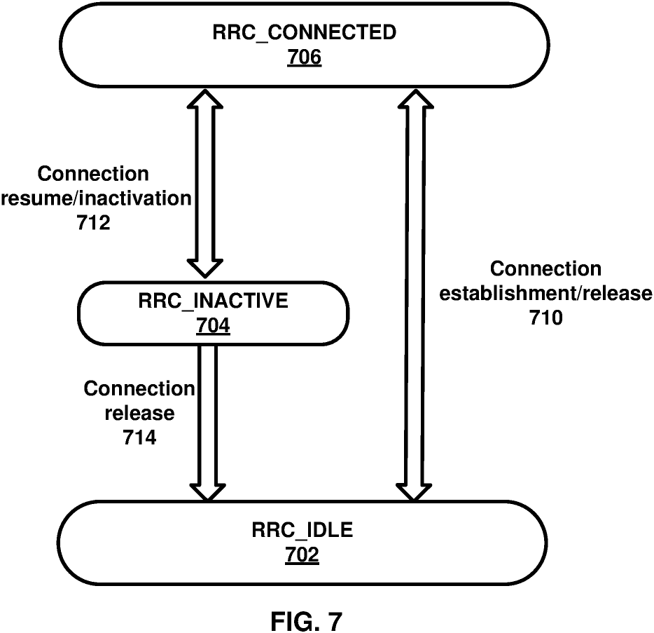

FIG. 7 shows examples of RRC states and RRC state transitions at a UE in accordance with several of various embodiments of the present disclosure. A UE may be in one of three RRC states: RRC_IDLE 702, RRC INACTIVE 704 and RRC_CONNECTED 706. In RRC_IDLE 702 state, no RRC context (e.g., parameters needed for communications between the UE and the network) may be established for the UE in the RAN. In RRC_IDLE 702 state, no data transfer between the UE and the network may take place and uplink synchronization is not maintained. The wireless device may sleep most of the time and may wake up periodically to receive paging messages. The uplink transmission of the UE may be based on a random access process and to enable transition to the RRC_CONNECTED 706 state. The mobility in RRC_IDLE 702 state is through a cell reselection procedure where the UE camps on a cell based on one or more criteria including signal strength that is determined based on the UE measurements.

In RRC_CONNECTED 706 state, the RRC context is established and both the UE and the RAN have necessary parameters to enable communications between the UE and the network. In the RRC_CONNECTED 706 state, the UE is configured with an identity known as a Cell Radio Network Temporary Identifier (C-RNTI) that is used for signaling purposes (e.g., uplink and downlink scheduling, etc.) between the UE and the RAN. The wireless device mobility in the RRC_CONNECTED 706 state is managed by the RAN. The wireless device provides neighboring cells and/or current serving cell measurements to the network and the network may make hand over decisions. Based on the wireless device measurements, the current serving base station may send a handover request message to a neighboring base station and may send a handover command to the wireless device to handover to a cell of the neighboring base station. The transition of the wireless device from the RRC_IDLE 702 state to the RRC_CONNECTED 706 state or from the RRC_CONNECTED 706 state to the RRC_IDLE 702 state may be based on connection establishment and connection release procedures (shown collectively as connection establishment/release 710 in FIG. 7).

To enable a faster transition to the RRC_CONNECTED 706 state (e.g., compared to transition from RRC_IDLE 702 state to RRC_CONNECTED 706 state), an RRC_INACTIVE 704 state is used for an NR UE wherein, the RRC context is kept at the UE and the RAN. The transition from the RRC_INACTIVE 704 state to the RRC_CONNECTED 706 state is handled by RAN without CN signaling. Similar to the RRC_IDLE 702 state, the mobility in RRC_INACTIVE 704 state is based on a cell reselection procedure without involvement from the network. The transition of the wireless device from the RRC_INACTIVE 704 state to the RRC_CONNECTED 706 state or from the RRC_CONNECTED 706 state to the RRC_INACTIVE 704 state may be based on connection resume and connection inactivation procedures (shown collectively as connection resume/inactivation 712 in FIG. 7). The transition of the wireless device from the RRC_INACTIVE 704 state to the RRC_IDLE 702 state may be based on a connection release 714 procedure as shown in FIG. 7.

In NR, Orthogonal Frequency Division Multiplexing (OFDM), also called cyclic prefix OFDM (CP-OFDM), is the baseline transmission scheme in both downlink and uplink of NR and the Discrete Fourier Transform (DFT) spread OFDM (DFT-s-OFDM) is a complementary uplink transmission in addition to the baseline OFDM scheme. OFDM is multi-carrier transmission scheme wherein the transmission bandwidth may be composed of several narrowband sub-carriers. The subcarriers are modulated by the complex valued OFDM modulation symbols resulting in an OFDM signal. The complex valued OFDM modulation symbols are obtained by mapping, by a modulation mapper, the input data (e.g., binary digits) to different points of a modulation constellation diagram. The modulation constellation diagram depends on the modulation scheme. NR may use different types of modulation schemes including Binary Phase Shift Keying (BPSK), π/2-BPSK, Quadrature Phase Shift Keying (QPSK), 16 Quadrature Amplitude Modulation (16QAM), 64QAM and 256QAM. Different and/or higher order modulation schemes (e.g., M-QAM in general) may be used. An OFDM signal with N subcarriers may be generated by processing N subcarriers in parallel for example by using Inverse Fast Fourier Transform (IFFT) processing. The OFDM receiver may use FFT processing to recover the transmitted OFDM modulation symbols. The subcarrier spacing of subcarriers in an OFDM signal is inversely proportional to an OFDM modulation symbol duration. For example, for a 15 KHz subcarrier spacing, duration of an OFDM signal is nearly 66.7 µs. To enhance the robustness of OFDM transmission in time dispersive channels, a cyclic prefix (CP) may be inserted at the beginning of an OFDM symbol. For example, the last part of an OFDM symbol may be copied and inserted at the beginning of an OFDM symbol. The CP insertion enhanced the OFDM transmission scheme by preserving subcarrier orthogonality in time dispersive channels.

In NR, different numerologies may be used for OFDM transmission. A numerology of OFDM transmission may indicate a subcarrier spacing and a CP duration for the OFDM transmission. For example, a subcarrier spacing in NR may generally be a multiple of 15 KHz and expressed as Δƒ = 2^{µ}.15 KHz (µ=0, 1, 2, ...). Example subcarrier spacings used in NR include 15 KHz (µ=0), 30 KHz (µ=1), 60 KHz (µ=2), 120 KHz (µ=3) and 240 KHz (µ=4). As discussed before, a duration of OFDM symbol is inversely proportional to the subcarrier spacing and therefor OFDM symbol duration may depend on the numerology (e.g., the µ value).

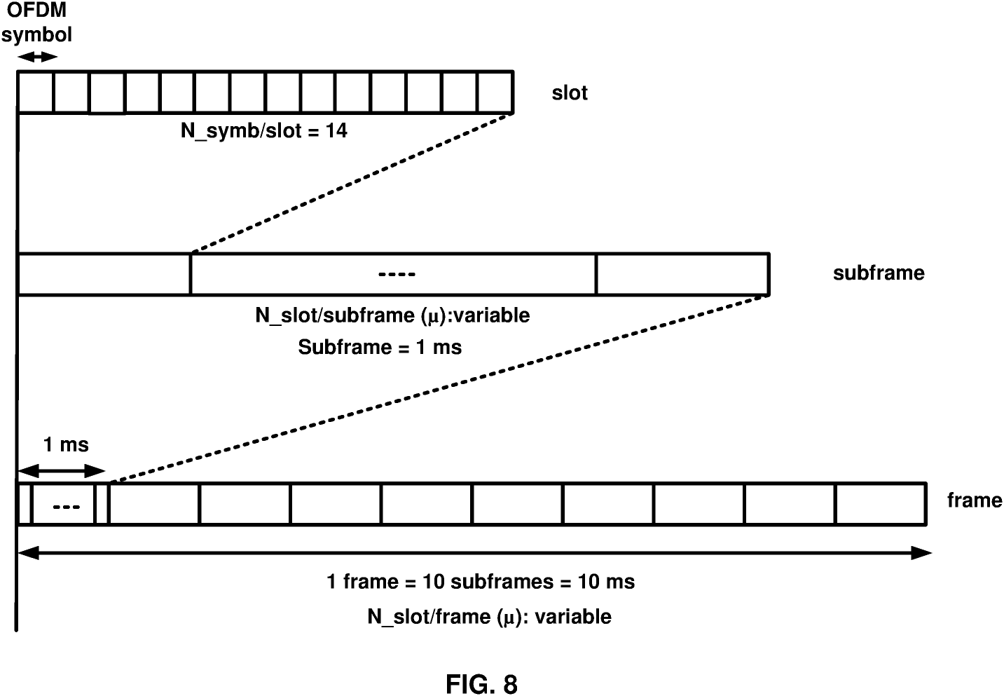

FIG. 8 shows an example time domain transmission structure in NR wherein OFDM symbols are grouped into slots, subframes and frames in accordance with several of various embodiments of the present disclosure. A slot is a group of

$${N}_{s y m b}^{s l o t}$$

OFDM symbols, wherein the

$${N}_{s y m b}^{s l o t}$$

may have a constant value (e.g., 14). Since different numerologies result in different OFDM symbol durations, duration of a slot may also depend on the numerology and may be variable. A subframe may have a duration of 1 ms and may be composed of one or more slots, the number of which may depend on the slot duration. The number of slots per subframe is therefore a function of µ and may generally expressed as

$${N}_{s l o t}^{s u b f r a m e , μ}$$

and the number of symbols per subframe may be expressed as

$${N}_{s l o t}^{s u b f r a m e , μ} = {N}_{s y m b}^{s l o t} {N}_{s l o t}^{s u b f r a m e , μ} .$$

A frame may have a duration of 10 ms and may consist of 10 subframes. The number of slots per frame may depend on the numerology and therefore may be variable. The number of slots per frame may generally be expressed as

$${N}_{s l o t}^{f r a m e , μ}$$

An antenna port may be defined as a logical entity such that channel characteristics over which a symbol on the antenna port is conveyed may be inferred from the channel characteristics over which another symbol on the same antenna port is conveyed. For example, for DM-RS associated with a PDSCH, the channel over which a PDSCH symbol on an antenna port is conveyed may be inferred from the channel over which a DM-RS symbol on the same antenna port is conveyed, for example, if the two symbols are within the same resource as the scheduled PDSCH and/or in the same slot and/or in the same precoding resource block group (PRG). For example, for DM-RS associated with a PDCCH, the channel over which a PDCCH symbol on an antenna port is conveyed may be inferred from the channel over which a DM-RS symbol on the same antenna port is conveyed if, for example, the two symbols are within resources for which the UE may assume the same precoding being used. For example, for DM-RS associated with a PBCH, the channel over which a PBCH symbol on one antenna port is conveyed may be inferred from the channel over which a DM-RS symbol on the same antenna port is conveyed if, for example, the two symbols are within a SS/PBCH block transmitted within the same slot, and with the same block index. The antenna port may be different from a physical antenna. An antenna port may be associated with an antenna port number and different physical channels may correspond to different ranges of antenna port numbers.

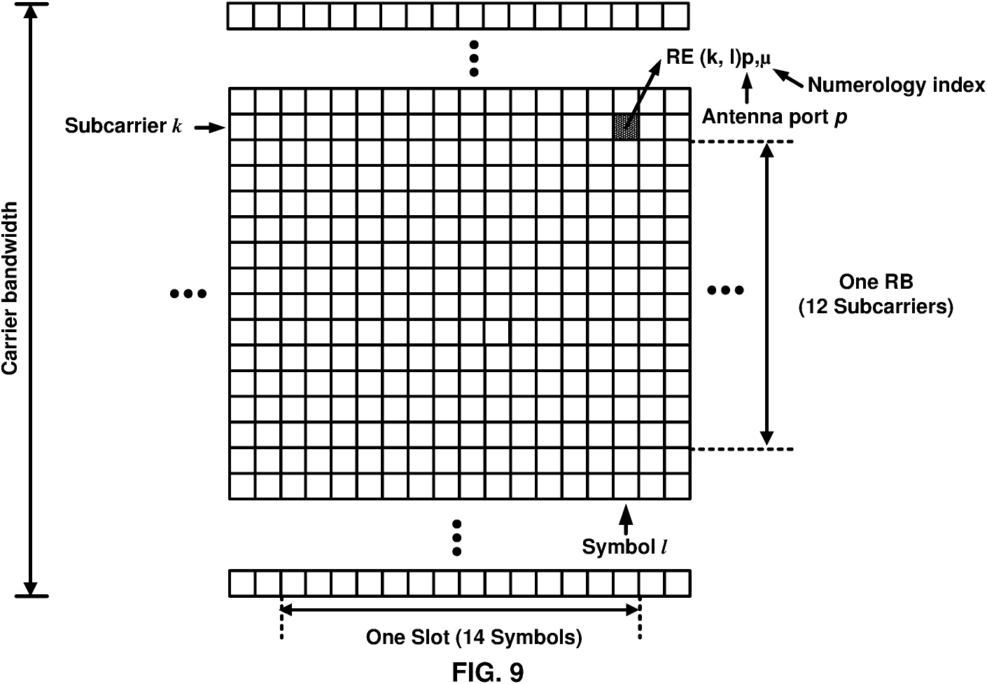

FIG. 9 shows an example of time-frequency resource grid in accordance with several of various embodiments of the present disclosure. The number of subcarriers in a carrier bandwidth may be based on the numerology of OFDM transmissions in the carrier. A resource element, corresponding to one symbol duration and one subcarrier, may be the smallest physical resource in the time-frequency grid. A resource element (RE) for antenna port p and subcarrier spacing configuration µ may be uniquely identified by (k,l)_{p,µ} where k is the index of a subcarrier in the frequency domain and 1 may refer to the symbol position in the time domain relative to some reference point. A resource block may be defined as

$${N}_{S C}^{R B} = 12$$

subcarriers. Since subcarrier spacing depends on the numerology of OFDM transmission, the frequency domain span of a resource block may be variable and may depend on the numerology. For example, for a subcarrier spacing of 15 KHz (e.g., µ=0), a resource block may be 180 KHz and for a subcarrier spacing of 30 KHz (e.g., µ=1), a resource block may be 360 KHz.

With large carrier bandwidths defined in NR and due to limited capabilities for some UEs (e.g., due to hardware limitations), a UE may not support an entire carrier bandwidth. Receiving on the full carrier bandwidth may imply high energy consumption. For example, transmitting downlink control channels on the full downlink carrier bandwidth may result in high power consumption for wide carrier bandwidths. NR may use a bandwidth adaptation procedure to dynamically adapt the transmit and receive bandwidths. The transmit and receive bandwidth of a UE on a cell may be smaller than the bandwidth of the cell and may be adjusted. For example, the width of the transmit and/or receive bandwidth may change (e.g., shrink during period of low activity to save power); the location of the transmit and/or receive bandwidth may move in the frequency domain (e.g., to increase scheduling flexibility); and the subcarrier spacing of the transmit or receive bandwidth may change (e.g., to allow different services). A subset of the cell bandwidth may be referred to as a Bandwidth Part (BWP) and bandwidth adaptation may be achieved by configuring the UE with one or more BWPs. The base station may configure a UE with a set of downlink BWPs and a set of uplink BWPs. A BWP may be characterized by a numerology (e.g., subcarrier spacing and cyclic prefix) and a set of consecutive resource blocks in the numerology of the BWP. One or more first BWPs of the one or more BWPs of the cell may be active at a time. An active BWP may be an active downlink BWP or an active uplink BWP.

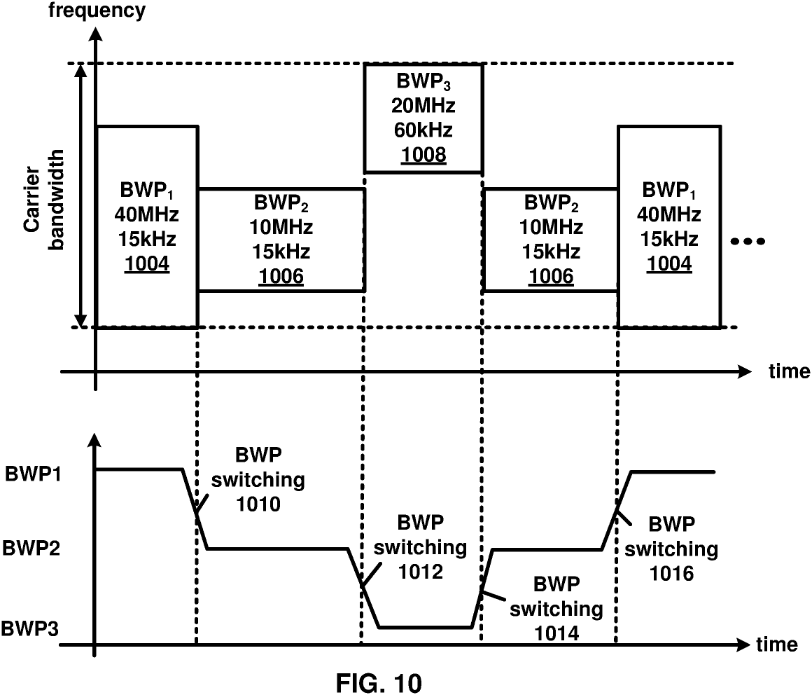

FIG. 10 shows an example of bandwidth part adaptation and switching. In this example, three BWPs (BWP₁ 1004, BWP₂ 1006 and BWP₃ 1008) are configured for a UE on a carrier bandwidth. The BWP₁ is configured with a bandwidth of 40 MHz and a numerology with subcarrier spacing of 15 KHz, the BWP₂ is configured with a bandwidth of 10 MHz and a numerology with subcarrier spacing of 15 KHz and the BWP₃ is configured with a bandwidth of 20 MHz and a subcarrier spacing of 60 KHz. The wireless device may switch from a first BWP (e.g., BWP₁) to a second BWP (e.g., BWP₂). An active BWP of the cell may change from the first BWP to the second BWP in response to the BWP switching.

The BWP switching (e.g., BWP switching 1010, BWP switching 1012, BWP switching 1014, or BWP switching 1016 in FIG. 10) may be based on a command from the base station. The command may be a DCI comprising scheduling information for the UE in the second BWP. In case of uplink BWP switching, the first BWP and the second BWP may be uplink BWPs and the scheduling information may be an uplink grant for uplink transmission via the second BWP. In case of downlink BWP switching, the first BWP and the second BWP may be downlink BWPs and the scheduling information may be a downlink assignment for downlink reception via the second BWP.

The BWP switching (e.g., BWP switching 1010, BWP switching 1012, BWP switching 1014, or BWP switching 1016 in FIG. 10) may be based on an expiry of a timer. The base station may configure a wireless device with a BWP inactivity timer and the wireless device may switch to a default BWP (e.g., default downlink BWP) based on the expiry of the BWP inactivity timer. The expiry of the BWP inactivity timer may be an indication of low activity on the current active downlink BWP. The base station may configure the wireless device with the default downlink BWP. If the base station does not configure the wireless device with the default BWP, the default BWP may be an initial downlink BWP. The initial active BWP may be the BWP that the wireless device receives scheduling information for remaining system information upon transition to an RRC_CONNECTED state.

A wireless device may monitor a downlink control channel of a downlink BWP. For example, the UE may monitor a set of PDCCH candidates in configured monitoring occasions in one or more configured COntrol REsource SETs (CORESETs) according to the corresponding search space configurations. A search space configuration may define how/where to search for PDCCH candidates. For example, the search space configuration parameters may comprise a monitoring periodicity and offset parameter indicating the slots for monitoring the PDCCH candidates. The search space configuration parameters may further comprise a parameter indicating a first symbol with a slot within the slots determined for monitoring PDCCH candidates. A search space may be associated with one or more CORESETs and the search space configuration may indicate one or more identifiers of the one or more CORESETs. The search space configuration parameters may further indicate that whether the search space is a common search space or a UE-specific search space. A common search space may be monitored by a plurality of wireless devices and a UE-specific search space may be dedicated to a specific UE.

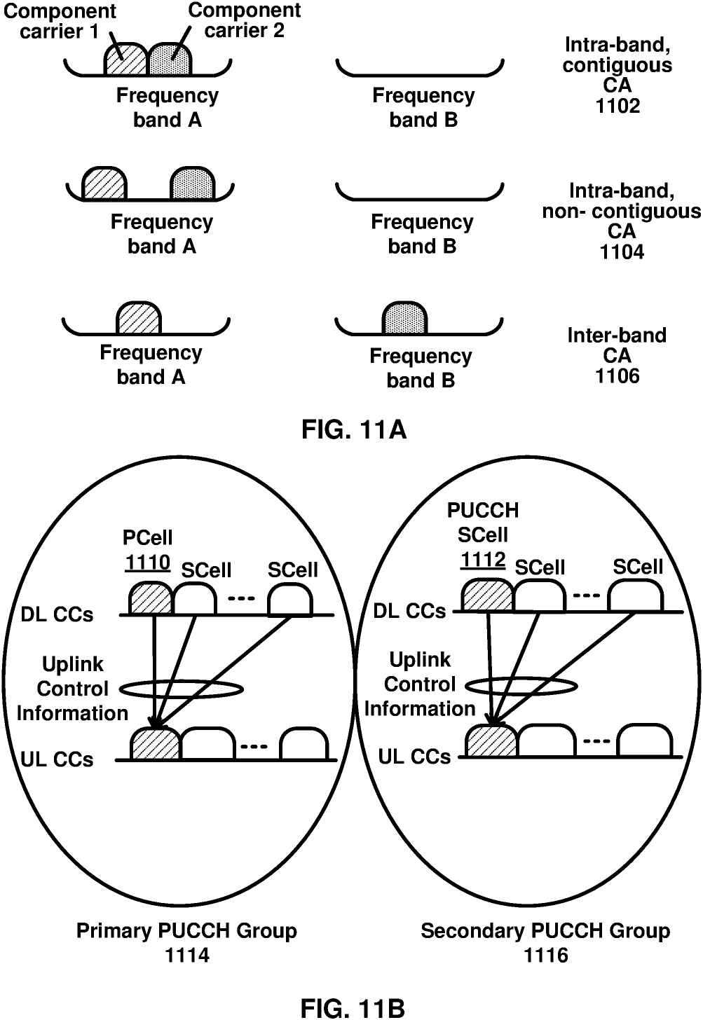

FIG. 11A shows example arrangements of carriers in carrier aggregation in accordance with several of various embodiments of the present disclosure. With carrier aggregation, multiple NR component carriers (CCs) may be aggregated. Downlink transmissions to a wireless device may take place simultaneously on the aggregated downlink CCs resulting in higher downlink data rates. Uplink transmissions from a wireless device may take place simultaneously on the aggregated uplink CCs resulting in higher uplink data rates. The component carriers in carrier aggregation may be on the same frequency band (e.g., intra-band carrier aggregation) or on different frequency bands (e.g., inter-band carrier aggregation). The component carriers may also be contiguous or non-contiguous. This results in three possible carrier aggregation scenarios, intra-band contiguous CA 1102, intra-band non-contiguous CA 1104 and inter-band CA 1106 as shown in FIG. 11A. Depending on the UE capability for carrier aggregation, a UE may transmit and/or receive on multiple carriers or for a UE that is not capable of carrier aggregation, the UE may transmit and/or receive on one component carrier at a time. In this disclosure, the carrier aggregation is described using the term cell and a carrier aggregation capable UE may transmit and/or receive via multiple cells.

In carrier aggregation, a UE may be configured with multiple cells. A cell of the multiple cells configured for the UE may be referred to as a Primary Cell (PCell). The PCell may be the first cell that the UE is initially connected to. One or more other cells configured for the UE may be referred to as Secondary Cells (SCells). The base station may configure a UE with multiple SCells. The configured SCells may be deactivated upon configuration and the base station may dynamically activate or deactivate one or more of the configured SCells based on traffic and/or channel conditions. The base station may activate or deactivate configured SCells using a SCell Activation/Deactivation MAC CE. The SCell Activation/Deactivation MAC CE may comprise a bitmap, wherein each bit in the bitmap may correspond to a SCell and the value of the bit indicates an activation status or deactivation status of the SCell.

An SCell may also be deactivated in response to expiry of a SCell deactivation timer of the SCell. The expiry of an SCell deactivation timer of an SCell may be an indication of low activity (e.g., low transmission or reception activity) on the SCell. The base station may configure the SCell with an SCell deactivation timer. The base station may not configure an SCell deactivation timer for an SCell that is configured with PUCCH (also referred to as a PUCCH SCell). The configuration of the SCell deactivation timer may be per configured SCell and different SCells may be configured with different SCell deactivation timer values. The SCell deactivation timer may be restarted based on one or more criteria including reception of downlink control information on the SCell indicating uplink grant or downlink assignment for the SCell or reception of downlink control information on a scheduling cell indicating uplink grant or downlink assignment for the SCell or transmission of a MAC PDU based on a configured uplink grant or reception of a configured downlink assignment.

A PCell for a UE may be an SCell for another UE and a SCell for a UE may be PCell for another UE. The configuration of PCell may be UE-specific. One or more SCells of the multiple SCells configured for a UE may be configured as downlink-only SCells, e.g., may only be used for downlink reception and may not be used for uplink transmission. In case of self-scheduling, the base station may transmit signaling for uplink grants and/or downlink assignments on the same cell that the corresponding uplink or downlink transmission takes place. In case of cross-carrier scheduling, the base station may transmit signaling for uplink grants and/or downlink assignments on a cell different from the cell that the corresponding uplink or downlink transmission takes place.

FIG. 11B shows examples of uplink control channel groups in accordance with several of various embodiments of the present disclosure. A base station may configure a UE with multiple PUCCH groups wherein a PUCCH group comprises one or more cells. For example, as shown in FIG. 11B, the base station may configure a UE with a primary PUCCH group 1114 and a secondary PUCCH group 1116. The primary PUCCH group may comprise the PCell 1110 and one or more first SCells. First UCI corresponding to the PCell and the one or more first SCells of the primary PUCCH group may be transmitted by the PUCCH of the PCell. The first UCI may be, for example, HARQ feedback for downlink transmissions via downlink CCs of the PCell and the one or more first SCells. The secondary PUCCH group may comprise a PUCCH SCell and one or more second SCells. Second UCI corresponding to the PUCCH SCell and the one or more second SCells of the secondary PUCCH group may be transmitted by the PUCCH of the PUCCH SCell. The second UCI may be, for example, HARQ feedback for downlink transmissions via downlink CCs of the PUCCH SCell and the one or more second SCells.

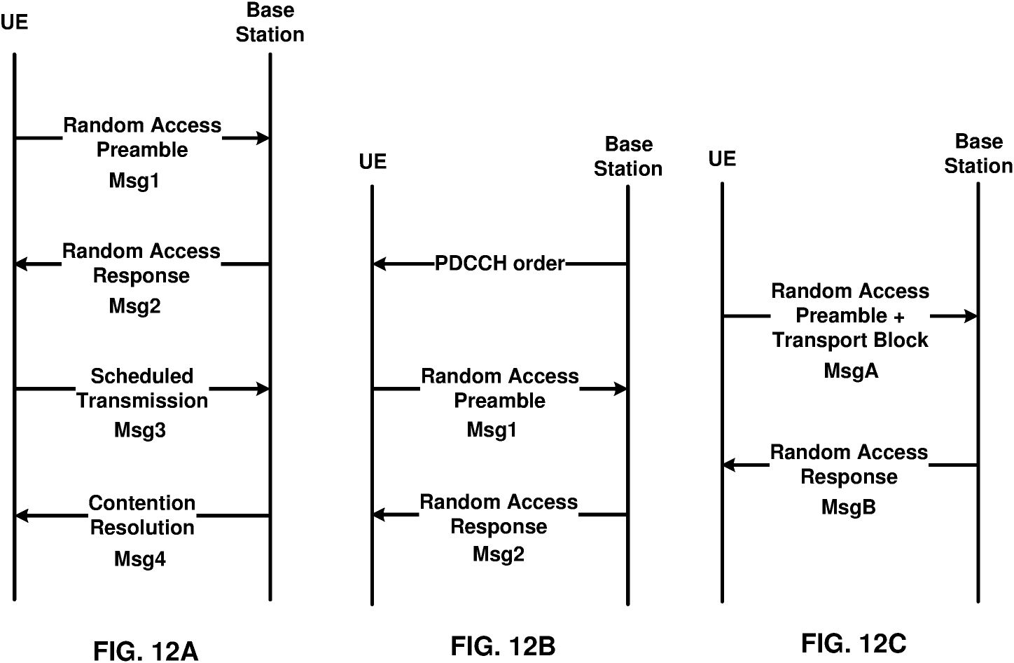

FIG. 12A, FIG. 12B and FIG. 12C show example random access processes in accordance with several of various embodiments of the present disclosure. FIG. 12A shows an example of four step contention-based random access (CBRA) procedure. The four-step CBRA procedure includes exchanging four messages between a UE and a base station. Msg1 may be for transmission (or retransmission) of a random access preamble by the wireless device to the base station. Msg2 may be the random access response (RAR) by the base station to the wireless device. Msg3 is the scheduled transmission based on an uplink grant indicated in Msg2 and Msg4 may be for contention resolution.

The base station may transmit one or more RRC messages comprising configuration parameters of the random access parameters. The random access parameters may indicate radio resources (e.g., time-frequency resources) for transmission of the random access preamble (e.g., Msgl), configuration index, one or more parameters for determining the power of the random access preamble (e.g., a power ramping parameter, a preamble received target power, etc.), a parameter indicating maximum number of preamble transmission, RAR window for monitoring RAR, cell-specific random access parameters and UE specific random access parameters. The UE-specific random access parameters may indicate one or more PRACH occasions for random access preamble (e.g., Msg1) transmissions. The random access parameters may indicate association between the PRACH occasions and one or more reference signals (e.g., SSB or CSI-RS). The random access parameters may further indicate association between the random access preambles and one or more reference signals (e.g., SBB or CSI-RS). The UE may use one or more reference signals (e.g., SSB(s) or CSI-RS(s)) and may determine a random access preamble to use for Msg1 transmission based on the association between the random access preambles and the one or more reference signals. The UE may use one or more reference signals (e.g., SSB(s) or CSI-RS(s)) and may determine the PRACH occasion to use for Msg1 transmission based on the association between the PRACH occasions and the reference signals. The UE may perform a retransmission of the random access preamble if no response is received with the RAR window following the transmission of the preamble. UE may use a higher transmission power for retransmission of the preamble. UE may determine the higher transmission power of the preamble based on the power ramping parameter.

Msg2 is for transmission of RAR by the base station. Msg2 may comprise a plurality of RARs corresponding to a plurality of random access preambles transmitted by a plurality of UEs. Msg2 may be associated with a random access temporary radio identifier (RA-RNTI) and may be received in a common search space of the UE. The RA-RNTI may be based on the PRACH occasion (e.g., time and frequency resources of a PRACH) in which a random access preamble is transmitted. RAR may comprise a timing advance command for uplink timing adjustment at the UE, an uplink grant for transmission of Msg3 and a temporary C-RNTI. In response to the successful reception of Msg2, the UE may transmit the Msg3. Msg3 and Msg4 may enable contention resolution in case of CBRA. In a CBRA, a plurality of UEs may transmit the same random access preamble and may consider the same RAR as being corresponding to them. UE may include a device identifier in Msg3 (e.g., a C-RNTI, temporary C-RNTI or other UE identity). Base station may transmit the Msg4 with a PDSCH and UE may assume that the contention resolution is successful in response to the PDSCH used for transmission of Msg4 being associated with the UE identifier included in Msg3.

FIG. 12B shows an example of a contention-free random access (CFRA) process. Msg 1 (random access preamble) and Msg 2 (random access response) in FIG. 12B for CFRA may be analogous to Msg 1 and Msg 2 in FIG. 12A for CBRA. In an example, the CFRA procedure may be initiated in response to a PDCCH order from a base station. The PDCCH order for initiating the CFRA procedure by the wireless device may be based on a DCI having a first format (e.g., format 1_0). The DCI for the PDCCH order may comprise a random access preamble index, an UL/SUL indicator indicating an uplink carrier of a cell (e.g., normal uplink carrier or supplementary uplink carrier) for transmission of the random access preamble, a SS/PBCH index indicating the SS/PBCH that may be used to determine a RACH occasion for PRACH transmission, a PRACH mask index indicating the RACH occasion associated with the SS/PBCH indicated by the SS/PBCH index for PRACH transmission, etc. In an example, the CFRA process may be started in response to a beam failure recovery process. The wireless device may start the CFRA for the beam failure recovery without a command (e.g., PDCCH order) from the base station and by using the wireless device dedicated resources.

FIG. 12C shows an example of a two-step random access process comprising two messages exchanged between a wireless device and a base station. Msg A may be transmitted by the wireless device to the base station and may comprise one or more transmissions of a preamble and/or one or more transmissions of a transport block. The transport block in Msg A and Msg 3 in FIG. 12A may have similar and/or equivalent contents. The transport block of Msg A may comprise data and control information (e.g., SR, HARQ feedback, etc.). In response to the transmission of Msg A, the wireless device may receive Msg B from the base station. Msg B in FIG. 12C and Msg 2 (e.g., RAR) illustrated in FIGS. 12A and 12B may have similar and/or equivalent content.

The base station may periodically transmit synchronization signals (SSs), e.g., primary SS (PSS) and secondary SS (SSS) along with PBCH on each NR cell. The PSS/SSS together with PBCH is jointly referred to as a SS/PBCH block. The SS/PBCH block enables a wireless device to find a cell when entering to the mobile communications network or find new cells when moving within the network. The SS/PBCH block spans four OFDM symbols in time domain. The PSS is transmitted in the first symbol and occupies 127 subcarriers in frequency domain. The SSS is transmitted in the third OFDM symbol and occupies the same 127 subcarriers as the PSS. There are eight and nine empty subcarriers on each side of the SSS. The PBCH is transmitted on the second OFDM symbol occupying 240 subcarriers, the third OFDM symbol occupying 48 subcarriers on each side of the SSS, and on the fourth OFDM symbol occupying 240 subcarriers. Some of the PBCH resources indicated above may be used for transmission of the demodulation reference signal (DMRS) for coherent demodulation of the PBCH. The SS/PBCH block is transmitted periodically with a period ranging from 5 ms to 160 ms. For initial cell search or for cell search during inactive/idle state, a wireless device may assume that that the SS/PBCH block is repeated at least every 20 ms.

In NR, transmissions using of antenna arrays, with many antenna elements, and beamforming plays an important role specially in higher frequency bands. Beamforming enables higher capacity by increasing the signal strength (e.g., by focusing the signal energy in a specific direction) and by lowering the amount interference received at the wireless devices. The beamforming techniques may generally be divided to analog beamforming and digital beamforming techniques. With digital beamforming, signal processing for beamforming is carried out in the digital domain before digital-to-analog conversion and detailed control of both amplitude and phase of different antenna elements may be possible. With analog beamforming, the signal processing for beamforming is carried out in the analog domain and after the digital to analog conversion. The beamformed transmissions may be in one direction at a time. For example, the wireless devices that are in different directions relative to the base station may receive their downlink transmissions at different times. For analog receiver-side beamforming, the receiver may focus its receiver beam in one direction at a time.

In NR, the base station may use beam sweeping for transmission of SS/PBCH blocks. The SS/PBCH blocks may be transmitted in different beams using time multiplexing. The set of SS/PBCH blocks that are transmitted in one beam sweep may be referred to as a SS/PBCH block set. The period of PBCH/SSB block transmission may be a time duration between a SS/PBCH block transmission in a beam and the next SS/PBCH block transmission in the same beam. The period of SS/PBCH block is, therefore, also the period of the SS/PBCH block set.

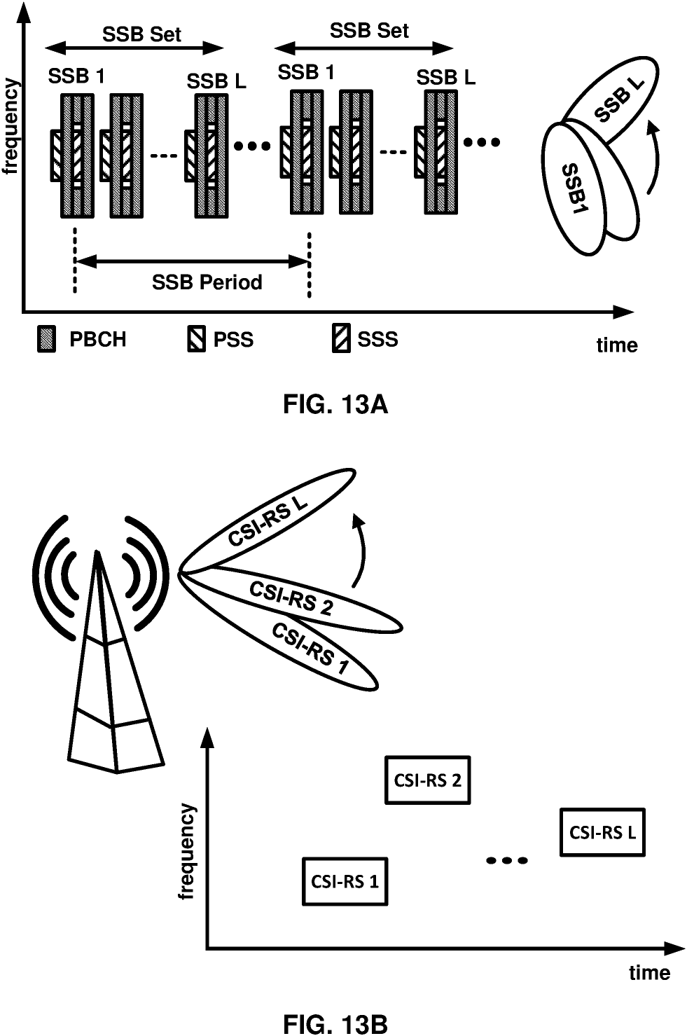

FIG. 13A shows example time and frequency structure of SS/PBCH blocks and their associations with beams in accordance with several of various embodiments of the present disclosure. In this example, a SS/PBCH block (also referred to as SSB) set comprise L SSBs wherein an SSB in the SSB set is associated with (e.g., transmitted in) one of L beams of a cell. The transmission of SBBs of an SSB set may be confined within a 5 ms interval, either in a first half-frame or a second half-frame of a 10 ms frame. The number of SSBs in an SSB set may depend on the frequency band of operation. For example, the number of SSBs in a SSB set may be up to four SSBs in frequency bands below 3 GHz enabling beam sweeping of up to four beams, up to eight SSBs in frequency bands between 3 GHz and 6 GHz enabling beam sweeping of up to eight beams, and up to sixty four SSBs in higher frequency bands enabling beam sweeping of up to sixty four beams. The SSs of an SSB may depend on a physical cell identity (PCI) of the cell and may be independent of which beam of the cell is used for transmission of the SSB. The PBCH of an SSB may indicate a time index parameter and the wireless device may determine the relative position of the SSB within the SSB set using the time index parameter. The wireless device may use the relative position of the SSB within an SSB set for determining the frame timing and/or determining RACH occasions for a random access process.

A wireless device entering the mobile communications network may first search for the PSS. After detecting the PSS, the wireless device may determine the synchronization up to the periodicity of the PSS. By detecting the PSS, the wireless device may determine the transmission timing of the SSS. The wireless device may determine the PCI of the cell after detecting the SSS. The PBCH of a SS/PBCH block is a downlink physical channel that carries the MIB. The MIB may be used by the wireless device to obtain remaining system information (RMSI) that is broadcast by the network. The RMSI may include System Information Block 1 (SIB1) that contains information required for the wireless device to access the cell.

As discussed earlier, the wireless device may determine a time index parameter from the SSB. The PBCH comprises a half-frame parameter indicating whether the SSB is in the first 5 ms half or the second 5 ms half of a 10 ms frame. The wireless device may determine the frame boundary using the time index parameter and the half-frame parameter. In addition, the PBCH may comprise a parameter indicating the system frame number (SFN) of the cell.

The base station may transmit CSI-RS and a UE may measure the CSI-RS to obtain channel state information (CSI). The base station may configure the CSI-RS in a UE-specific manner. In some scenarios, same set of CSI-RS resources may be configured for multiple UEs and one or more resource elements of a CSI-RS resource may be shared among multiple UEs. A CSI-RS resource may be configured such that it does not collide with a CORESET configured for the wireless device and/or with a DMRS of a PDSCH scheduled for the wireless device and/or transmitted SSBs. The UE may measure one or more CSI-RSs configured for the UE and may generate a CSI report based on the CSI-RS measurements and may transmit the CSI report to the base station for scheduling, link adaptation and/or other purposes.

NR supports flexible CSI-RS configurations. A CSI-RS resource may be configured with single or multiple antenna ports and with configurable density. Based on the number of configured antenna ports, a CSI-RS resource may span different number of OFDM symbols (e.g., 1, 2, and 4 symbols). The CSI-RS may be configured for a downlink BWP and may use the numerology of the downlink BWP. The CSI-RS may be configured to cover the full bandwidth of the downlink BWP or a portion of the downlink BWP. In some cases, the CSI-RS may be repeated in every resource block of the CSI-RS bandwidth, referred to as CSI-RS with density equal to one. In some cases, the CSI-RS may be configured to be repeated in every other resource block of the CSI-RS bandwidth. CSI-RS may be non-zero power (NZP) CSI-RS or zero-power (ZP) CSI-RS.

The base station may configure a wireless device with one or more sets of NZP CSI-RS resources. The base station may configure the wireless device with a NZP CSI-RS resource set using an RRC information element (IE) NZP-CSI-RS-ResourceSet indicating a NZP CSI-RS resource set identifier (ID) and parameters specific to the NZP CSI-RS resource set. An NZP CSI-RS resource set may comprise one or more CSI-RS resources. An NZP CSI-RS resource set may be configured as part of the CSI measurement configuration.

The CSI-RS may be configured for periodic, semi-persistent or aperiodic transmission. In case of the periodic and semi-persistent CSI-RS configurations, the wireless device may be configured with a CSI resource periodicity and offset parameter that indicate a periodicity and corresponding offset in terms of number of slots. The wireless device may determine the slots that the CSI-RSs are transmitted. For semi-persistent CSI-RS, the CSI-RS resources for CSI-RS transmissions may be activated and deactivated by using a semi-persistent (SP) CSI-CSI Resource Set Activation/Deactivation MAC CE. In response to receiving a MAC CE indicating activation of semi-persistent CSI-RS resources, the wireless device may assume that the CSI-RS transmissions will continue until the CSI-RS resources for CSI-RS transmissions are activated.

As discussed before, CSI-RS may be configured for a wireless device as NZP CSI-RS or ZP CSI-RS. The configuration of the ZP CSI-RS may be similar to the NZP CSI-RS with the difference that the wireless device may not carry out measurements for the ZP CSI-RS. By configuring ZP CSI-RS, the wireless device may assume that a scheduled PDSCH that includes resource elements from the ZP CSI-RS is rate matched around those ZP CSI-RS resources. For example, a ZP CSI-RS resource configured for a wireless device may be an NZP CSI-RS resource for another wireless device. For example, by configuring ZP CSI-RS resources for the wireless device, the base station may indicate to the wireless device that the PDSCH scheduled for the wireless device is rate matched around the ZP CSI-RS resources.

A base station may configure a wireless device with channel state information interference measurement (CSI-IM) resources. Similar to the CSI-RS configuration, configuration of locations and density of CSI-IM resources may be flexible. The CSI-IM resources may be periodic (configured with a periodicity), semi-persistent (configured with a periodicity and activated and deactivated by MAC CE) or aperiodic (triggered by a DCI).

Tracking reference signals (TRSs) may be configured for a wireless device as a set of sparse reference signals to assist the wireless in time and frequency tracking and compensating time and frequency variations in its local oscillator. The wireless device may further use the TRSs for estimating channel characteristics such as delay spread or doppler frequency. The base station may use a CSI-RS configuration for configuring TRS for the wireless device. The TRS may be configured as a resource set comprising multiple periodic NZP CSI-RS resources.

A base station may configure a UE and the UE may transmit sounding reference signals (SRSs) to enable uplink channel sounding/estimation at the base station. The SRS may support up to four antenna ports and may be designed with low cubic metric enabling efficient operation of the wireless device amplifier. The SRS may span one or more (e.g., one, two or four) consecutive OFDM symbols in time domain and may be located within the last n (e.g., six) symbols of a slot. In the frequency domain, the SRS may have a structure that is referred to as a comb structure and may be transmitted on every Nth subcarrier. Different SRS transmissions from different wireless devices may have different comb structures and may be multiplexed in frequency domain.

A base station may configure a wireless device with one or more SRS resource sets and an SRS resource set may comprise one or more SRS resources. The SRS resources in an SRS resources set may be configured for periodic, semi-persistent or aperiodic transmission. The periodic SRS and the semi-persistent SRS resources may be configured with periodicity and offset parameters. The Semi-persistent SRS resources of a configured semi-persistent SRS resource set may be activated or deactivated by a semi-persistent (SP) SRS Activation/Deactivation MAC CE. The set of SRS resources included in an aperiodic SRS resource set may be activated by a DCI. A value of a field (e.g., an SRS request field) in the DCI may indicate activation of resources in an aperiodic SRS resource set from a plurality of SRS resource sets configured for the wireless device.

An antenna port may be associated with one or more reference signals. The receiver may assume that the one or more reference signals, associated with the antenna port, may be used for estimating channel corresponding to the antenna port. The reference signals may be used to derive channel state information related to the antenna port. Two antenna ports may be referred to as quasi co-located if characteristics (e.g., large-scale properties) of the channel over which a symbol is conveyed on one antenna port may be inferred from the channel over which a symbol is conveyed from another antenna port. For example, a UE may assume that radio channels corresponding to two different antenna ports have the same large-scale properties if the antenna ports are specified as quasi co-located. In some cases, the UE may assume that two antenna ports are quasi co-located based on signaling received from the base station. Spatial quasi-colocation (QCL) between two signals may be, for example, due to the two signals being transmitted from the same location and in the same beam. If a receive beam is good for a signal in a group of signals that are spatially quasi co-located, it may be assumed also be good for the other signals in the group of signals.

The CSI-RS in the downlink and the SRS in uplink may serve as quasi-location (QCL) reference for other physical downlink channels and physical uplink channels, respectively. For example, a downlink physical channel (e.g., PDSCH or PDCCH) may be spatially quasi co-located with a downlink reference signal (e.g., CSI-RS or SSB). The wireless device may determine a receive beam based on measurement on the downlink reference signal and may assume that the determined received beam is also good for reception of the physical channels (e.g., PDSCH or PDCCH) that are spatially quasi co-located with the downlink reference signal. Similarly, an uplink physical channel (e.g., PUSCH or PUCCH) may be spatially quasi co-located with an uplink reference signal (e.g., SRS). The base station may determine a receive beam based on measurement on the uplink reference signal and may assume that the determined received beam is also good for reception of the physical channels (e.g., PUSCH or PUCCH) that are spatially quasi co-located with the uplink reference signal.

The Demodulation Reference Signals (DM-RSs) enables channel estimation for coherent demodulation of downlink physical channels (e.g., PDSCH, PDCCH and PBH) and uplink physical channels (e.g., PUSCH and PUCCH). The DM-RS may be located early in the transmission (e.g., front-loaded DM-RS) and may enable the receiver to obtain the channel estimate early and reduce the latency. The time-domain structure of the DM-RS (e.g., symbols wherein the DM-RS are located in a slot) may be based on different mapping types.

The Phase Tracking Reference Signals (PT-RSs) enables tracking and compensation of phase variations across the transmission duration. The phase variations may be, for example, due to oscillator phase noise. The oscillator phase noise may become more severe in higher frequencies (e.g., mmWave frequency bands). The base station may configure the PT-RS for uplink and/or downlink. The PT-RS configuration parameters may indicate frequency and time density of PT-RS, maximum number of ports (e.g., uplink ports), resource element offset, configuration of uplink PT-RS without transform precoder (e.g., CP-OFDM) or with transform precoder (e.g., DFT-s-OFDM), etc. The subcarrier number and/or resource blocks used for PT-RS transmission may be based on the C-RNTI of the wireless device to reduce risk of collisions between PT-RSs of wireless devices scheduled on overlapping frequency domain resources.

FIG. 13B shows example time and frequency structure of CSI-RSs and their association with beams in accordance with several of various embodiments of the present disclosure. A beam of the L beams shown in FIG. 13B may be associated with a corresponding CSI-RS resource. The base station may transmit the CSI-RSs using the configured CSI-RS resources and a UE may measure the CSI-RSs (e.g., received signal received power (RSRP) of the CSI-RSs) and report the CSI-RS measurements to the base station based on a reporting configuration. For example, the base station may determine one or more transmission configuration indication (TCI) states and may indicate the one or more TCI states to the UE (e.g., using RRC signaling, a MAC CE and/or a DCI). Based on the one or more TCI states indicated to the UE, the UE may determine a downlink receive beam and receive downlink transmissions using the receive beam. In case of a beam correspondence, the UE may determine a spatial domain filter of a transmit beam based on spatial domain filter of a corresponding receive beam. Otherwise, the UE may perform an uplink beam selection procedure to determine the spatial domain filter of the transmit beam. The UE may transmit one or more SRSs using the SRS resources configured for the UE and the base station may measure the SRSs and determine/select the transmit beam for the UE based the SRS measurements. The base station may indicate the selected beam to the UE. The CSI-RS resources shown in FIG. 13B may be for one UE. The base station may configure different CSI-RS resources associated with a given beam for different UEs by using frequency division multiplexing.

A base station and a wireless device may perform beam management procedures to establish beam pairs (e.g., transmit and receive beams) that jointly provide good connectivity. For example, in the downlink direction, the UE may perform measurements for a beam pair and estimate channel quality for a transmit beam by the base station (or a transmission reception point (TRP) more generally) and the receive beam by the UE. The UE may transmit a report indicating beam pair quality parameters. The report may comprise one or more parameters indicating one or more beams (e.g., a beam index, an identifier of reference signal associated with a beam, etc.), one or more measurement parameters (e.g., RSRP), a precoding matrix indicator (PMI), a channel quality indicator (CQI), and/or a rank indicator (RI).

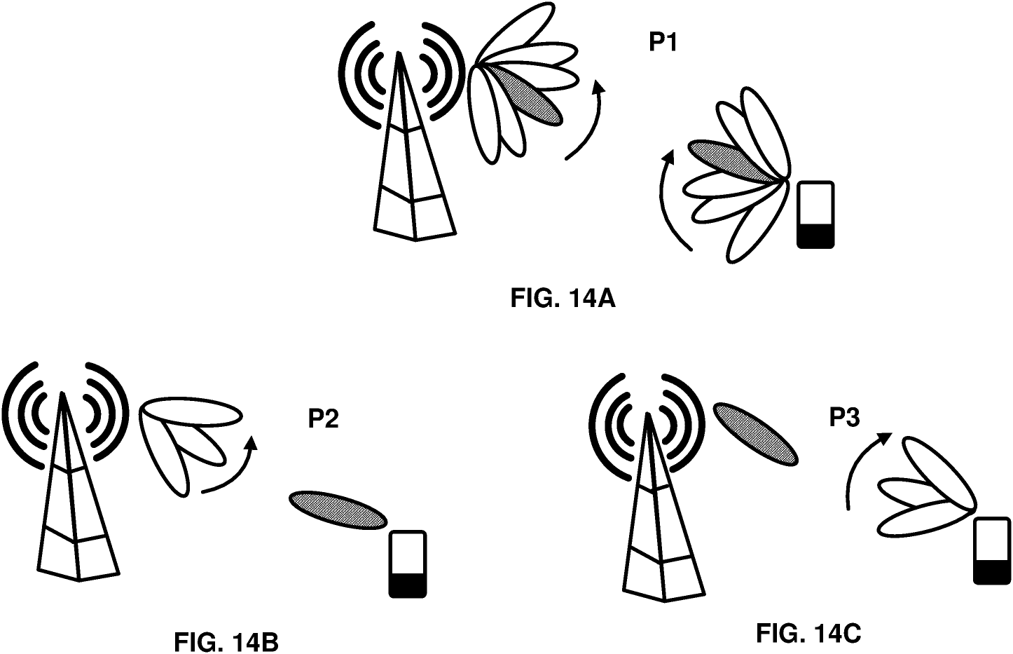

FIG. 14A, FIG. 14B and FIG. 14C show example beam management processes (referred to as P1, P2 and P3, respectively) in accordance with several of various embodiments of the present disclosure. The P1 process shown in FIG. 14A may enable, based on UE measurements, selection of a base station (or TRP more generally) transmit beam and/or a wireless device receive beam. The TRP may perform a beam sweeping procedure where the TRP may sequentially transmit reference signals (e.g., SSB and/or CSI-RS) on a set of beams and the UE may select a beam from the set of beams and may report the selected beam to the TRP. The P2 procedure as shown in FIG. 14B may be a beam refinement procedure. The selection of the TRP transmit beam and the UE receive beam may be regularly reevaluated due to movements and/or rotations of the UE or movement of other objects. In an example, the base station may perform the beam sweeping procedure over a smaller set of beams and the UE may select the best beam over the smaller set. In an example, the beam shape may be narrower compared to beam selected based on the P1 procedure. Using the P3 procedure as shown in FIG. 14C, the TRP may fix its transmit beam and the UE may refine its receive beam.

A wireless device may receive one or more messages from a base station. The one or more messages may comprise one or more RRC messages. The one or more messages may comprise configuration parameters of a plurality of cells for the wireless device. The plurality of cells may comprise a primary cell and one or more secondary cells. For example, the plurality of cells may be provided by a base station and the wireless device may communicate with the base station using the plurality of cells. For example, the plurality of cells may be provided by multiple base stations (e.g., in case of dual and/or multi-connectivity). The wireless device may communicate with a first base station, of the multiple base stations, using one or more first cells of the plurality of cells. The wireless device may communicate with a second base station of the multiple base stations using one or more second cells of the plurality of cells.

The one or more messages may comprise configuration parameters used for processes in physical, MAC, RLC, PCDP, SDAP, and/or RRC layers of the wireless device. For example, the configuration parameters may include values of timers used in physical, MAC, RLC, PCDP, SDAP, and/or RRC layers. For example, the configuration parameters may include parameters for configurating different channels (e.g., physical layer channel, logical channels, RLC channels, etc.) and/or signals (e.g., CSI-RS, SRS, etc.).

Upon starting a timer, the timer may start running until the timer is stopped or until the timer expires. A timer may be restarted if it is running. A timer may be started if it is not running (e.g., after the timer is stopped or after the timer expires). A timer may be configured with or may be associated with a value (e.g., an initial value). The timer may be started or restarted with the value of the timer. The value of the timer may indicate a time duration that the timer may be running upon being started or restarted and until the timer expires. The duration of a timer may not be updated until the timer is stopped or expires (e.g., due to BWP switching). This specification may disclose a process that includes one or more timers. The one or more timers may be implemented in multiple ways. For example, a timer may be used by the wireless device and/or base station to determine a time window [t1, t2], wherein the timer is started at time t1 and expires at time t2 and the wireless device and/or the base station may be interested in and/or monitor the time window [t1, t2], for example to receive a specific signaling. Other examples of implementation of a timer may be provided.

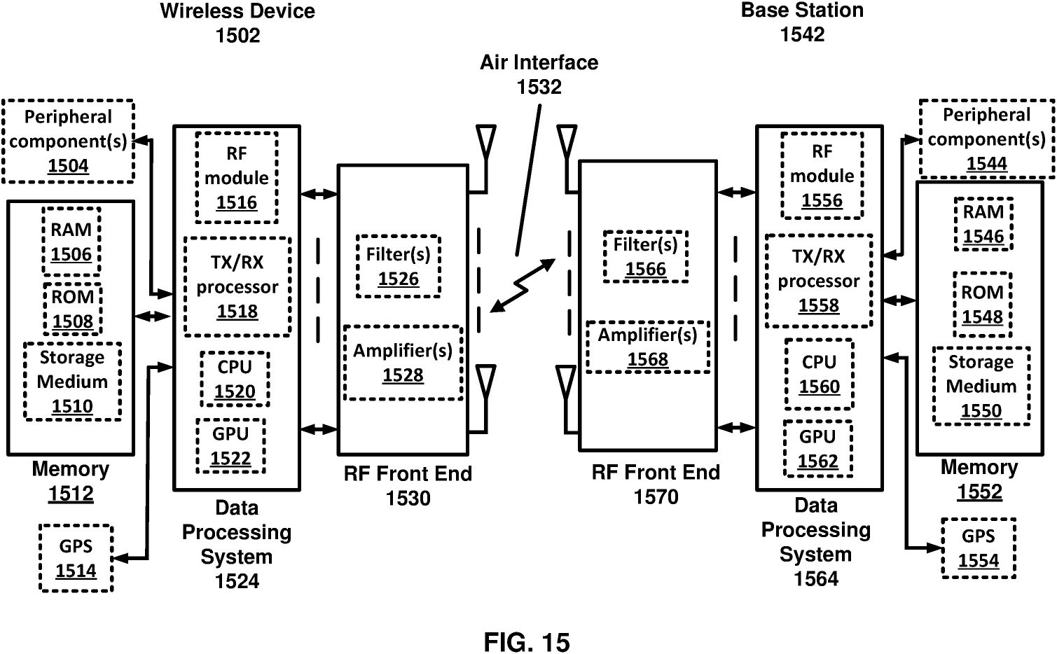

FIG. 15 shows example components of a wireless device and a base station that are in communication via an air interface in accordance with several of various embodiments of the present disclosure. The wireless device 1502 may communicate with the base station 1542 over the air interface 1532. The wireless device 1502 may include a plurality of antennas. The base station 1542 may include a plurality of antennas. The plurality of antennas at the wireless device 1502 and/or the base station 1542 enables different types of multiple antenna techniques such as beamforming, single-user and/or multi-user MIMO, etc.

The wireless device 1502 and the base station 1542 may have one or more of a plurality of modules/blocks, for example RF front end (e.g., RF front end 1530 at the wireless device 1502 and RF front end 1570 at the base station 1542), Data Processing System (e.g., Data Processing System 1524 at the wireless device 1502 and Data Processing System 1564 at the base station 1542), Memory (e.g., Memory 1512 at the wireless device 1502 and Memory 1542 at the base station 1542). Additionally, the wireless device 1502 and the base station 1542 may have other modules/blocks such as GPS (e.g., GPS 1514 at the wireless device 1502 and GPS 1554 at the base station 1542).

An RF front end module/block may include circuitry between antennas and a Data Processing System for proper conversion of signals between these two modules/blocks. An RF front end may include one or more filters (e.g., Filter(s) 1526 at RF front end 1530 or Filter(s) 1566 at the RF front end 1570), one or more amplifiers (e.g., Amplifier(s) 1528 at the RF front end 1530 and Amplifier(s) 1568 at the RF front end 1570). The Amplifier(s) may comprise power amplifier(s) for transmission and low-noise amplifier(s) (LNA(s)) for reception.

The Data Processing System 1524 and the Data Processing System 1564 may process the data to be transmitted or the received signals by implementing functions at different layers of the protocol stack such as PHY, MAC, RLC, etc. Example PHY layer functions that may be implemented by the Data Processing System 1524 and/or 1564 may include forward error correction, interleaving, rate matching, modulation, precoding, resource mapping, MIMO processing, etc. Similarly, one or more functions of the MAC layer, RLC layer and/or other layers may be implemented by the Data Processing System 1524 and/or the Data Processing System 1564. One or more processes described in the present disclosure may be implemented by the Data Processing System 1524 and/or the Data Processing System 1564. A Data Processing System may include an RF module (RF module 1516 at the Data Processing System 1524 and RF module 1556 at the Data Processing System 1564) and/or a TX/RX processor (e.g., TX/RX processor 1518 at the Data Processing System 1524 and TX/RX processor 1558 at the Data Processing System 1566) and/or a central processing unit (CPU) (e.g., CPU 1520 at the Data Processing System 1524 and CPU 1560 at the Data Processing System 1564) and/or a graphical processing unit (GPU) (e.g., GPU 1522 at the Data Processing System 1524 and GPU 1562 at the Data Processing System 1564).

The Memory 1512 may have interfaces with the Data Processing System 1524 and the Memory 1552 may have interfaces with Data Processing System 1564, respectively. The Memory 1512 or the Memory 1552 may include non-transitory computer readable mediums (e.g., Storage Medium 1510 at the Memory 1512 and Storage Medium 1550 at the Memory 1552) that may store software code or instructions that may be executed by the Data Processing System 1524 and Data Processing System 1564, respectively, to implement the processes described in the present disclosure. The Memory 1512 or the Memory 1552 may include random-access memory (RAM) (e.g., RAM 1506 at the Memory 1512 or RAM 1546 at the Memory 1552) or read-only memory (ROM) (e.g., ROM 1508 at the Memory 1512 or ROM 1548 at the Memory 1552) to store data and/or software codes.

The Data Processing System 1524 and/or the Data Processing System 1564 may be connected to other components such as a GPS module 1514 and a GPS module 1554, respectively, wherein the GPS module 1514 and a GPS module 1554 may enable delivery of location information of the wireless device 1502 to the Data Processing System 1524 and location information of the base station 1542 to the Data Processing System 1564. One or more other peripheral components (e.g., Peripheral Component(s) 1504 or Peripheral Component(s) 1544) may be configured and connected to the data Processing System 1524 and data Processing System 1564, respectively.

In example embodiments, a wireless device may be configured with parameters and/or configuration arrangements. For example, the configuration of the wireless device with parameters and/or configuration arrangements may be based on one or more control messages that may be used to configure the wireless device to implement processes and/or actions. The wireless device may be configured with the parameters and/or the configuration arrangements regardless of the wireless device being in operation or not in operation. For example, software, firmware, memory, hardware and/or a combination thereof and/or alike may be configured in a wireless device regardless of the wireless device being in operation or not operation. The configured parameters and/or settings may influence the actions and/or processes performed by the wireless device when in operation.

In example embodiments, a wireless device may receive one or more messages comprising configuration parameters. For example, the one or more messages may comprise radio resource control (RRC) messages. A parameter of the configuration parameters may be in at least one of the one or more messages. The one or more messages may comprise information element (IEs). An information element may be a structural element that includes single or multiple fields. The fields in an IE may be individual contents of the IE. The terms configuration parameter, IE and field may be used equally in this disclosure. The IEs may be implemented using a nested structure, wherein an IE may include one or more other IEs and an IE of the one or more other IEs may include one or more additional IEs. With this structure, a parent IE contains all the offspring IEs as well. For example, a first IE containing a second IE, the second IE containing a third IE, and the third IE containing a fourth IE may imply that the first IE contains the third IE and the fourth IE.

In an example, a Random Access procedure may be initiated by a PDCCH order, by the MAC entity itself, or by RRC. In an example, there may be one Random Access procedure ongoing at any point in time in a MAC entity. In an example, the Random Access procedure on an SCell may be initiated by a PDCCH order with ra-PreambleIndex different from 0b000000.

In an example, if a new Random Access procedure is triggered while another is ongoing in the MAC entity, it may be up to UE implementation whether to continue with the ongoing procedure or start with the new procedure (e.g., for SI request).

In an example, if there was an ongoing Random Access procedure that is triggered by a PDCCH order while the UE receives another PDCCH order indicating the same Random Access Preamble, PRACH mask index and uplink carrier, the Random Access procedure may be considered as the same Random Access procedure as the ongoing one and not initialized again.

In an example, RRC may configure one or more of the following parameters for the Random Access procedure. A parameter prach-ConfigurationIndex may indicate the available set of PRACH occasions for the transmission of the Random Access Preamble for Msg1. These may also be applicable to the MSGA PRACH if the PRACH occasions are shared between 2-step and 4-step RA types. msgA-PRACH-ConfigurationIndex may indicate the available set of PRACH occasions for the transmission of the Random Access Preamble for MSGA in 2-step RA type. preambleReceivedTargetPower may indicate initial Random Access Preamble power for 4-step RA type. msgA-PreambleReceivedTargetPower may indicate initial Random Access Preamble power for 2-step RA type. rsrp-ThresholdSSB may indicate an RSRP threshold for the selection of the SSB for 4-step RA type. If the Random Access procedure is initiated for beam failure recovery, rsrp-ThresholdSSB used for the selection of the SSB within candidateBeamRSList may refer to rsrp-ThresholdSSB in BeamFailureRecoveryConfig IE. rsrp-ThresholdCSI-RS may indicate an RSRP threshold for the selection of CSI-RS for 4-step RA type. If the Random Access procedure is initiated for beam failure recovery, rsrp-ThresholdCSI-RS may be equal to rsrp-ThresholdSSB in BeamFailureRecoveryConfig IE. msgA-RSRP-ThresholdSSB may indicate an RSRP threshold for the selection of the SSB for 2-step RA type. rsrp-ThresholdSSB-SUL may indicate an RSRP threshold for the selection between the NUL carrier and the SUL carrier. msgA-RSRP-Threshold may indicate an RSRP threshold for selection between 2-step RA type and 4-step RA type when both 2-step and 4-step RA type Random Access Resources are configured in the UL BWP. msgA-TransMax may indicate the maximum number of MSGA transmissions when both 4-step and 2-step RA type Random Access Resources are configured. candidateBeamRSList may indicate a list of reference signals (CSI-RS and/or SSB) identifying the candidate beams for recovery and the associated Random Access parameters. recoverySearchSpaceId may indicate the search space identity for monitoring the response of the beam failure recovery request. powerRampingStep may indicate the power-ramping factor. msgA-PreamblePowerRampingStep may indicate the power ramping factor for MSGA preamble. powerRampingStepHighPriority may indicate the power-ramping factor in case of prioritized Random Access procedure. scalingFactorBI may indicate a scaling factor for prioritized Random Access procedure. ra-PreambleIndex may indicate Random Access Preamble. ra-ssb-OccasionMaskIndex: may define PRACH occasion(s) associated with an SSB in which the MAC entity may transmit a Random Access Preamble. msgA-SSB-SharedRO-MaskIndex may indicates the subset of 4-step RA type PRACH occasions shared with 2-step RA type PRACH occasions for each SSB. If 2-step RA type PRACH occasions are shared with 4-step RA type PRACH occasions and msgA-SSB-SharedRO-MaskIndex is not configured, 4-step RA type PRACH occasions may be available for 2-step RA type. ra-OccasionList may defines PRACH occasion(s) associated with a CSI-RS in which the MAC entity may transmit a Random Access Preamble. ra-PreambleStartIndex may indicate the starting index of Random Access Preamble(s) for on-demand SI request. preambleTransMax may indicate the maximum number of Random Access Preamble transmission. ssb-perRACH-OccasionAndCB-PreamblesPerSSB may define the number of SSBs mapped to each PRACH occasion for 4-step RA type and the number of contention-based Random Access Preambles mapped to each SSB. msgA-CB-PreamblesPerSSB-PerSharedRO may define the number of contention-based Random Access Preambles for 2-step RA type mapped to each SSB when the PRACH occasions are shared between 2-step and 4-step RA types. msgA-SSB-PerRACH-OccasionAndCB-PreamblesPerSSB may define the number of SSBs mapped to each PRACH occasion for 2-step RA type and the number of contention-based Random Access Preambles mapped to each SSB. msgA-PUSCH-ResourceGroupA may define MSGA PUSCH resources that the UE may use when performing MSGA transmission using Random Access Preambles group A. msgA-PUSCH-ResourceGroupB may define MSGA PUSCH resources that the UE may use when performing MSGA transmission using Random Access Preambles group B. msgA-PUSCH-Resource-Index may identify the index of the PUSCH resource used for MSGA in case of contention-free Random Access with 2-step RA type.

In an example, if groupBconfigured is configured, the Random Access Preambles group B may be configured for 4-step RA type. Amongst the contention-based Random Access Preambles associated with an SSB, the first numberOfRA-PreamblesGroupA included in groupBconfigured Random Access Preambles may belong to Random Access Preambles group A. The remaining Random Access Preambles associated with the SSB may belong to Random Access Preambles group B (if configured).

In an example, if groupB-ConfiguredTwoStepRA is configured, the Random Access Preambles group B may be configured for 2-step RA type. Amongst the contention-based Random Access Preambles for 2-step RA type associated with an SSB, the first numberOfRA-PreamblesGroupA included in GroupB-ConfiguredTwoStepRA Random Access Preambles may belong to Random Access Preambles group A. The remaining Random Access Preambles associated with the SSB may belong to Random Access Preambles group B (if configured).

In an example. If Random Access Preambles group B is supported by the cell Random Access Preambles group B may be included for each SSB.

In an example, if Random Access Preambles group B is configured for 4-step RA type: ra-Msg3SizeGroupA may indicate the threshold to determine the groups of Random Access Preambles for 4-step RA type. msg3-DeltaPreamble may indicate APREAMBLE_Msg3. messagePowerOffsetGroupB may indicate the power offset for preamble selection included in groupBconfigured. numberOfRA-PreamblesGroupA may define the number of Random Access Preambles in Random Access Preamble group A for each SSB included in groupBconfigured.

In an example, if Random Access Preambles group B is configured for 2-step RA type: msgA-DeltaPreamble may indicate ΔMsgA_PUSCH. messagePowerOffsetGroupB may indicate the power offset for preamble selection included in GroupB-ConfiguredTwoStepRA. numberOfRA-PreamblesGroupA may define the number of Random Access Preambles in Random Access Preamble group A for each SSB included in GroupB-ConfiguredTwoStepRA. ra-MsgA-SizeGroupA may indicate the threshold to determine the groups of Random Access Preambles for 2-step RA type.

In an example, RRC may configure the set of Random Access Preambles and/or PRACH occasions for SI request, if any; and/or the set of Random Access Preambles and/or PRACH occasions for beam failure recovery request, if any; and/or the set of Random Access Preambles and/or PRACH occasions for reconfiguration with sync, if any; and/or ra-ResponseWindow: the time window to monitor RA response(s); and/or ra-ContentionResolutionTimer: the Contention Resolution Timer; and/or msgB-ResponseWindow: the time window to monitor RA response(s) for 2-step RA type.

In an example, the following UE variables may be used for the Random Access procedure:
PREAMBLE_INDEX; PREAMBLE_TRANSMISSION_COUNTER;
PREAMBLE_POWER_RAMPING_COUNTER; PREAMBLE_POWER_RAMPING_STEP;
PREAMBLE_RECEIVED_TARGET_POWER; PREAMBLE_BACKOFF; PCMAX;
SCALING_FACTOR_BI; TEMPORARY_C-RNTI; RA_TYPE; POWER_OFFSET_2STEP_RA;
MSGA_PREAMBLE_POWER_RAMPING_STEP.

In an example, when the Random Access procedure is initiated on a Serving Cell, the MAC entity may: flush the Msg3 buffer; flush the MSGA buffer; set the PREAMBLE_TRANSMISSION_COUNTER to 1; set the PREAMBLE_POWER_RAMPING_COUNTER to 1; set the PREAMBLE_BACKOFF to 0 ms; set POWER_OFFSET_2STEP_RA to 0 dB; if the carrier to use for the Random Access procedure is explicitly signaled: the MAC entity may select the signaled carrier for performing Random Access procedure and may set the PCMAX to PCMAX,f,c of the signaled carrier.

In an example, when the Random Access procedure is initiated on a Serving Cell, if the BWP selected for Random Access procedure is configured with both 2-step and 4-step RA type Random Access Resources and the RSRP of the downlink pathloss reference is above msgA-RSRP-Threshold; or if the BWP selected for Random Access procedure is only configured with 2-step RA type Random Access resources (e.g., no 4-step RACH RA type resources configured); or if the Random Access procedure was initiated for reconfiguration with sync and if the contention-free Random Access Resources for 2-step RA type have been explicitly provided in rach-ConfigDedicated for the BWP selected for Random Access procedure: the MAC entity may set the RA_TYPE to 2-stepRA. Otherwise, the MAC entity may set the RA_TYPE to 4-stepRA.

In an example, when the Random Access procedure is initiated on a Serving Cell, the MAC entity may perform initialization of variables specific to Random Access type. If RA_TYPE is set to 2-stepRA: the MAC entity may perform the Random Access Resource selection procedure for 2-step RA type. Otherwise, the MAC entity may perform the Random Access Resource selection procedure.

In an example, if RA_TYPE is set to 2-stepRA, the MAC entity may set PREAMBLE_POWER_RAMPING_STEP to msgA-PreamblePowerRampingStep; may set SCALING_FACTOR_BI to 1; may apply preambleTransMax included in the RACH-ConfigGenericTwoStepRA.

In an example, if RA_TYPE is set to 2-stepRA, if the Random Access procedure was initiated for handover; and if cfra-TwoStep is configured for the selected carrier: if msgA-TransMax is configured in the cfra-TwoStep: the MAC entity may apply msgA-TransMax configured in the cfra-TwoStep.

In an example, if RA_TYPE is set to 2-stepRA, if msgA-TransMax is included in the RACH-ConfigCommonTwoStepRA: the MAC entity may apply msgA-TransMax included in the RACH-ConfigCommonTwoStepRA.

In an example, if RA_TYPE is set to 2-stepRA, if the Random Access procedure was initiated for SpCell beam failure recovery; and if beamFailureRecoveryConfig is configured for the active UL BWP of the selected carrier; and if ra-PrioritizationTwoStep is configured in the beamFailureRecoveryConfig: the MAC entity may set PREAMBLE_POWER_RAMPING_STEP to the powerRampingStepHighPriority included in the ra-PrioritizationTwoStep in beamFailureRecoveryConfig. If scalingFactorBI is configured in the ra-PrioritizationTwoStep in beamFailureRecoveryConfig: the MAC entity may set SCALING_FACTOR_BI to the scalingFactorBI.

In an example, if RA_TYPE is set to 2-stepRA, if the Random Access procedure was initiated for handover; and if rach-ConfigDedicated is configured for the selected carrier; and if ra-PrioritizationTwoStep is configured in the rach-ConfigDedicated: the MAC entity may set PREAMBLE_POWER_RAMPING_STEP to the powerRampingStepHighPriority included in the ra-PrioritizationTwoStep in rach-ConfigDedicated. If scalingFactorBI is configured in ra-PrioritizationTwoStep in the rach-ConfigDedicated: the MAC entity may set SCALING_FACTOR_BI to the scalingFactorBI.

In an example, if RA_TYPE is set to 2-stepRA, ra-PrioritizationForAccessIdentityTwoStep may be configured for the selected carrier; and the MAC entity may be provided by upper layers with Access Identity 1 or 2; and for at least one of these Access Identities the corresponding bit in the ra-PrioritizationForAI may be set to one. If powerRampingStepHighPriority is configured in the ra-PrioritizationForAccessIdentityTwoStep: the MAC entity may set PREAMBLE_POWER_RAMPING_STEP to the powerRampingStepHighPriority. If scalingFactorBI is configured in the ra-PrioritizationForAccessIdentityTwoStep: the MAC entity may set SCALING_FACTOR_BI to the scalingFactorBI.

In an example, if RA_TYPE is set to 2-stepRA, the MAC entity may set MSGA_PREAMBLE_POWER_RAMPING_STEP to PREAMBLE_POWER_RAMPING_STEP.

In an example, if RA_TYPE is set to 4-stepRA, the MAC entity may set PREAMBLE_POWER_RAMPING_STEP to powerRampingStep; may set SCALING_FACTOR_BI to 1; may set preambleTransMax to preambleTransMax included in the RACH-ConfigGeneric.

In an example, if RA_TYPE is set to 4-stepRA, if the Random Access procedure was initiated for SpCell beam failure recovery; and if beamFailureRecoveryConfig is configured for the active UL BWP of the selected carrier: the MAC entity may start the beamFailureRecoveryTimer, if configured; may apply the parameters powerRampingStep, preambleReceivedTargetPower, and preambleTransMax configured in the beamFailureRecoveryConfig.

In an example, if RA_TYPE is set to 4-stepRA, if the Random Access procedure was initiated for beam failure recovery; and if beamFailureRecoveryConfig is configured for the active UL BWP of the selected carrier; and if ra-Prioritization is configured in the beamFailureRecoveryConfig: the MAC entity may set PREAMBLE_POWER_RAMPING_STEP to the powerRampingStepHighPriority included in the ra-Prioritization in beamFailureRecoveryConfig. If scalingFactorBI is configured in ra-Prioritization in the beamFailureRecoveryConfig: the MAC entity may set SCALING_FACTOR_BI to the scalingFactorBI.

In an example, if RA_TYPE is set to 4-stepRA, if the Random Access procedure was initiated for handover; and if rach-ConfigDedicated is configured for the selected carrier; and if ra-Prioritization is configured in the rach-ConfigDedicated: the MAC entity may set PREAMBLE_POWER_RAMPING_STEP to the powerRampingStepHighPriority included in the ra-Prioritization in rach-ConfigDedicated. If scalingFactorBI is configured in ra-Prioritization in the rach-ConfigDedicated: the MAC entity may set SCALING_FACTOR_BI to the scalingFactorBI.

In an example, RA_TYPE may be set to 4-stepRA, ra-PrioritizationForAccessIdentity may be configured for the selected carrier; and the MAC entity may be provided by upper layers with Access Identity 1 or 2; and for at least one of these Access Identities the corresponding bit in the ra-PrioritizationForAI may be set to one. If powerRampingStepHighPriority is configured in the ra-PrioritizationForAccessIdentity: the MAC entity may set PREAMBLE_POWER_RAMPING_STEP to the powerRampingStepHighPriority. If scalingFactorBI is configured in the ra-PrioritizationForAccessIdentity: the MAC entity may set SCALING_FACTOR_BI to the scalingFactorBI.

In an example, RA_TYPE may be set to 4-stepRA. If RA_TYPE is switched from 2-stepRA to 4-stepRA during this Random Access procedure: the MAC entity may set POWER_OFFSET_2STEP_RA to (PREAMBLE_POWER_RAMPING_COUNTER - 1) × (MSGA_PREAMBLE_POWER_RAMPING_STEP - PREAMBLE_POWER_RAMPING_STEP).

In an example, the selected RA_TYPE may be set to 4-stepRA. If the Random Access procedure was initiated for SpCell beam failure recovery; and if the beamFailureRecoveryTimer is either running or not configured; and if the contention-free Random Access Resources for beam failure recovery request associated with any of the SSBs and/or CSI-RSs have been explicitly provided by RRC; and if at least one of the SSBs with SS-RSRP above rsrp-ThresholdSSB amongst the SSBs in candidateBeamRSList or the CSI-RSs with CSI-RSRP above rsrp-ThresholdCSI-RS amongst the CSI-RSs in candidateBeamRSList is available: the MAC entity may select an SSB with SS-RSRP above rsrp-ThresholdSSB amongst the SSBs in candidateBeamRSList or a CSI-RS with CSI-RSRP above rsrp-ThresholdCSI-RS amongst the CSI-RSs in candidateBeamRSList. If CSI-RS is selected, and there is no ra-PreambleIndex associated with the selected CSI-RS: the MAC entity may set the PREAMBLE_INDEX to a ra-PreambleIndex corresponding to the SSB in candidateBeamRSList which is quasi-colocated with the selected CSI-RS. Otherwise, the MAC entity may set the PREAMBLE_INDEX to a ra-PreambleIndex corresponding to the selected SSB or CSI-RS from the set of Random Access Preambles for beam failure recovery request.

In an example, if the ra-PreambleIndex has been explicitly provided by PDCCH; and if the ra-PreambleIndex is not 0b000000: the MAC entity may set the PREAMBLE_INDEX to the signaled ra-PreambleIndex; and may select the SSB signaled by PDCCH.

In an example, if the contention-free Random Access Resources associated with SSBs have been explicitly provided in rach-ConfigDedicated and at least one SSB with SS-RSRP above rsrp-ThresholdSSB amongst the associated SSBs is available: the MAC entity may select an SSB with SS-RSRP above rsrp-ThresholdSSB amongst the associated SSBs; and may set the PREAMBLE_INDEX to a ra-PreambleIndex corresponding to the selected SSB.

In an example, if the contention-free Random Access Resources associated with CSI-RSs have been explicitly provided in rach-ConfigDedicated and at least one CSI-RS with CSI-RSRP above rsrp-ThresholdCSI-RS amongst the associated CSI-RSs is available: the MAC entity may select a CSI-RS with CSI-RSRP above rsrp-ThresholdCSI-RS amongst the associated CSI-RSs; and may set the PREAMBLE_INDEX to a ra-PreambleIndex corresponding to the selected CSI-RS.

In an example, the Random Access procedure may be initiated for SI request. The Random Access Resources for SI request may have been explicitly provided by RRC. If at least one of the SSBs with SS-RSRP above rsrp-ThresholdSSB is available: the MAC entity may select an SSB with SS-RSRP above rsrp-ThresholdSSB. Otherwise, the MAC entity may select any SSB. The MAC entity may select a Random Access Preamble corresponding to the selected SSB, from the Random Access Preamble(s) determined according to ra-PreambleStartIndex. The MAC entity may set the PREAMBLE _INDEX to selected Random Access Preamble.

In an example, for the contention-based Random Access preamble selection: if at least one of the SSBs with SS-RSRP above rsrp-ThresholdSSB is available: the MAC entity may select an SSB with SS-RSRP above rsrp-ThresholdSSB. Otherwise, the MAC entity may select any SSB.

In an example, for the contention-based Random Access preamble selection: the RA_TYPE is switched from 2-stepRA to 4-stepRA. If a Random Access Preambles group was selected during the current Random Access procedure: the MAC entity may select the same group of Random Access Preambles as was selected for the 2-step RA type. Otherwise, if Random Access Preambles group B is configured; and if the transport block size of the MSGA payload configured in the rach-ConfigDedicated corresponds to the transport block size of the MSGA payload associated with Random Access Preambles group B: the MAC entity may select the Random Access Preambles group B. Otherwise, the MAC entity may select the Random Access Preambles group A.

In an example, for the contention-based Random Access preamble selection: Msg3 buffer may be empty. Random Access Preambles group B may be configured. If the potential Msg3 size (UL data available for transmission plus MAC subheader(s) and, where required, MAC CEs) is greater than ra-Msg3SizeGroupA and the pathloss is less than PCMAX (of the Serving Cell performing the Random Access Procedure) - preambleReceivedTargetPower - msg3-DeltaPreamble - messagePowerOffsetGroupB; or if the Random Access procedure was initiated for the CCCH logical channel and the CCCH SDU size plus MAC subheader is greater than ra-Msg3SizeGroupA: the MAC entity may select the Random Access Preambles group B. Otherwise, the MAC entity may select the Random Access Preambles group A.

In an example, for the contention-based Random Access preamble selection: Msg3 buffer may be empty. Random Access Preambles group B may not be configured. The MAC entity may select the Random Access Preambles group A.

In an example, for the contention-based Random Access preamble selection: Msg3 may be retransmitted. The MAC entity may select the same group of Random Access Preambles as was used for the Random Access Preamble transmission attempt corresponding to the first transmission of Msg3.

In an example, for the contention-based Random Access preamble selection: the MAC entity may select a Random Access Preamble randomly with equal probability from the Random Access Preambles associated with the selected SSB and the selected Random Access Preambles group. The MAC entity may select a Random Access Preamble randomly with equal probability from the Random Access Preambles associated with the selected SSB and the selected Random Access Preambles group. The MAC entity may set the PREAMBLE_INDEX to the selected Random Access Preamble.

In an example, if the Random Access procedure was initiated for SI request; and if ra-AssociationPeriodIndex and si-RequestPeriod are configured: the MAC entity may determine the next available PRACH occasion from the PRACH occasions corresponding to the selected SSB in the association period given by ra-AssociationPeriodIndex in the si-RequestPeriod permitted by the restrictions given by the ra-ssb-OccasionMaskIndex if configured (the MAC entity shall select a PRACH occasion randomly with equal probability amongst the consecutive PRACH occasions corresponding to the selected SSB).

In an example, if an SSB is selected, the MAC entity may determine the next available PRACH occasion from the PRACH occasions corresponding to the selected SSB permitted by the restrictions given by the ra-ssb-OccasionMaskIndex if configured or indicated by PDCCH (the MAC entity may select a PRACH occasion randomly with equal probability amongst the consecutive PRACH occasions, corresponding to the selected SSB; the MAC entity may take into account the possible occurrence of measurement gaps when determining the next available PRACH occasion corresponding to the selected SSB).

In an example, if a CSI-RS is selected: if there is no contention-free Random Access Resource associated with the selected CSI-RS: the MAC entity may determine the next available PRACH occasion from the PRACH occasions, permitted by the restrictions given by the ra-ssb-OccasionMaskIndex if configured, corresponding to the SSB in candidateBeamRSList which is quasi-colocated with the selected CSI-RS (the MAC entity may select a PRACH occasion randomly with equal probability amongst the consecutive PRACH occasions, corresponding to the SSB which is quasi-colocated with the selected CSI-RS; the MAC entity may take into account the possible occurrence of measurement gaps when determining the next available PRACH occasion corresponding to the SSB which is quasi-colocated with the selected CSI-RS).

In an example, if a CSI-RS is selected: if there is contention-free Random Access Resource associated with the selected CSI-RS: the MAC entity may determine the next available PRACH occasion from the PRACH occasions in ra-OccasionList corresponding to the selected CSI-RS (the MAC entity may select a PRACH occasion randomly with equal probability amongst the PRACH occasions occurring simultaneously but on different subcarriers, corresponding to the selected CSI-RS; the MAC entity may take into account the possible occurrence of measurement gaps when determining the next available PRACH occasion corresponding to the selected CSI-RS).

In an example, the MAC entity may perform the Random Access Preamble transmission procedure. When the UE determines if there is an SSB with SS-RSRP above rsrp-ThresholdSSB or a CSI-RS with CSI-RSRP above rsrp-ThresholdCSI-RS, the UE may use the latest unfiltered L1-RSRP measurement.

In an example, for each Random Access Preamble: if PREAMBLE_TRANSMISSION_COUNTER is greater than one; and if the notification of suspending power ramping counter has not been received from lower layers; and if LBT failure indication was not received from lower layers for the last Random Access Preamble transmission; and if SSB or CSI-RS selected is not changed from the selection in the last Random Access Preamble transmission: the MAC entity may increment PREAMBLE_POWER_RAMPING_COUNTER by 1.

In an example, for each Random Access Preamble: the MAC entity may select the value of DELTA_PREAMBLE; may set PREAMBLE _RECEIVED _TARGET _POWER to preambleReceivedTargetPower + DELTA _PREAMBLE + (PREAMBLE_POWER_RAMPING_COUNTER - 1) × PREAMBLE_POWER_RAMPING_STEP + POWER_OFFSET_2STEP_RA; except for contention-free Random Access Preamble for beam failure recovery request, may compute the RA-RNTI associated with the PRACH occasion in which the Random Access Preamble is transmitted; may instruct the physical layer to transmit the Random Access Preamble using the selected PRACH occasion, corresponding RA-RNTI (if available), PREAMBLE_INDEX, and PREAMBLE_RECEIVED_TARGET_POWER.

In an example, the RA-RNTI associated with the PRACH occasion in which the Random Access Preamble is transmitted, may be computed as: RA-RNTI = 1 + s_id + 14 × t_id + 14 × 80 × f_id + 14 × 80 × 8 × ul_carrier_id, where s_id may be the index of the first OFDM symbol of the PRACH occasion (0 ≤ s_id < 14), t_id may be the index of the first slot of the PRACH occasion in a system frame (0 ≤ t_id < 80), where the subcarrier spacing to determine t_id may be based on a value of µ, f_id may be the index of the PRACH occasion in the frequency domain (0 ≤ f_id < 8), and ul_carrier_id may be the UL carrier used for Random Access Preamble transmission (0 for NUL carrier, and 1 for SUL carrier). Example embodiments may enhance the RA-RNTI computation process above.

In an example, once the Random Access Preamble is transmitted and regardless of the possible occurrence of a measurement gap, if the contention-free Random Access Preamble for beam failure recovery request was transmitted by the MAC entity: the MAC entity may start the ra-ResponseWindow configured in BeamFailureRecoveryConfig at the first PDCCH occasion from the end of the Random Access Preamble transmission; the MAC entity may monitor for a PDCCH transmission on the search space indicated by recoverySearchSpaceId of the SpCell identified by the C-RNTI while ra-ResponseWindow is running.

In an example, once the Random Access Preamble is transmitted and regardless of the possible occurrence of a measurement gap, if the contention-free Random Access Preamble for beam failure recovery request was not transmitted by the MAC entity: the MAC entity may start the ra-ResponseWindow configured in RACH-ConfigCommon at the first PDCCH occasion from the end of the Random Access Preamble transmission; the MAC entity may monitor the PDCCH of the SpCell for Random Access Response(s) identified by the RA-RNTI while the ra-ResponseWindow is running.

In an example, once the Random Access Preamble is transmitted and regardless of the possible occurrence of a measurement gap, if notification of a reception of a PDCCH transmission on the search space indicated by recoverySearchSpaceId is received from lower layers on the Serving Cell where the preamble was transmitted; and if PDCCH transmission is addressed to the C-RNTI; and if the contention-free Random Access Preamble for beam failure recovery request was transmitted by the MAC entity: the MAC entity may consider the Random Access procedure successfully completed.

In an example, the Random Access Preamble may be transmitted. If a valid downlink assignment has been received on the PDCCH for the RA-RNTI and the received TB is successfully decoded: if the Random Access Response contains a MAC subPDU with Backoff Indicator: the MAC entity may set the PREAMBLE_BACKOFF to value of the BI field of the MAC subPDU, multiplied with SCALING_FACTOR_BI. If the Random Access Response does not contain a MAC subPDU with Backoff Indicator: the MAC entity may set the PREAMBLE_BACKOFF to 0 ms.

In an example, the Random Access Preamble may be transmitted. If the Random Access Response contains a MAC subPDU with Random Access Preamble identifier corresponding to the transmitted PREAMBLE_INDEX: the MAC entity may consider this Random Access Response reception successful. If the Random Access Response reception is considered successful: if the Random Access Response includes a MAC subPDU with RAPID only: the MAC entity may consider this Random Access procedure successfully completed; and may indicate the reception of an acknowledgement for SI request to upper layers. Otherwise, the MAC entity may apply the following actions for the Serving Cell where the Random Access Preamble was transmitted:
process the received Timing Advance Command; indicate the preambleReceivedTargetPower and the amount of power ramping applied to the latest Random Access Preamble transmission to lower layers (i.e. (PREAMBLE_POWER_RAMPING_COUNTER - 1) ×
PREAMBLE_POWER_RAMPING_STEP); if the Random Access procedure for an SCell is performed on uplink carrier where pusch-Config is not configured: ignore the received UL grant;
otherwise process the received UL grant value and indicate it to the lower layers. If the Random Access Preamble was not selected by the MAC entity among the contention-based Random Access Preamble(s): the MAC entity may consider the Random Access procedure successfully completed. Otherwise, the MAC entity may set the TEMPORARY_C-RNTI to the value received in the Random Access Response; if this is the first successfully received Random Access Response within this Random Access procedure: if the transmission is not being made for the CCCH logical channel: the MAC entity may indicate to the Multiplexing and assembly entity to include a C-RNTI MAC CE in the subsequent uplink transmission.

In an example, if within a Random Access procedure, an uplink grant provided in the Random Access Response for the same group of contention-based Random Access Preambles has a different size than the first uplink grant allocated during that Random Access procedure, the UE behavior is not defined.

In an example, ra-ResponseWindow configured in BeamFailureRecoveryConfig may expire and a PDCCH transmission on the search space indicated by recoverySearchSpaceId addressed to the C-RNTI may have not been received on the Serving Cell where the preamble was transmitted; or ra-ResponseWindow configured in RACH-ConfigCommon may expires, and the Random Access Response containing Random Access Preamble identifiers that matches the transmitted PREAMBLE_INDEX may have not been received. The MAC entity may consider the Random Access Response reception not successful; and the MAC entity may increment PREAMBLE_TRANSMISSION_COUNTER by 1. If PREAMBLE_TRANSMISSION_COUNTER = preambleTransMax + 1: if the Random Access Preamble is transmitted on the SpCell: the MAC entity may indicate a Random Access problem to upper layers; if this Random Access procedure was triggered for SI request: the MAC entity may consider the Random Access procedure unsuccessfully completed. Otherwise, if the Random Access Preamble is transmitted on an SCell: the MAC entity may consider the Random Access procedure unsuccessfully completed. If the Random Access procedure is not completed: the MAC entity may select a random backoff time according to a uniform distribution between 0 and the PREAMBLE_BACKOFF; if the criteria to select contention-free Random Access Resources is met during the backoff time: the MAC entity may perform the Random Access Resource selection procedure.

In an example, the MAC entity may stop ra-ResponseWindow (and hence monitoring for Random Access Response(s)) after successful reception of a Random Access Response containing Random Access Preamble identifiers that matches the transmitted PREAMBLE_INDEX.

In an example, prior to initiation of the physical random access procedure, Layer 1 may receive from higher layers a set of SS/PBCH block indexes and may provide to higher layers a corresponding set of RSRP measurements.

In an example, prior to initiation of the physical random access procedure, Layer 1 may receive from higher layers an indication to perform a Type-1 random access procedure or a Type-2 random access procedure.

In an example, prior to initiation of the physical random access procedure, Layer 1 may receive the following information from the higher layers: Configuration of physical random access channel (PRACH) transmission parameters (PRACH preamble format, time resources, and frequency resources for PRACH transmission); Parameters for determining the root sequences and their cyclic shifts in the PRACH preamble sequence set (index to logical root sequence table, cyclic shift ( N_{CS} ), and set type (unrestricted, restricted set A, or restricted set B)).

In an example, from the physical layer perspective, the Type-1 L1 random access procedure may include the transmission of random access preamble (Msg1) in a PRACH, random access response (RAR) message with a PDCCH/PDSCH (Msg2), and when applicable, the transmission of a PUSCH scheduled by a RAR UL grant, and PDSCH for contention resolution.

In an example, from the physical layer perspective, the Type-2 L1 random access procedure may include the transmission of random access preamble in a PRACH and of a PUSCH (MsgA) and the reception of a RAR message with a PDCCH/PDSCH (MsgB), and when applicable, the transmission of a PUSCH scheduled by a fallback RAR UL grant, and PDSCH for contention resolution.

In an example, if a random access procedure is initiated by a PDCCH order to the UE, a PRACH transmission may be with a same SCS as a PRACH transmission initiated by higher layers.

In an example, if a UE is configured with two UL carriers for a serving cell and the UE detects a PDCCH order, the UE may use the UL/SUL indicator field value from the detected PDCCH order to determine the UL carrier for the corresponding PRACH transmission.

In an example, physical random access procedure may be triggered upon request of a PRACH transmission by higher layers or by a PDCCH order. A configuration by higher layers for a PRACH transmission may include the following: a configuration for PRACH transmission; and a preamble index, a preamble SCS, P_{PRACH,target}, a corresponding RA-RNTI, and a PRACH resource.

In an example, a PRACH may be transmitted using the selected PRACH format with transmission power P_{PRACH,b,f,c}(i) on the indicated PRACH resource.

In an example, for Type-1 random access procedure, a UE may be provided a number N of SS/PBCH block indexes associated with one PRACH occasion and a number R of contention based preambles per SS/PBCH block index per valid PRACH occasion by ssb-perRACH-OccasionAndCB-PreamblesPerSSB.

In an example, for Type-2 random access procedure with common configuration of PRACH occasions with Type-1 random access procedure, a UE may be provided a number N of SS/PBCH block indexes associated with one PRACH occasion by ssb-perRACH-OccasionAndCB-PreamblesPerSSB and a number Q of contention based preambles per SS/PBCH block index per valid PRACH occasion by msgA-CB-PreamblesPerSSB-PerSharedRO. The PRACH transmission may be on a subset of PRACH occasions associated with a same SS/PBCH block index within an SSB-RO mapping cycle for a UE provided with a PRACH mask index by msgA-SSB-SharedRO-MaskIndex.

In an example, for Type-2 random access procedure with separate configuration of PRACH occasions with Type-1 random access procedure, a UE may be provided a number N of SS/PBCH block indexes associated with one PRACH occasion and a number R of contention based preambles per SS/PBCH block index per valid PRACH occasion by msgA-SSB-PerRACH-OccasionAndCB-PreamblesPerSSB when provided; otherwise, by ssb-perRACH-OccasionAndCB-PreamblesPerSSB.

In an example, for Type-1 random access procedure, or for Type-2 random access procedure with separate configuration of PRACH occasions from Type 1 random access procedure, if N < 1, one SS/PBCH block index is mapped to 1/N consecutive valid PRACH occasions and R contention based preambles with consecutive indexes associated with the SS/PBCH block index per valid PRACH occasion start from preamble index 0. If N ≥ 1, R contention based preambles with consecutive indexes associated with SS/PBCH block index n, 0 ≤ n ≤ N - 1, per valid PRACH occasion start from preamble index

$$n ⋅ {N}_{\text{preamble}}^{\text{total}} / N \text{where} {N}_{\text{preamble}}^{\text{total}}$$

may be provided by totalNumberOfRA-Preambles for Type-1 random access procedure, or by msgA-TotalNumberOfRA-Preambles for Type-2 random access procedure with separate configuration of PRACH occasions from a Type 1 random access procedure, and may be an integer multiple of N.

In an example, for Type-2 random access procedure with common configuration of PRACH occasions with Type-1 random access procedure, if N < 1, one SS/PBCH block index may be mapped to 1/N consecutive valid PRACH occasions and Q contention based preambles with consecutive indexes associated with the SS/PBCH block index per valid PRACH occasion start from preamble index R. If N ≥ 1, Q contention based preambles with consecutive indexes associated with SS/PBCH block index n, 0 ≤ n ≤ N - 1, per valid PRACH occasion start from preamble index

$$n ⋅ {N}_{\text{preamble}}^{\text{total}} / N + R , \text{where} {N}_{\text{preamble}}^{\text{total}}$$

is provided by totalNumberOfRA-Preambles for Type-1 random access procedure.

In an example, for link recovery, a UE may be provided N SS/PBCH block indexes associated with one PRACH occasion by ssb-perRACH-Occasion in BeamFailureRecoveryConfig. For a dedicated RACH configuration provided by RACH-ConfigDedicated, if cfra is provided, a UE may be provided N SS/PBCH block indexes associated with one PRACH occasion by ssb-perRACH-Occasion in occasions. If N < 1, one SS/PBCH block index is mapped to 1/N consecutive valid PRACH occasions. If N ≥ 1, all consecutive N SS/PBCH block indexes may be associated with one PRACH occasion.

In an example, SS/PBCH block indexes may be provided by ssb-PositionsInBurst in SIB1 or in ServingCellConfigCommon may be mapped to valid PRACH occasions in the following order. First, in increasing order of preamble indexes within a single PRACH occasion. Second, in increasing order of frequency resource indexes for frequency multiplexed PRACH occasions. Third, in increasing order of time resource indexes for time multiplexed PRACH occasions within a PRACH slot. Fourth, in increasing order of indexes for PRACH slots.

In an example, an association period, starting from frame 0, for mapping SS/PBCH block indexes to PRACH occasions may be the smallest value in the set determined by the PRACH configuration period such that

$${N}_{\text{Tx}}^{\text{SSB}}$$

SS/PBCH block indexes may be mapped at least once to the PRACH occasions within the association period, where a UE may obtain

$${N}_{\text{Tx}}^{\text{SSB}}$$

from the value of ssb-PositionsInBurst in SIB1 or in ServingCellConfigCommon. If after an integer number of SS/PBCH block indexes to PRACH occasions mapping cycles within the association period there may be a set of PRACH occasions or PRACH preambles that are not mapped to

$${N}_{\text{Tx}}^{\text{SSB}}$$

SS/PBCH block indexes, no SS/PBCH block indexes may be mapped to the set of PRACH occasions or PRACH preambles. An association pattern period may include one or more association periods and may be determined so that a pattern between PRACH occasions and SS/PBCH block indexes may repeat at most every 160 msec. PRACH occasions not associated with SS/PBCH block indexes after an integer number of association periods, if any, may not be used for PRACH transmissions.

In an example, for a PRACH transmission triggered by a PDCCH order, the PRACH mask index field, if the value of the random access preamble index field is not zero, may indicate the PRACH occasion for the PRACH transmission where the PRACH occasions are associated with the SS/PBCH block index indicated by the SS/PBCH block index field of the PDCCH order.

In an example, for a PRACH transmission triggered by higher layers, if ssb-ResourceList is provided, the PRACH mask index may be indicated by ra-ssb-OccasionMaskIndex which may indicate the PRACH occasions for the PRACH transmission where the PRACH occasions are associated with the selected SS/PBCH block index.

In an example, the PRACH occasions may be mapped consecutively per corresponding SS/PBCH block index. The indexing of the PRACH occasion indicated by the mask index value may be reset per mapping cycle of consecutive PRACH occasions per SS/PBCH block index. The UE may select for a PRACH transmission the PRACH occasion indicated by PRACH mask index value for the indicated SS/PBCH block index in the first available mapping cycle.

In an example, for the indicated preamble index, the ordering of the PRACH occasions may be: First, in increasing order of frequency resource indexes for frequency multiplexed PRACH occasions; Second, in increasing order of time resource indexes for time multiplexed PRACH occasions within a PRACH slot; Third, in increasing order of indexes for PRACH slots.

In an example, for a PRACH transmission triggered upon request by higher layers, a value of ra-OccasionList, if csirs-ResourceList is provided, may indicate a list of PRACH occasions for the PRACH transmission where the PRACH occasions may be associated with the selected CSI-RS index indicated by csi-RS. The indexing of the PRACH occasions indicated by ra-OccasionList may be reset per association pattern period.

In an example, in response to a PRACH transmission, a UE may attempt to detect a DCI format 1_0 with CRC scrambled by a corresponding RA-RNTI during a window controlled by higher layers. The window may start at the first symbol of the earliest CORESET the UE is configured to receive PDCCH for Type1-PDCCH CSS set that is at least one symbol, after the last symbol of the PRACH occasion corresponding to the PRACH transmission, where the symbol duration corresponds to the SCS for Type1-PDCCH CSS set. The length of the window in number of slots, based on the SCS for Type1-PDCCH CSS set, may be provided by ra-ResponseWindow.

In an example, if the UE detects the DCI format 1_0 with CRC scrambled by the corresponding RA-RNTI and LSBs of a SFN field in the DCI format 1_0, if included and applicable, may be same as corresponding LSBs of the SFN where the UE transmitted PRACH, and the UE may receive a transport block in a corresponding PDSCH within the window, the UE may pass the transport block to higher layers. The higher layers may parse the transport block for a random access preamble identity (RAPID) associated with the PRACH transmission. If the higher layers identify the RAPID in RAR message(s) of the transport block, the higher layers may indicate an uplink grant to the physical layer. This may be referred to as random access response (RAR) UL grant in the physical layer.

In an example, if the UE does not detect the DCI format 1_0 with CRC scrambled by the corresponding RA-RNTI within the window, or if the UE detects the DCI format 1_0 with CRC scrambled by the corresponding RA-RNTI within the window and LSBs of a SFN field in the DCI format 1_0, if included and applicable, not be same as corresponding LSBs of the SFN where the UE transmitted PRACH, or if the UE does not correctly receive the transport block in the corresponding PDSCH within the window, or if the higher layers do not identify the RAPID associated with the PRACH transmission from the UE, the higher layers may indicate to the physical layer to transmit a PRACH. If requested by higher layers, the UE may be expected to transmit a PRACH no later than NT_{T,1} +0.75 msec after the last symbol of the window, or the last symbol of the PDSCH reception, where N_{T,1} is a time duration of N₁ symbols corresponding to a PDSCH processing time for UE processing capability 1 assuming µ corresponds to the smallest SCS configuration among the SCS configurations for the PDCCH carrying the DCI format 1_0, the corresponding PDSCH when additional PDSCH DM-RS is configured, and the corresponding PRACH. For µ = 0, the UE may assume N_{1,0} = 14 . For a PRACH transmission using 1.25 kHz or 5 kHz SCS, the UE may determine N₁ assuming SCS configuration µ-0.

In an example, if the UE detects a DCI format 1_0 with CRC scrambled by the corresponding RA-RNTI and LSBs of a SFN field in the DCI format 1_0, if included and applicable, are same as corresponding LSBs of the SFN where the UE transmitted the PRACH, and the UE may receive a transport block in a corresponding PDSCH, the UE may assume same DM-RS antenna port quasi co-location properties as for a SS/PBCH block or a CSI-RS resource the UE used for PRACH association regardless of whether or not the UE is provided TCI-State for the CORESET where the UE receives the PDCCH with the DCI format 1_0.

In an example, if the UE attempts to detect the DCI format 1_0 with CRC scrambled by the corresponding RA-RNTI in response to a PRACH transmission initiated by a PDCCH order that triggers a contention-free random access procedure for the SpCell, the UE may assume that the PDCCH that includes the DCI format 1_0 and the PDCCH order have same DM-RS antenna port quasi co-location properties. If the UE attempts to detect the DCI format 1_0 with CRC scrambled by the corresponding RA-RNTI in response to a PRACH transmission initiated by a PDCCH order that triggers a contention-free random access procedure for a secondary cell, the UE may assume the DM-RS antenna port quasi co-location properties of the CORESET associated with the Type1-PDCCH CSS set for receiving the PDCCH that includes the DCI format 1_0.

In an example, a RAR UL grant may schedule a PUSCH transmission from the UE.

In an example, if the value of the frequency hopping flag is 0, the UE may transmit the PUSCH without frequency hopping; otherwise, the UE may transmit the PUSCH with frequency hopping.

In an example, the UE may determine the MCS of the PUSCH transmission from the first sixteen indexes of the applicable MCS index table for PUSCH.

In an example, unless the UE is configured a SCS, the UE may receive subsequent PDSCH using same SCS as for the PDSCH reception providing the RAR message.

In an example random access process, a UE may re-transmit Msg1 using a different beam compared to a previous Msg1 transmission when the UE does not receive a RAR for the UE corresponding to the previous Msg1 transmission. Because the UE can use only one beam per Msg1 transmission, the average time required for the UE to complete initial access may be longer in case the UE has multiple beams to try for initial access. The longer initial access time may also increase the possibility that the SSB the UE selected and obtained system information from does not remain the best SSB, for example due to UE mobility.

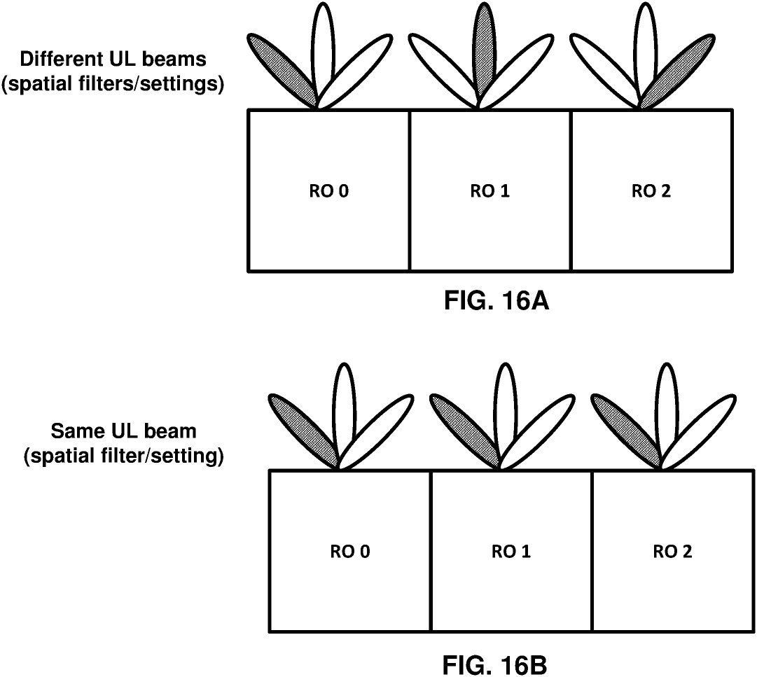

In an example, to improve coverage for Msg1 and to enable transmission from different beams, an RO bundle may be considered for multiple PRACH transmissions. An RO bundle may include a number of ROs and the UE may transmit PRACH per RO bundle (e.g., instead of per RO). Using an RO bundle may enhance beamforming gain and link budget gain. For example, transmitting preambles (e.g., repetitions of a preamble) from multiple UL Tx beams at one RACH attempt (e.g., PRACH sweeping) as shown in FIG. 16A may enable a UE to identify a suitable UL Tx beam with fewer re-attempts for Msg1 transmission and thus may reduce access latency. For example, the preambles in different ROs (with same UL Tx beams) in a RO bundle (e.g., repetitions of a preamble) and may provide link budget enhancement for PRACH reception as shown in FIG. 16B.

In an example, whether or not a UE uses a same or different uplink beams (e.g., spatial settings/filters) for PRACH transmissions over an RO bundle may be controlled by gNB. For example, for FR1 or if SSBs are relatively narrow-beam in FR2, a gNB may signal to the UE to use a same spatial setting to transmit PRACH over the RO bundle; otherwise, the gNB may signal to the UE to use different spatial settings.

In an example, when CSI-RS resources are configured and assuming a UE capability for beam reciprocity, a UE may determine channel qualities associated with different spatial settings by performing measurements based on receptions in the CSI-RS resources. The UE may transmit a PRACH preamble with the best uplink beam/ spatial setting (e.g., the uplink beam/ spatial setting resulting the largest RSRP). The UE may also transmit PRACH preambles over more than one uplink beam/ spatial setting. For example, for robustness at the expense of additional PRACH resources, the UE may transmit a PRACH preamble with the second best uplink beam/ spatial setting.

Example embodiments may enhance uplink coverage for physical random access channel (PRACH). Uplink coverage enhancement for PRACH may be used in procedures such as initial access and beam failure recovery. In an example, to enable PRACH coverage enhancement, multiple PRACH transmissions with same beam may be used, for example in a 4-step RACH procedure. In an example, to enable PRACH coverage enhancement, multiple PRACH transmissions with different beams may be used, for example, in a 4-step RACH procedure. The PRACH coverage enhancement may be for FR2 and/or for FR1. In an example, to enable PRACH coverage enhancement, a short PRACH format and/or other formats may be used.

Example embodiments may be implemented in a wireless device that is in an RRC idle state (e.g., for initial access) or in a wireless device that is in an RRC inactive state (e.g., for transitioning from the RRC inactive state to an RRC connected state) or in a wireless device that is in an RRC connected state (e.g., for a random access during the RRC connected state, e.g., for beam failure recovery, link failure, etc.).

In example embodiments, a random access process may be of a first type or of a second type.

A random access process of the first type may comprise transmitting a plurality of random access preambles (e.g., via a single uplink beam (e.g., spatial filter/setting) or via multiple uplink beams (e.g., spatial filters/settings)) in each preamble/Msg1 transmission attempt. In an example, the wireless device may transmit a plurality of random access preambles for a corresponding preamble transmission counter value in the random access process of the first type. In an example, the wireless device may start monitoring for a random access response after transmission of a first random access preamble (e.g., in a first/earliest control channel occasion after the earliest random access preamble in the plurality of random access occasions, e.g., in a first/earliest control channel occasion after the latest random access preamble in the plurality of random access occasions) in the plurality of random access preambles. In an example, the wireless device may transmit at least one random access preamble of the plurality of random access preambles during a random access response window for control channel monitoring (e.g., for reception of DCI comprising scheduling information for reception of random access response).

A random access process of the second type may comprise transmitting a single random access preambles in each preamble/Msg1 transmission attempt. In an example, the wireless device may transmit a single random access preamble for a corresponding preamble transmission counter value in the random access process of the second type. In an example, the wireless device may start monitoring for a random access response after transmission of the random access preamble, e.g., in a first/earliest control channel occasion after the random access preamble.

In example embodiments, a spatial setting and/or a spatial filter and/or a spatial relation information and/or a beamforming function and/or a mapping function used by a wireless device in an uplink transmission (e.g., for PRACH transmission, etc.) may determine characteristics of the uplink beam (e.g., shape, direction, power, etc.) used for the uplink transmission. The wireless device may utilize a plurality of spatial settings and/or spatial filters and/or spatial relations information and/or beamforming functions and/or a mapping function to enable a plurality of uplink beams.

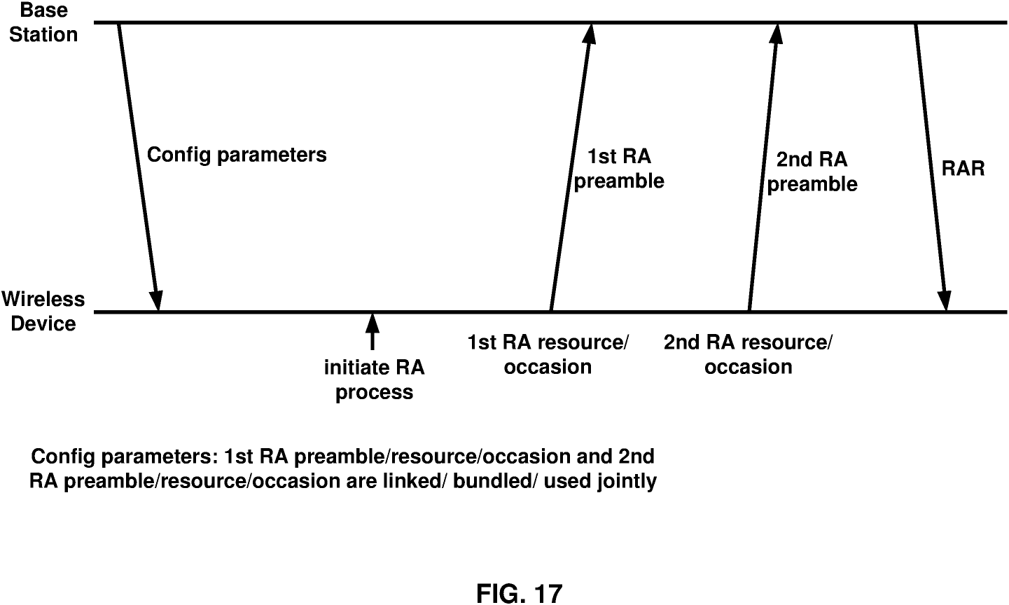

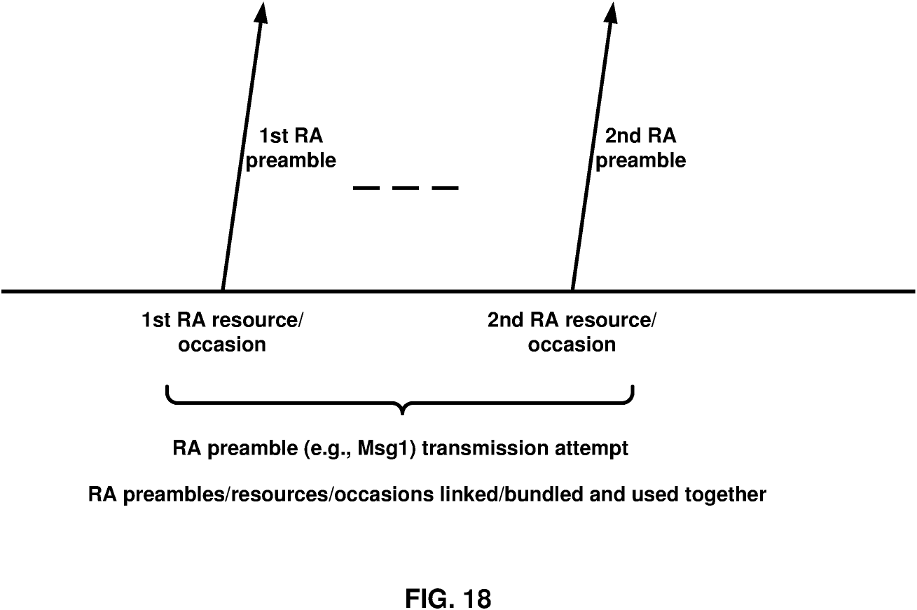

In an example embodiment as shown in FIG. 17, a wireless device may receive one or more configuration parameters (e.g., based on receiving one or more RRC messages comprising at least a portion of the one or more configuration parameters and/or based on receiving a broadcast message e.g., a SIB message comprising at least a portion of the one or more configuration parameters) for performing/initiating random access processes. The one or more configuration parameters may indicate that a plurality of random access preambles/resources/occasions are linked together (e.g., used together/jointly) and/or bundled in a bundle/group for transmission of random access preambles (e.g., Msg1) in a random access process. The plurality of the random access preamble/resources/occasions may comprise a first random access preamble/resource/occasion and a second random access preamble/resource/occasion. In an example as shown in FIG. 18, for preamble transmission (e.g., Msg1) attempt (e.g., for preamble transmission for a given preamble transmission counter value), a plurality of random access preambles may be transmitted in their corresponding random access occasions and via their corresponding random access resources.

The wireless device may initiate a random access process, e.g., autonomously based on a determination at the wireless device or in response to a PDCCH order, from a base station, indicating a command/order to initiate the random access process. In response to initiating the random access process, the wireless device may transmit the first random access process preamble, in the corresponding first random access occasion and via the corresponding first random access resource and may transmit the second random access preamble in the corresponding second random access occasion and via the corresponding second random access resource. In an example, in response to initiating the random access process, the wireless device may transmit a plurality of random access preambles, comprising the first random access preamble and the second random access preamble, in their corresponding random access occasions and via their corresponding random access resources.

In an example, the plurality of random access preambles/resources/occasions (e.g., comprising the first random access preamble/ resource/ occasion and the second random access preamble/ resource/ occasion) may be associated with the same uplink beam (e.g., the same spatial setting/ filter). The wireless device may transmit the plurality of random access preambles via the same uplink beam (e.g., the same spatial setting/ filter).

In an example, the one or more configuration parameters may indicate that the plurality of random access preambles/ resources/ occasions are associated with the same uplink beam (e.g., spatial setting/ filter). In an example, the one or more configuration parameters may comprise one or more first parameter indicating that the plurality of random access preambles/ resources/ occasions are associated with the same uplink beam (e.g., spatial filter/setting), e.g., based on indicating the same identifier/ index of the same uplink beam (e.g., spatial setting/ filter) for the plurality of random access preambles/resources/occasions. In an example, the wireless device may determine the uplink beam (e.g., spatial filter/setting) associated with the plurality of random access preambles/resources/occasions based on the identifier/index (e.g., the configured identifier/index) of the uplink beam/ spatial filter/ spatial setting associated with the plurality of random access preambles/ resources/ occasions. In response to determining that the uplink beam (e.g., the spatial filter/setting) associated with the plurality of random access preambles/resources/occasions being the same, the wireless device may transmit the plurality of random access preambles (e.g., comprising the first random access preamble and the second random access preamble) based on/via the same uplink beam (e.g., spatial filter/setting).

In an example, the wireless device may determine the uplink beam (e.g., spatial filter/setting) associated with the plurality of random access preambles/resources/occasions based on the wireless device implementation.

In an example, the wireless device may determine the uplink beam (e.g., spatial filter/setting) associated with the plurality of random access preambles/ resources/ occasions based on an indication/ command/ order from the base station, e.g., an indication/ command/ order for initiating the random access process, e.g., a PDCCH order. In an example, the indication/ command/ order (e.g., the PDCCH order) may comprise a field with a value indicating the uplink beam (e.g., spatial filter/ setting), e.g., indicating an identifier/index of the uplink beam (e.g., spatial filter/setting) for transmission of the plurality of random access preambles.

In an example, the plurality of random access preambles/ resources/ occasions (e.g., a bundle/group comprising the first random access preamble/ resource/ occasion and the second random access preamble/ resource/ occasion) may be associated with a plurality of uplink beams (e.g., a plurality of spatial settings/ filters) comprising the first uplink beam (e.g., the first spatial filter/setting) and the second uplink beam (e.g., the second spatial filter/setting). The wireless device may transmit the plurality of random access preambles via the plurality of uplink beams (e.g., a plurality of spatial settings/ filters). For example, the first random access preamble/ resource/ occasion may be for transmission via/ associated with a first uplink beam (e.g., a first spatial filter/setting) and the second random access preamble/resource/occasion may be for transmission via/ associated with a second uplink beam (e.g., a second spatial filter/setting). For example, the one or more configuration parameters may indicate that the first random access preamble/ resource/ occasion may be for transmission via/ associated with a first uplink beam (e.g., a first spatial filter/setting) and the second random access preamble/ resource/ occasion may be for transmission via/ associated with a second uplink beam (e.g., a second spatial filter/ setting).

In an example, the first random access preamble/resource/occasion may be associated with a first identifier/index of the first uplink beam (e.g., spatial filter/setting) and the second random access preamble/resource/occasion may be associated with a second identifier/index of the second uplink beam (e.g., spatial filter/setting). For example, the one or more configuration parameters may indicate that the first random access preamble/ resource/ occasion is associated with the first identifier/index and the second random access preamble/ resource/ occasion is associated with the second identifier/index. In an example, an identifier/index of an uplink beam (spatial filter/setting) in a plurality of uplink beams (e.g., spatial filters/settings) may be based on relative timing of random access occasions/resources of the random access preambles transmitted via the plurality of uplink beams. For example, the first identifier/index and the second identifier/index may be based on relative timings of the first random access occasion/resource and the second random access occasion/resource. For example, the first identifier/index may have a lower value than the second identifier/index based on first random access being earlier than the second random access occasion.

In an example, the wireless device may receive an indication/ command/ order from the base station, e.g., an indication/ command/ order for initiating the random access process, e.g., a PDCCH order. In an example, the indication/ command/ order (e.g., the PDCCH order) may comprise one or more fields with values indicating the first uplink beam (e.g., the first spatial filter/ setting), e.g., indicating an identifier/index of the first uplink beam (e.g., the first spatial filter/ setting) and the second uplink beam (e.g., the second spatial filter/ setting), e.g., indicating an identifier/index of the second uplink beam (e.g., the second spatial filter/ setting).

In an example, the wireless device may determine the first uplink beam (e.g., spatial filter/setting) based on the first identifier/index and may determine the second uplink beam (e.g., spatial filter/setting) based on the second identifier. In an example, the wireless device may determine the first uplink beam (e.g., spatial filter/setting) and the second uplink beam (e.g., spatial filter/setting) based on the wireless device implementation.

In an example, the first random access preamble/resource/occasion may be associated with a first identifier and the second random access preamble/resource/occasion may be associated with a second identifier. In an example, an identifier of a random access preamble/resource/occasion may be based on the relative timing of the random access preamble/resource/occasion in a plurality of random access preambles/resources/occasions. For example, the first identifier may have a lower value than the second identifier based on the first random access occasion being earlier than the second random access occasion. The wireless device may determine the first uplink beam (e.g., spatial filter/setting) and the second uplink beam (e.g., spatial filter/setting) based on the first identifier of the first random access occasion and the second identifier of the second random access occasion.

Based on the association of the first random access preamble/resource/occasion and the first uplink beam (e.g., the first spatial filter/ setting) and the association of the second random access preamble/resource/occasion and the second uplink beam (e.g., the second spatial filter/setting), the wireless device may transmit the first random access preamble based on/ via the first uplink beam (e.g., the first spatial filter/setting) and may transmit the second random access preamble based on/ via the second uplink beam (e.g., the second spatial filter/setting).

In an example, the plurality of random access preambles (e.g., comprising the first random access preamble and the second random access preamble) may be the same, e.g., may be repetitions of the same random access preamble. In an example, at least some of the plurality of random access preambles may be the same. In an example, at least some of the plurality of random access preambles may be different.

The wireless device may receive a random access response (RAR). The wireless device may receive the random access response based on (e.g., in response to) monitoring a control channel (e.g., PDCCH) for one or more RNTIs (e.g., one or more RA-RNTIs). The wireless device may monitor the control channel during a random access response window. The wireless device may receive a configuration parameter indicating a duration of the of random access response window. In an example, the wireless device may determine a starting time of a random access response window and may determine the time window to monitor for the control channel associated with the RAR based on the starting time of the random access response window and based on the duration (e.g., the configured duration) of the random access response window.

In an example, the wireless device may monitor the control channel in response to (e.g., after, e.g., on or after a first/earliest control channel occasion after the timing of) the transmission of the first random access preamble (e.g., the first random access occasion associated with the first random access preamble). In an example, the wireless device may monitor the control channel in response to (e.g., after, e.g., on or after a first/earliest control channel occasion after the timing of) the transmission of the earliest random access preamble in the plurality of the random access preambles. In an example, the wireless device may receive the RAR in response to (e.g., after, e.g., on or after a first/earliest control channel occasion after the timing of) the transmission of the first random access preamble (e.g., the first random access occasion associated with the first random access preamble). In an example, the wireless device may receive the RAR in response to (e.g., after, e.g., on or after a first/earliest symbol after the timing of) the transmission of the earliest random access preamble in the plurality of the random access preambles.

In an example, the wireless device may monitor the control channel in response to (e.g., after, e.g., on or after a first/earliest control channel occasion after the timing of) the transmission of the second random access preamble (e.g., the second random access occasion associated with the second random access preamble). In an example, the wireless device may monitor the control channel in response to (e.g., after, e.g., on or after a first/earliest control channel occasion after the timing of) the transmission of the latest random access preamble in the plurality of the random access preambles. In an example, the wireless device may monitor the control channel only after (e.g., on or after a first/earliest control channel occasion after) transmission of the plurality of the random access preambles. In an example, the wireless device may receive the RAR in response to (e.g., after, e.g., on or after a first/earliest control channel occasion after the timing of) the transmission of the second random access preamble (e.g., the second random access occasion associated with the second random access preamble). In an example, the wireless device may receive the RAR in response to (e.g., after, e.g., on or after a first control channel occasion after the timing of) the transmission of the latest random access preamble in the plurality of the random access preambles. In an example, the wireless device may receive the RAR only after (e.g., on or after a first control channel occasion after) transmission of the plurality of the random access preambles.

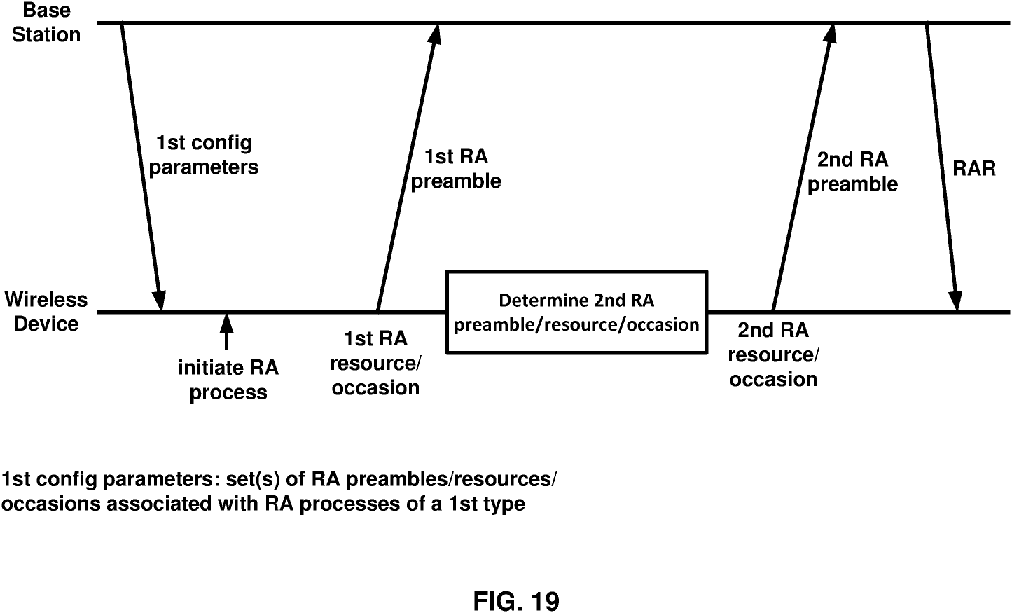

In an example embodiment as shown in FIG. 19, a wireless device may receive one or more first configuration parameters (e.g., based on receiving one or more RRC messages comprising at least a portion of the one or more first configuration parameters and/or based on receiving a broadcast message e.g., a SIB message comprising at least a portion of the one or more first configuration parameters) indicating one or more sets of random access preambles/ resources/ occasions that are associated with random access processes of the first type. The one or more sets of random access preambles/ resources/ occasions may comprise a first set of one or more random access preambles/ resources/ occasions.

In an example, the wireless device may further receive one or more second configuration parameters indicating one or more second configuration parameters for random access processes of the second type. In an example, the wireless device may utilize the one or more first configuration parameters for random access processes of the first type and may utilize the one or more second configuration parameters for random access processes of the second type. The wireless device may perform a random access process of the first type based on the one or more first configuration parameters and the wireless device may perform a random access process of the second type based on the one or more second configuration parameters.

The wireless device may initiate a random access process, e.g., autonomously based on a determination at the wireless device or in response to a PDCCH order, from a base station, indicating a command/order to initiate the random access process. In response to initiating the random access process, the wireless device may transmit a first random access process preamble, in the corresponding first random access occasion and via the corresponding first random access resource. The wireless device may determine a second random access preamble/ resource/ occasion based on the first random access preamble/ resource/ occasion. In an example, the wireless device may determine the second random access preamble/resource/occasion from the first set of the one or more random access preambles/resources/occasions. The wireless device may transmit a second random access process preamble, in the corresponding second random access occasion and via the corresponding second random access resource.

In an example, the wireless device may transmit the first random access preamble based on/ vi an uplink beam (spatial filter/setting). The first random access preamble/resource/occasion may be associated with the uplink beam (spatial filter/setting). The wireless device may transmit the second random access preamble based on/ via the uplink beam (spatial filter/setting). The second random access preamble/resource/occasion may be associated with the uplink beam (spatial filter/setting). The uplink beam (spatial filter/setting) may be used for transmission of the first random access preamble and the second random access preamble. In an example, the one or more first configuration parameters may indicate that the first random access preamble/resource/occasion and the second random access preamble/resource/occasion are associated with the uplink beam (spatial filter/setting) and/or may indicate that the first random access preamble/resource/occasion and the second random access preamble/resource/occasion are associated with the same uplink beam (spatial filter/setting).

In an example, the first set of the one or more random access preambles/ resources/ occasions may be associated with an uplink beam (e.g., spatial filter/setting). In an example, each set of the one or more sets of random access preambles/ resources/ occasions may be associated with a corresponding uplink beam (e.g., spatial filter/setting). In an example, the wireless device may receive an indication from a base station (e.g., a PDCCH order) indicating the first set of the one or more random access preambles/resources/occasions, in the one or more sets of random access preambles/resources/occasions for the random access process. In an example, based on the first random access preamble/resource/occasion and the second random access preamble/resource/occasion being from the same set (e.g., the first set) of random access preambles/resources/occasion, the wireless device may transmit the first random access preamble and the second random access preamble based on/ via the same uplink beam (e.g., spatial filter/setting).

In an example, the wireless device may transmit the first random access preamble based on/ vi a first uplink beam (spatial filter/setting). The first random access preamble/resource/occasion may be associated with the first uplink beam (spatial filter/setting). The wireless device may transmit the second random access preamble based on/ via a second uplink beam (spatial filter/setting). The second random access preamble/resource/occasion may be associated with the second uplink beam (spatial filter/setting). Different uplink beams (spatial filters/settings) may be used for transmission of the first random access preamble and the second random access preamble.

In an example, the one or more first configuration parameters may indicate that the first random access preamble/resource/occasion is associated with the first uplink beam (spatial filter/setting) and the second random access preamble/resource/occasion is associated with the second uplink beam (spatial filter/setting) and/or may indicate that the first random access preamble/resource/occasion and the second random access preamble/resource/occasion are associated with different uplink beams (spatial filters/settings).

In an example, the wireless device may determine, based on wireless device implementation, the first uplink beam (spatial filter/setting) for transmission of the first random access preamble. The wireless device may determine the second uplink beam (spatial filter/setting) based on the first uplink beam (spatial filter/setting).

In an example, the wireless device may determine, based on wireless device implementation, the first uplink beam (spatial filter/setting) for transmission of the first random access preamble and may determine, based on the wireless device implementation, the second uplink beam (spatial filter/setting) for transmission of the second random access preamble.

The wireless device may receive a random access response (RAR). The wireless device may receive the random access response based on (e.g., in response to) monitoring a control channel (e.g., PDCCH) for one or more RNTIs (e.g., one or more RA-RNTIs). The wireless device may monitor the control channel during a random access response window. The wireless device may receive a configuration parameter indicating a duration of the of random access response window. In an example, the wireless device may determine a starting time of a random access response window and may determine the time window to monitor for the control channel associated with the RAR based on the starting time of the random access response window and based on the duration (e.g., the configured duration) of the random access response window.

In an example, the wireless device may monitor the control channel in response to (e.g., after, e.g., on or after a first/earliest control channel occasion after the timing of) the transmission of the first random access preamble (e.g., the first random access occasion associated with the first random access preamble). In an example, the wireless device may monitor the control channel in response to (e.g., after, e.g., on or after a first/earliest control channel occasion after the timing of) the transmission of the earliest random access preamble in the plurality of the random access preambles comprising the first random access preamble and the second random access preamble. In an example, the wireless device may receive the RAR in response to (e.g., after, e.g., on or after a first/earliest control channel occasion after the timing of) the transmission of the first random access preamble (e.g., the first random access occasion associated with the first random access preamble). In an example, the wireless device may receive the RAR in response to (e.g., after, e.g., on or after a first/earliest control channel occasion after the timing of) the transmission of the earliest random access preamble in the plurality of the random access preambles comprising the first random access preamble and the second random access preamble.

In an example, the wireless device may monitor the control channel in response to (e.g., after, e.g., on or after a first/earliest control channel occasion after the timing of) the transmission of the second random access preamble (e.g., the second random access occasion associated with the second random access preamble). In an example, the wireless device may monitor the control channel in response to (e.g., after, e.g., on or after a first control channel occasion after the timing of) the transmission of the latest random access preamble in the plurality of the random access preambles comprising the first random access preamble and the second random access preamble. In an example, the wireless device may monitor the control channel only after (e.g., in a first/earliest control channel occasion after) transmission of the plurality of the random access preambles. In an example, the wireless device may receive the RAR in response to (e.g., after, e.g., on or after a first/earliest control channel occasion after the timing of) the transmission of the second random access preamble (e.g., the second random access occasion associated with the second random access preamble). In an example, the wireless device may receive the RAR in response to (e.g., after, e.g., on or after a first/earliest control channel occasion after the timing of) the transmission of the latest random access preamble in the plurality of the random access preambles comprising the first random access preamble and the second random access preamble. In an example, the wireless device may receive the RAR only after (e.g., on or after a first control channel occasion after) transmission of the plurality of the random access preambles.

In an example, the plurality of random access preambles (e.g., comprising the first random access preamble and the second random access preamble) may be the same, e.g., may be repetitions of the same random access preamble. In an example, at least some of the plurality of random access preambles (e.g., comprising the first random access preamble and the second random access preamble) may be the same. In an example, at least some of the plurality of random access preambles (e.g., comprising the first random access preamble and the second random access preamble) may be different.

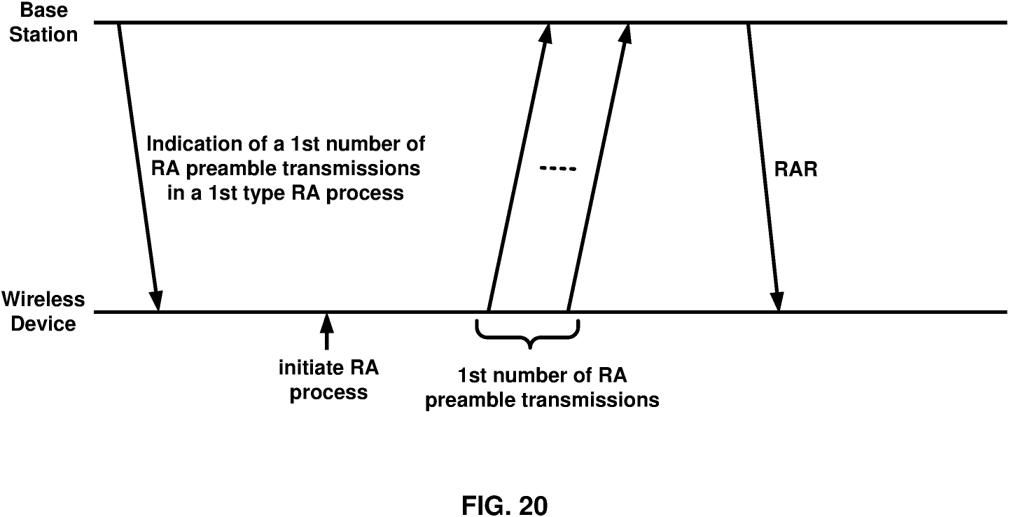

In an example embodiment a shown in FIG. 20, a wireless device may receive an indication (e.g., based on a DCI/physical layer signaling and/or based on a MAC CE and/or based on one or more configuration parameters (e.g., received based on one or more RRC messages or a broadcast message, e.g., SIB)) of a first number of random access preamble transmissions in random access processes of the first type. The wireless device may initiate a random access process e.g., autonomously based on a determination at the wireless device or in response to a PDCCH order, from a base station, indicating a command/order to initiate the random access process. In response to initiating the random access process, the wireless device may transmit a plurality of random access preambles (e.g., for Msg1 transmission). The plurality of random-access preambles may be transmitted for a preamble transmission attempt, e.g., for a given value of preamble transmission counter. A number of the plurality of random access preambles may be (e.g., may be determined based on) the indication of the first number from the base station.

In an example, the wireless device may receive a command/order (e.g., may receive a DCI as a PDCCH order) from a base station for starting/initiating a random access process (e.g., a random access process of the first type). The order/command (e.g., the DCI) may indicate the first number. In an example, the command/order (e.g., the DCI) may comprise a field with a value indicating the first number. In an example, a parameter associated with the order/command (e.g., the DCI) may indicate the first number.

The wireless device may receive a random access response. The wireless device may receive the random access response based on (e.g., in response to) monitoring a control channel (e.g., PDCCH) for one or more RNTIs (e.g., one or more RA-RNTIs). The wireless device may monitor the control channel during a random access response window. The wireless device may receive a configuration parameter indicating a duration of the of random access response window. In an example, the wireless device may determine a starting time of a random access response window and may determine the time window to monitor for the control channel associated with the RAR based on the starting time of the random access response window and based on the duration (e.g., the configured duration) of the random access response window.

In an example, the wireless device may monitor the control channel in response to (e.g., after, e.g., on or after a first/earliest control channel occasion after the timing of) the transmission of the earliest random access preamble in the plurality of the random access preambles. In an example, the wireless device may receive the RAR in response to (e.g., after, e.g., on or after a first/earliest control channel occasion after the timing of) the transmission of the earliest random access preamble in the plurality of the random access preambles.

In an example, the wireless device may monitor the control channel in response to (e.g., after, e.g., on or after a first/earliest control channel occasion after the timing of) the transmission of the latest random access preamble in the plurality of the random access preambles. In an example, the wireless device may monitor the control channel only after (e.g., on or after a first/earliest control channel occasion after) transmission of the plurality of the random access preambles. In an example, the wireless device may receive the RAR in response to (e.g., after, e.g., on or after a first/earliest control channel occasion after the timing of) the transmission of the latest random access preamble in the plurality of the random access preambles. In an example, the wireless device may receive the RAR only after (e.g., on or after a first/earliest control channel occasion after) transmission of the plurality of the random access preambles.

In an example, the plurality of random access preambles may be the same, e.g., may be repetitions of the same random access preamble. In an example, at least some of the plurality of random access preambles may be the same. In an example, at least some of the plurality of random access preambles may be different.

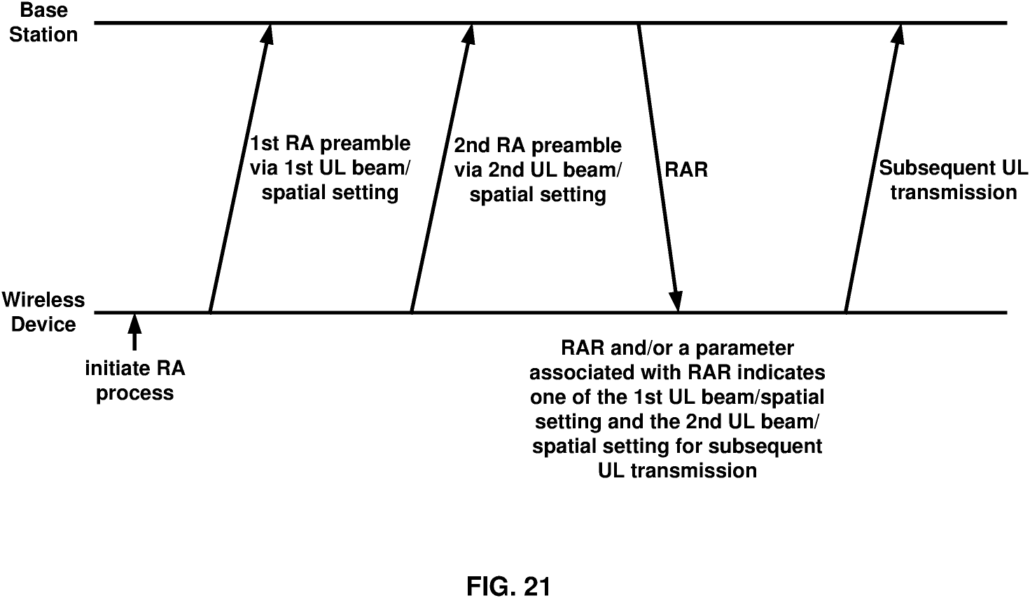

In an example embodiment as shown in FIG. 21, a wireless device may initiate a random access process, e.g., autonomously based on a determination at the wireless device or in response to a PDCCH order, from a base station, indicating a command/order to initiate the random access process. In an example, the random access process may be of the first type. In response to initiating the random access process, the wireless device may transmit a plurality of random access preambles comprising a first random access preamble and a second random access preamble. In response to initiating the random access process, the wireless device may transmit the first random access process preamble based on/ via a first uplink beam (spatial filter/setting) and may transmit the second random access preamble based on/ via a second uplink beam (spatial filter/setting).

The wireless device may receive a random access response (RAR). The wireless device may receive the random access response based on (e.g., in response to) monitoring a control channel (e.g., PDCCH) for one or more RNTIs (e.g., one or more RA-RNTIs). The wireless device may monitor the control channel during a random access response window. The wireless device may receive a configuration parameter indicating a duration of the of random access response window. In an example, the wireless device may determine a starting time of a random access response window and may determine the time window to monitor for the control channel associated with the RAR based on the starting time of the random access response window and based on the duration (e.g., the configured duration) of the random access response window.

In an example, the wireless device may monitor the control channel in response to (e.g., after, e.g., in on or after first/earliest control channel occasion after the timing of) the transmission of the first random access preamble (e.g., the first random access occasion associated with the first random access preamble). In an example, the wireless device may monitor the control channel in response to (e.g., after, e.g., on or after a first/earliest control channel occasion after the timing of) the transmission of the earliest random access preamble in a plurality of the random access preambles comprising the first random access preamble and the second random access preamble. In an example, the wireless device may receive the RAR in response to (e.g., after, e.g., on or after a first/earliest control channel occasion after the timing of) the transmission of the first random access preamble (e.g., the first random access occasion associated with the first random access preamble). In an example, the wireless device may receive the RAR in response to (e.g., after, e.g., on or after a first/earliest control channel occasion after the timing of) the transmission of the earliest random access preamble in a plurality of the random access preambles comprising the first random access preamble and the second random access preamble.

In an example, the wireless device may monitor the control channel in response to (e.g., after, e.g., on or after a first/earliest control channel occasion after the timing of) the transmission of the second random access preamble (e.g., the second random access occasion associated with the second random access preamble). In an example, the wireless device may monitor the control channel in response to (e.g., after, e.g., on or after a first/earliest control channel occasion after the timing of) the transmission of the latest random access preamble in a plurality of the random access preambles comprising the first random access preamble and the second random access preamble. In an example, the wireless device may monitor the control channel only after (e.g., on or after a first/earliest control channel occasion after) transmission of the plurality of the random access preambles. In an example, the wireless device may receive the RAR in response to (e.g., after, e.g., on or after a first/earliest control channel occasion after the timing of) the transmission of the second random access preamble (e.g., the second random access occasion associated with the second random access preamble). In an example, the wireless device may receive the RAR in response to (e.g., after, e.g., on or after a first/earliest control channel occasion after the timing of) the transmission of the latest random access preamble in the plurality of the random access preambles. In an example, the wireless device may receive the RAR only after (e.g., on or after a first/earliest control channel occasion after) transmission of the plurality of the random access preambles.

In an example, a plurality of random access preambles (e.g., comprising the first random access preamble and the second random access preamble) may be the same, e.g., may be repetitions of the same random access preamble. In an example, at least some of the plurality of random access preambles may be the same. In an example, at least some of the plurality of random access preambles may be different.

The RAR (e.g., the content of the RAR and/or a parameter associated with the RAR) may indicate one of first uplink beam (spatial filter/setting) and the second uplink beam (spatial filter/setting) for a subsequent uplink transmission (e.g., for transmission of Msg3 in a 4-step random access process or for transmission of a Msg B in a 2-step random access process or for an uplink transmission after completion of the random access process). For example, the RAR may comprise a field with a value indicating one of the first uplink beam (e.g., spatial filter/setting) and the second uplink beam (e.g., spatial filter/setting) for the subsequent uplink transmission. For example, the RAR may comprise an uplink grant indicating one of the first uplink beam (e.g., spatial filter/setting) and the second uplink beam (e.g., spatial filter/setting) for the subsequent uplink transmission. For example, the uplink grant, included in RAR, may comprise a field with a value indicating one of the first uplink beam (e.g., spatial filter/setting) and the second uplink beam (e.g., spatial filter/setting) for the subsequent uplink transmission. For example, a value of a frequency hopping flag filed of the uplink grant may indicate one of the first uplink beam (e.g., spatial filter/setting) and the second uplink beam (e.g., spatial filter/setting) for the subsequent uplink transmission. For example, a value of a frequency resource allocation filed of the uplink grant may indicate one of the first uplink beam (e.g., spatial filter/setting) and the second uplink beam (e.g., spatial filter/setting) for the subsequent uplink transmission. For example, a value of a time resource allocation filed of the uplink grant may indicate one of the first uplink beam (e.g., spatial filter/setting) and the second uplink beam (e.g., spatial filter/setting) for the subsequent uplink transmission. For example, a value of a modulation and coding scheme filed of the uplink grant may indicate one of the first uplink beam (e.g., spatial filter/setting) and the second uplink beam (e.g., spatial filter/setting) for the subsequent uplink transmission. For example, a value of a transmit power control (TPC) filed of the uplink grant may indicate one of the first uplink beam (e.g., spatial filter/setting) and the second uplink beam (e.g., spatial filter/setting) for the subsequent uplink transmission. For example, a value of a channel state information (CSI) request filed of the uplink grant may indicate one of the first uplink beam (e.g., spatial filter/setting) and the second uplink beam (e.g., spatial filter/setting) for the subsequent uplink transmission. For example, a value of a field of the RAR, or a value of a field of the uplink grant included in the RAR, may indicate an identifier of the uplink beam (spatial filter/setting) for the subsequent uplink transmission.

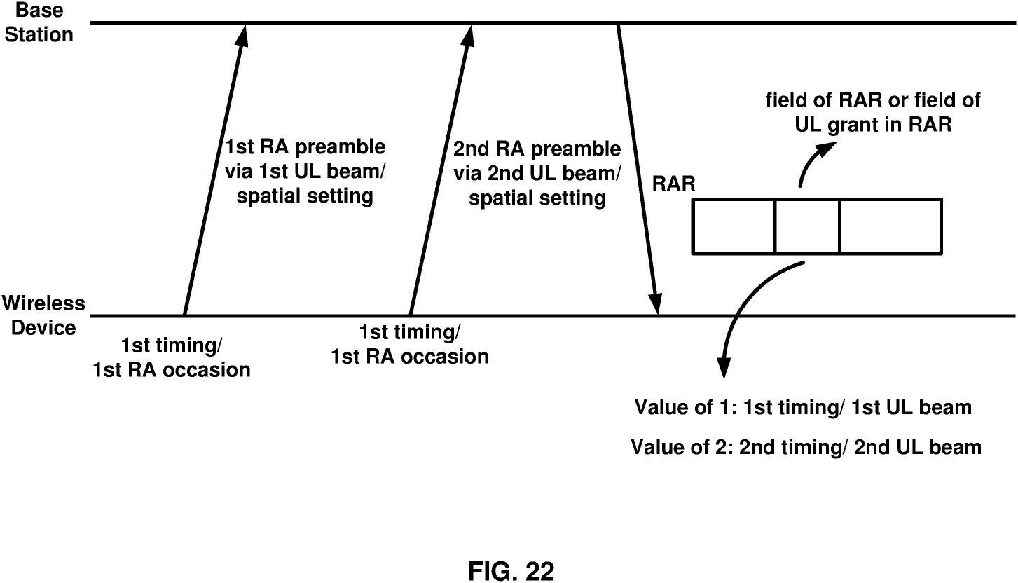

In an example, the value of the field of the RAR, or a value of a field of the uplink grant included in the RAR, may indicate one of a first timing of the first random access preamble/resource/occasion and a second timing of the second random access preamble/resource/occasion and may indicate the uplink beam (e.g., spatial filter/setting) for the subsequent uplink transmission based on the uplink beam (e.g., spatial filter/setting) used for transmission of the random access preamble at the indicated timing. For example, the transmission of the first random access preamble may be in a first timing. The first random access resource/occasion for transmission of the first random access preamble may be in the first timing. The transmission of the second random access preamble may be in a second timing. The second random access resource/occasion for transmission of the second random access preamble may be in the second timing. The value of the field of the RAR, or a value of a field of the uplink grant included in the RAR, may indicate one of a first timing and the second timing. The uplink beam (e.g., the spatial filter/setting) that was used for transmission of a random access preamble in the indicated timing may be indicated to be used for the subsequent uplink transmission. In an example, the value of the field of the RAR, or the value of the field of the uplink grant included in RAR, may indicate an identifier/index of a timing in a time-ordered sequence of the first timing and the second timing. In an example as shown in FIG. 22, a value of 1 of the field may indicate the first timing of the first random access preamble/ random access occasion and the first uplink beam (spatial filter/setting) and a value of 2 of the field may indicate the second timing of the second random access preamble/ random access occasion and the second uplink beam (spatial filter/setting).

The wireless device may transmit the subsequent uplink transmission (e.g., Msg3 in a 4-step random access process or a Msg B in a 2-step random access process) based on/via the first uplink beam (spatial filter/setting) indicated by the RAR (e.g., indicated by the content of the RAR and/or the parameter associated with the RAR).

In an example, the wireless device may determine/compute/calculate a first RNTI (e.g., a first RA-RNTI) that is associated with transmission of the first random access preamble via the first uplink beam (e.g., spatial filter/setting). The wireless device may determine/compute/calculate the first RNTI based on time/frequency resources, uplink carrier, and other parameters associated with the transmission of the first random access preamble. In an example, the wireless device may determine/compute/calculate the first RNTI further based on the first uplink beam (e.g., spatial filter/setting), e.g., based on a first identifier/index associated with the first uplink beam. The wireless device may determine/compute/calculate a second RNTI (e.g., a second RA-RNTI) that is associated with transmission of the second random access preamble via the second uplink beam (e.g., spatial filter/setting). The wireless device may determine/compute/calculate the second RNTI based on time/frequency resources, uplink carrier, other parameters associated with the transmission of the second random access preamble. In an example, the wireless device may determine/compute/calculate the second RNTI further based on the second uplink beam (e.g., spatial filter/setting), e.g., based on a second identifier/index associated with the second uplink beam.

The wireless device may monitor a control channel during a random access response window. The monitoring the control channel during the random access response window may be at least for the first RNTI (e.g., the first RA-RNTI) and the second RNTI (e.g., the second RA-RNTI). The wireless device may receive a RAR in response to monitoring the control channel. An RNTI associated with the received RAR may be one of the first RNTI (e.g., the first RA-RNTI) and the second RNTI (e.g., the second RA-RNTI). The RNTI associated with the RAR may indicate one of the first uplink beam (e.g., spatial filter/setting) and the second uplink beam (e.g., spatial filter/setting) for the subsequent uplink transmission. The wireless device may determine, based on the RNTI associated with the RAR, one of the first uplink beam (e.g., spatial filter/setting) and the second uplink beam (e.g., spatial filter/setting) for the subsequent uplink transmission. For example, in response to the RNTI associated with the RAR being the first RNTI (e.g., the first RA-RNTI), the uplink beam (e.g., spatial filter/setting) indicated for the subsequent uplink transmission may be the first uplink beam (spatial filter/setting). The wireless device may transmit the subsequent uplink transmission based on the first uplink beam (spatial filter/setting). For example, in response to the RNTI associated with the RAR being the second RNTI (e.g., the second RA-RNTI), the uplink beam (e.g., spatial filter/setting) indicated for the subsequent uplink transmission may be the second uplink beam (spatial filter/setting). The wireless device may transmit the subsequent uplink transmission based on the second uplink beam (spatial filter/setting).

In an example, in response to monitoring the control channel, the wireless device may receive a DCI (e.g., a DCI format 1_0) via a PDCCH comprising scheduling information for the RAR. In an example, the wireless device may determine one of the first uplink beam (spatial filter/setting) and the second uplink beam (spatial filter/setting) for the subsequent uplink transmission based on the DCI (e.g., based on a value of a field of the DCI) and/or based on one or more parameters (e.g., one or more reference signals, e.g., one or more demodulation reference signals (DMRSs)) associated with the PDCCH. In an example, receiving the DCI comprising the scheduling information for the RAR may comprise may based on a CORESET and/or a search space. The CORESET and/or the search space used for reception of the DCI may indicate one of the first uplink beam (e.g., spatial filter/setting) and the second uplink beam (e.g., spatial filter/setting) for the subsequent uplink transmission.

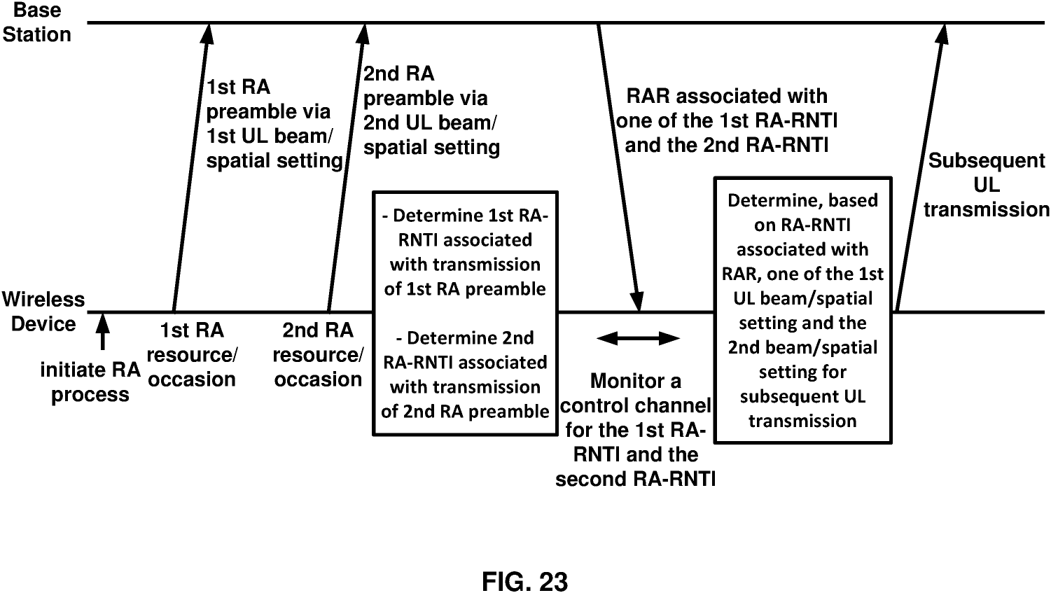

In an example embodiment as shown in FIG. 23, a wireless device may initiate a random access process, e.g., autonomously based on a determination at the wireless device or in response to a PDCCH order, from a base station, indicating a command/order to initiate the random access process. In an example, the random access process may be of the first type. In response to initiating the random access process, the wireless device may transmit a plurality of random access preambles comprising a first random access preamble and a second random access preamble. In response to initiating the random access process, the wireless device may transmit the first random access process preamble based on/ via a first uplink beam (spatial filter/setting) and may transmit the second random access preamble based on/ via a second uplink beam (spatial filter/setting).

The wireless device may determine/compute/calculate a first RNTI (e.g., a first RA-RNTI) that is associated with transmission of the first random access preamble via the first uplink beam (e.g., spatial filter/setting) and via the first random access resource in the first random access occasion. The wireless device may determine/compute/calculate the first RNTI based on time/frequency resources, uplink carrier, and other parameters associated with the transmission of the first random access preamble. The wireless device may determine/compute/calculate the first RNTI further based on the first uplink beam (e.g., spatial filter/setting), e.g., based on a first identifier/index associated with the first uplink beam. In an example, the first random access preamble/resource/occasion may be associated with a first identifier/index (e.g., based on the relative timing of the first random access occasion and the second random access occasion) and determining/calculating/computing the first RNTI may be based on the first identifier/index of the first random access preamble/resource/occasion. The wireless device may determine/compute/calculate a second RNTI (e.g., a second RA-RNTI) that is associated with transmission of the second random access preamble via the second uplink beam (e.g., spatial filter/setting) and via the second random access resource in the second random access occasion. The wireless device may determine/compute/calculate the second RNTI based on time/frequency resources, uplink carrier, other parameters associated with the transmission of the second random access preamble. In an example, the wireless device may determine/compute/calculate the second RNTI further based on the second uplink beam (e.g., spatial filter/setting), e.g., based on a second identifier/index associated with the second uplink beam. In an example, the second random access preamble/resource/occasion may be associated with a second identifier/index (e.g., based on the relative timing of the first random access occasion and the second random access occasion) and determining/calculating/computing the second RNTI may be based on the second identifier/index of the second random access preamble/resource/occasion.

The wireless device may monitor a control channel during a time window (e.g., a random access response window). The monitoring the control channel during the random access response window may be at least for the first RNTI (e.g., the first RA-RNTI) and the second RNTI (e.g., the second RA-RNTI). The wireless device may receive a RAR in response to monitoring the control channel. An RNTI associated with the received RAR may be one of the first RNTI (e.g., the first RA-RNTI) and the second RNTI (e.g., the second RA-RNTI). The RNTI associated with the RAR may indicate one of the first uplink beam (e.g., spatial filter/setting) and the second uplink beam (e.g., spatial filter/setting) for a subsequent uplink transmission (e.g., for transmission of Msg3 in a 4-step random access process or for transmission of a Msg B in a 2-step random access process or for an uplink transmission after completion of the random access process). The wireless device may determine, based on the RNTI associated with the RAR, one of the first uplink beam (e.g., spatial filter/setting) and the second uplink beam (e.g., spatial filter/setting) for the subsequent uplink transmission. The wireless device may transmit the subsequent uplink transmission based on/ via the determined uplink beam (e.g., spatial filter/setting). For example, in response to the RNTI associated with the RAR being the first RNTI (e.g., the first RA-RNTI), the uplink beam (e.g., spatial filter/setting) indicated for the subsequent uplink transmission may be the first uplink beam (e.g., spatial filter/setting). The wireless device may transmit the subsequent uplink transmission based on the first uplink beam (spatial filter/setting). For example, in response to the RNTI associated with the RAR being the second RNTI (e.g., the second RA-RNTI), the uplink beam (e.g., spatial filter/setting) indicated for the subsequent uplink transmission may be the second uplink beam (e.g., spatial filter/setting). The wireless device may transmit the subsequent uplink transmission based on the second uplink beam (e.g., spatial filter/setting).

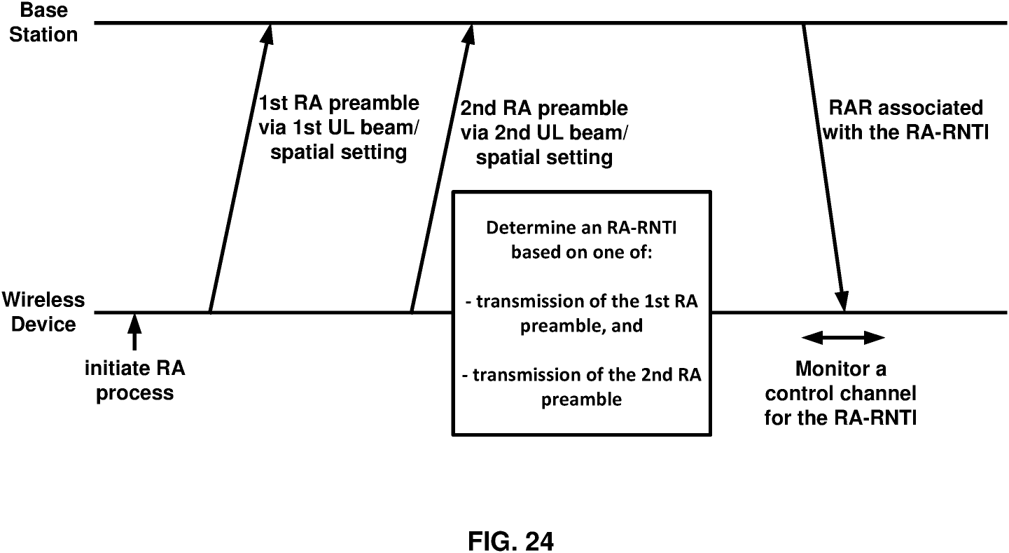

In an example embodiment as shown in FIG. 24, a wireless device may initiate a random access process, e.g., autonomously based on a determination at the wireless device or in response to a PDCCH order, from a base station, indicating a command/order to initiate the random access process. In an example, the random access process may be of the first type. In response to initiating the random access process, the wireless device may transmit a plurality of random access preambles comprising a first random access preamble and a second random access preamble. In response to initiating the random access process, the wireless device may transmit the first random access process preamble based on/ via a first uplink beam (spatial filter/setting) and may transmit the second random access preamble based on/ via a second uplink beam (spatial filter/setting).

The wireless device may determine/compute/calculate an RNTI (e.g., an RA-RNTI) based on one of the transmission of the first random access preamble and the transmission of the second random access preamble. For example, the wireless device may determine/select one of the transmission of the first random access preamble and the transmission of the second random access preamble for determining/calculating/computing the RNTI (e.g., the RA-RNTI).

In an example, a first timing of the first random access preamble/resource/occasion may be earlier than a second timing of the second random access preamble/resource/occasion and the wireless device may determine/calculate/compute the RNTI (e.g., the RA-RNTI) based on the transmission of the first random access preamble in response to the first timing being earlier than the second timing.

In an example, a first timing of the first random access preamble/resource/occasion may be earlier than a second timing of the second random access preamble/resource/occasion and the wireless device may determine/calculate/compute the RNTI (e.g., the RA-RNTI) based on the transmission of the second random access preamble in response to the second timing being later than the first timing.

The wireless device may receive a random access response (RAR). The wireless device may receive the random access response based on (e.g., in response to) monitoring a control channel (e.g., PDCCH) for the determined/calculated/computed RNTI (e.g., the determined/calculated/computed RA-RNTI). The wireless device may monitor the control channel during a random access response window. The wireless device may receive a configuration parameter indicating a duration of the of random access response window. In an example, the wireless device may determine a starting time of a random access response window and may determine the time window to monitor for the control channel associated with the RAR based on the starting time of the random access response window and based on the duration (e.g., the configured duration) of the random access response window.

In an example, the wireless device may monitor the control channel in response to (e.g., after, e.g., on or after a first/earliest control channel occasion after the timing of) the transmission of the second random access preamble (e.g., the second random access occasion associated with the second random access preamble). In an example, the wireless device may monitor the control channel in response to (e.g., after, e.g., on or after a first/earliest control channel occasion after the timing of) the transmission of the latest random access preamble in the plurality of the random access preambles. In an example, the wireless device may monitor the control channel only after (e.g., on or after a first/earliest control channel occasion after) transmission of the plurality of the random access preambles. In an example, the wireless device may receive the RAR in response to (e.g., after, e.g., on or after a first/earliest control channel occasion after the timing of) the transmission of the second random access preamble (e.g., the second random access occasion associated with the second random access preamble). In an example, the wireless device may receive the RAR in response to (e.g., after, e.g., on or after a first/earliest control channel occasion after the timing of) the transmission of the latest random access preamble in the plurality of the random access preambles. In an example, the wireless device may receive the RAR only after (e.g., on or after a first/earliest control channel occasion after) transmission of the plurality of the random access preambles.

In an example, the wireless device may monitor the control channel in response to (e.g., after, e.g., on or after a first/earliest control channel occasion after the timing of) the transmission of the first random access preamble (e.g., the first random access occasion associated with the first random access preamble). In an example, the wireless device may monitor the control channel in response to (e.g., after, e.g., on or after a first/earliest control channel occasion after the timing of) the transmission of the earliest random access preamble in the plurality of the random access preambles. In an example, the wireless device may receive the RAR in response to (e.g., after, e.g., on or after a first/earliest control channel occasion after the timing of) the transmission of the first random access preamble (e.g., the first random access occasion associated with the first random access preamble). In an example, the wireless device may receive the RAR in response to (e.g., after, e.g., on or after a first/earliest control channel occasion after the timing of) the transmission of the earliest random access preamble in the plurality of the random access preambles.

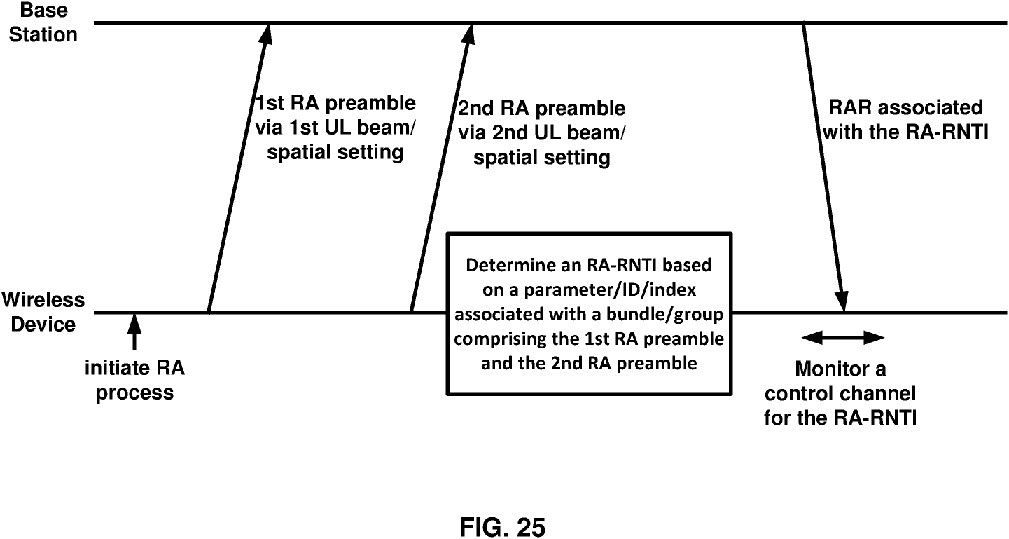

In an example embodiment as shown in FIG. 25, a wireless device may initiate a random access process, e.g., autonomously based on a determination at the wireless device or in response to a PDCCH order, from a base station, indicating a command/order to initiate the random access process. In an example, the random access process may be of the first type. In response to initiating the random access process, the wireless device may transmit a plurality of random access preambles comprising a first random access preamble and a second random access preamble. In response to initiating the random access process, the wireless device may transmit the first random access process preamble based on/ via a first uplink beam (spatial filter/setting) and may transmit the second random access preamble based on/ via a second uplink beam (spatial filter/setting).

The wireless device may determine/compute/calculate an RNTI (e.g., an RA-RNTI) based on a parameter/identifier/index associated with a bundle/group comprising the first random access preamble and the second random access preamble.

The wireless device may receive a random access response (RAR). The wireless device may receive the random access response based on (e.g., in response to) monitoring a control channel (e.g., PDCCH) for the determined/calculated/computed RNTI (e.g., the determined/calculated/computed RA-RNTI). The wireless device may monitor the control channel during a random access response window. The wireless device may receive a configuration parameter indicating a duration of the of random access response window. In an example, the wireless device may determine a starting time of a random access response window and may determine the time window to monitor for the control channel associated with the RAR based on the starting time of the random access response window and based on the duration (e.g., the configured duration) of the random access response window.

In an example, the wireless device may monitor the control channel in response to (e.g., after, e.g., on or after a first/earliest control channel occasion after the timing of) the transmission of the second random access preamble (e.g., the second random access occasion associated with the second random access preamble). In an example, the wireless device may monitor the control channel in response to (e.g., after, e.g., on or after a first/earliest control channel occasion after the timing of) the transmission of the latest random access preamble in the plurality of the random access preambles. In an example, the wireless device may monitor the control channel only after (e.g., on or after a first/earliest control channel occasion after) transmission of the plurality of the random access preambles. In an example, the wireless device may receive the RAR in response to (e.g., after, e.g., on or after a first/earliest control channel occasion after the timing of) the transmission of the second random access preamble (e.g., the second random access occasion associated with the second random access preamble). In an example, the wireless device may receive the RAR in response to (e.g., after, e.g., on or after a first/earliest control channel occasion after the timing of) the transmission of the latest random access preamble in the plurality of the random access preambles. In an example, the wireless device may receive the RAR only after (e.g., on or after a first/earliest control channel occasion after) transmission of the plurality of the random access preambles.

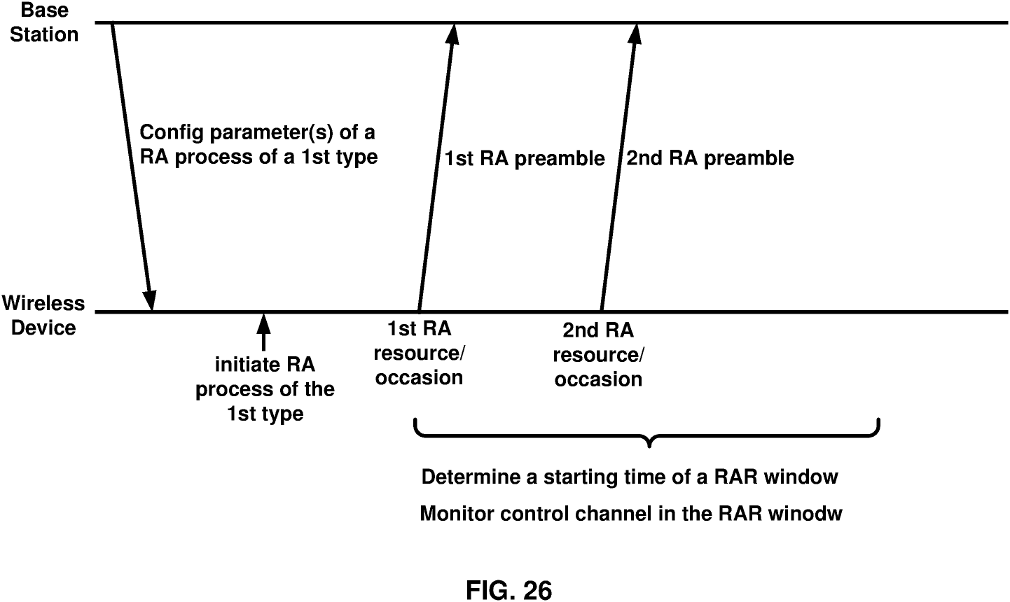

In an example embodiment as shown in FIG. 26, a wireless device may receive one or more configuration parameters (e.g., based on receiving one or more RRC messages comprising at least a portion of the one or more configuration parameters and/or based on receiving a broadcast message e.g., a SIB message comprising at least a portion of the one or more configuration parameters) of a random access process of the first type. The wireless device may initiate a random access process, e.g., autonomously based on a determination at the wireless device or in response to a PDCCH order, from a base station, indicating a command/order to initiate the random access process. In response to initiating the random access process, the wireless device may transmit a plurality of random access preambles comprising a first random access preamble and a second random access preamble. In response to initiating the random access process, the wireless device may transmit the first random access process preamble in a first random access occasion and via a first random access resource and may transmit the second random access preamble in a second random access occasion and via a second random access resource. In an example, transmitting the first random access preamble may be based on/ via a first uplink beam (e.g., spatial filter/setting) and transmitting the second random access may be based on/ via a second uplink beam (e.g., spatial filter/setting).

The wireless device may determine a starting time of a random access response window. In an example, the starting time of the random access response window may be a first/earliest control channel occasion after (e.g., after the end of) the earlier of a first timing of the first random access preamble (e.g., the first random access occasion) and a second timing of the second random access preamble (e.g., the second random access occasion). In an example, the starting time of the random access response window may be a first/earliest control channel occasion after (e.g., after the end of) the later of a first timing of the first random access preamble (e.g., the first random access occasion) and a second timing of the second random access preamble (e.g., the second random access occasion).

In an example, a starting of the random access response window may be based on the uplink beam(s) (e.g., spatial filter(s)/setting(s)) used for transmission of the first random access preamble and the second random access preamble, for example may be based on the first uplink beam (e.g., spatial filter/setting) used for transmission of the first random access preamble and the second uplink beam (e.g., spatial filter/setting) used for transmission of the second random access preamble. For example, the starting time of the random access response window may be determined to be a first/earliest control channel occasion after the first random access occasion (on which the first random access preamble may be transmitted based on/ via the first uplink beam (e.g., a spatial filter/setting)) based on one or more parameters/criteria (e.g., identifier/index) associated with the first uplink beam (e.g., spatial filter/setting) used for transmission of the first random access preamble.

In an example, the wireless device may receive a configuration parameter (e.g., an RRC configuration parameter) indicating a duration of the random access response window. The wireless device may determine the random access response window based on the starting time of the random access response window and based on the duration of the random access response window. The wireless device may monitor the control channel during the random access response window that is determined based on the starting time of the random access response window and based on the duration of the random access response window.

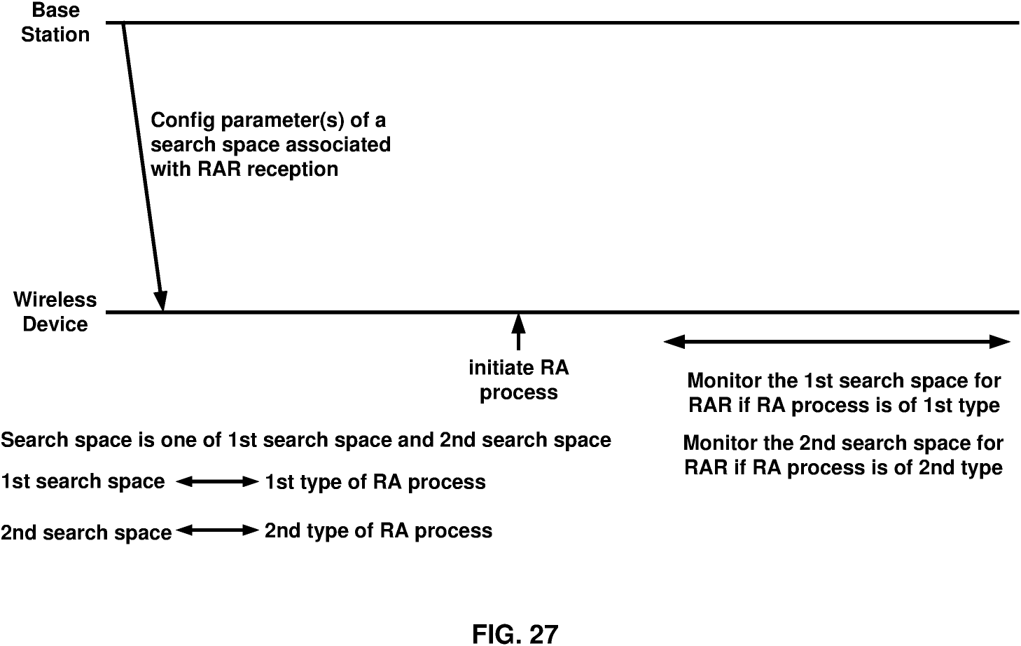

In an example embodiment as shown in FIG. 27, a wireless device may receive one or more configuration parameters of a search space (e.g., random access response search space). The search space may be associated with random access response (RAR) reception (e.g., for reception of DCI comprising scheduling information for reception of the RAR). The search space may be one of a first search space and a second search space. The first search space may be for random access processes of the first type. The second search space may be for random access processes of the second type. In an example, the first search space and/or the second search space may be common search space (CSS).

The wireless device may initiate a random access process, e.g., autonomously based on a determination at the wireless device or in response to a PDCCH order, from a base station, indicating a command/order to initiate the random access process. In response to initiating the random access process, the wireless device may transmit one or more random access preambles (e.g., based on the random access process being of the first type or of the second type). The wireless device may monitor for a RAR in response to transmitting the one or more random access preambles. The wireless device may monitor the first search space in response to the random access process being of the first type. The wireless device may monitor the second search space in response to the random access process being of the second type.

In an example, the wireless device may transmit a capability message comprising one or more capability information elements (IEs) indicating whether the wireless device supports random access processes of the first type. In response to the one or more capability IEs indicating that the wireless device supports the random access processes of the first type, the wireless device may receive configuration parameters for random access processes of the first type. The search space may be the first search space. The wireless device may monitor the first search space for a RAR in response to transmitting a plurality of random access preambles.

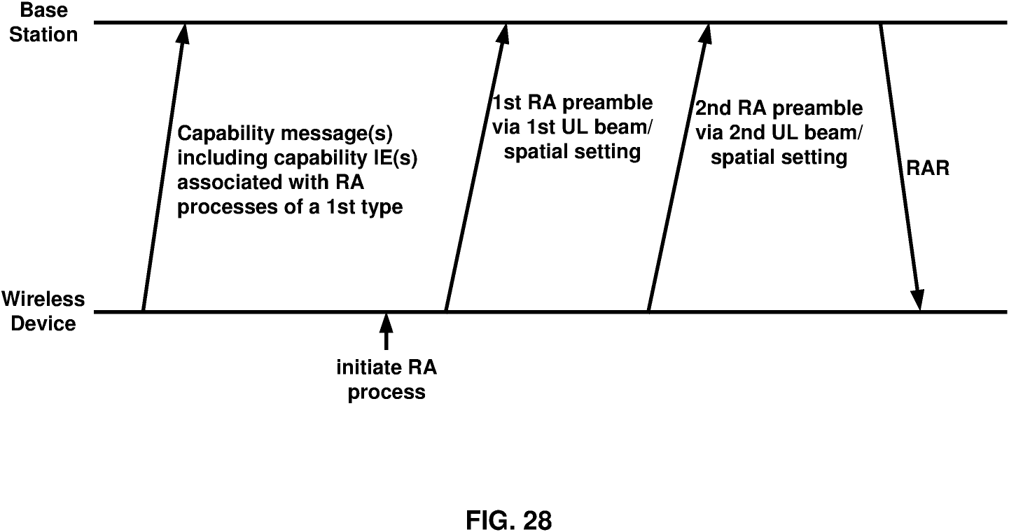

In an example embodiment as shown in FIG. 28, a wireless device may transmit, to a base station, one or more capability messages comprising one or more capability IEs associated with random access processes of the first type. In response to transmitting the one or more capability messages and based on the values of the one or more capability IEs, the wireless device may initiate a random access process (e.g., a random access process of the first type).

In an example, the values of the one or more capability IEs may indicate that the wireless device supports/ is capable of random access processes of the first type. In an example, in response to transmitting the one or more capability messages and the one or more capability IEs indicating that the wireless device supports/is capable of random access processes of the first type, the wireless device may receive random access configuration parameters associated with random access processes of the first type.

In an example, the values of the one or more capability IEs may indicate that the wireless device supports/ is capable of being configured with a search space used in reception of RAR (e.g., used in reception of DCI comprising scheduling information for reception of RAR) in a random access process of the first type. In an example, the one or more capability IEs may indicate that the wireless device supports/ is capable of being configured with multiple random access response search spaces.

In an example, in response to transmitting the one or more capability messages and the one or more capability IEs indicating that the wireless device supports/is capable of being configured with a search space used in reception of RAR in a random access process of the first type, the wireless device may receive one or more configuration parameters of the search space used in reception of RAR in a random access process of the first type.

In an example, in response to transmitting the one or more capability messages and the one or more capability IEs indicating that the wireless device supports/is capable of being configured with multiple random access response search spaces, the wireless device may receive configuration parameters of a first search space and a second search space. The first search space may be for reception of RAR (e.g., for reception of DCI comprising scheduling information for reception of RAR) associated with the first type of random access processes. The second search space may be for reception of RAR (e.g., for reception of DCI comprising scheduling information for reception of RAR) associated with the second type of random access processes (e.g., random access processes that are not of the first type).

The wireless device may transmit a first random access preamble via a first uplink beam (e.g., spatial filter/setting) and may transmit a second random access preamble via a second uplink beam (e.g., spatial filter/setting) in response to initiating the random access process. The wireless device may receive a RAR. The wireless device may receive the RAR in response to transmitting the first random access preamble and the second random access preamble.

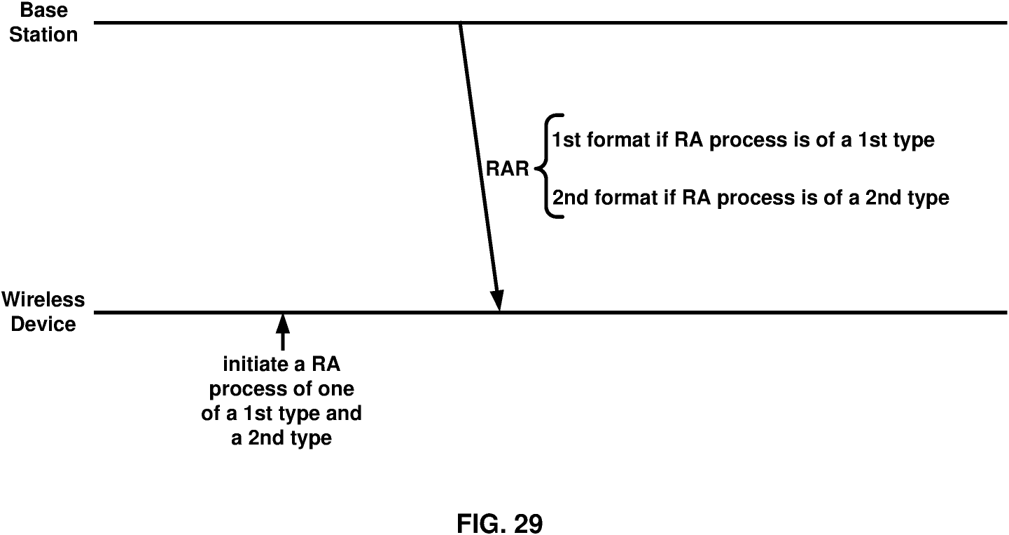

In an example embodiment as shown in FIG. 29, a wireless device may initiate a random access process, e.g., autonomously based on a determination at the wireless device or in response to a PDCCH order, from a base station, indicating a command/order to initiate the random access process. The wireless device may transmit one or more random access preambles in response to initiating the random access process. The wireless device may receive a random access response (RAR). The RAR may have one of a first format and a second format. The RAR may have the first format in response to the random access process being of the first type. The RAR may have a second format in response to the random access process being of the second type. In an example, a first number of fields in a RAR of the first format may be different from a second number of fields in a RAR of the second format. In an example, a first number of bits in a RAR of the first format may be different from a second number of bits in a RAR of the second format.

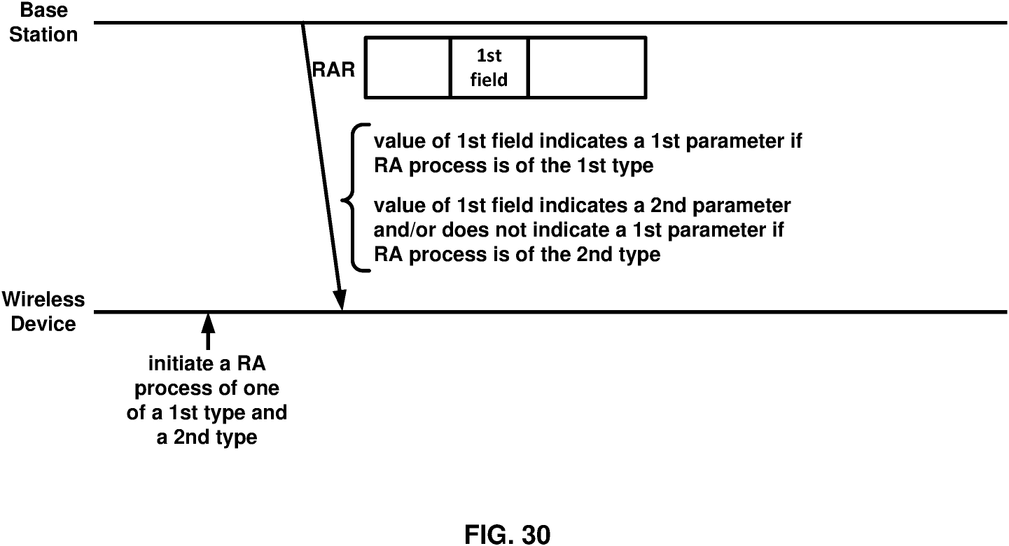

In an example as shown in FIG. 30, a wireless device may initiate a random access process, e.g., autonomously based on a determination at the wireless device or in response to a PDCCH order, from a base station, indicating a command/order to initiate the random access process. The random access process may be one of a first type or a second type. The wireless device may transmit one or more random access preambles (e.g., based on the random access process being of the first type or the second type) in response to initiating the random access process. The wireless device may receive a random access response (RAR). In response to the random access process being of the first type, a value of a first field of the RAR may indicate a first parameter (e.g., an indication of an uplink beam (e.g., spatial filter/setting)). For example, in response to the random access process being of the first type, a value of one or more bits of the first field (e.g., one or more most significant bits (MSB) of the first field, e.g., one or more least significant bits (LSB) of the first bit, etc.) may indicate the first parameter. In response to the random access process being of the second type (e.g., not being of the first type), a value of the first field of the RAR may indicate a second parameter and/or may not indicate the first parameter. In an example, in response to the random access process being of the first type, a value of field of an uplink grant (e.g., one or more most significant bits (MSB) of the field of the uplink grant, e.g., one or more least significant bits (LSB) of the uplink grant, etc.) included in the RAR, may indicate the first parameter (e.g., an indication of an uplink beam (e.g., spatial filter/setting)). In response to the random access process being of the second type (e.g., not being of the first type), a value of the field of the uplink grant, included in the RAR, may indicate a second parameter and/or may not indicate the first parameter.

In an example, the field of the uplink grant may be a frequency hopping flag field. The second parameter may be a frequency hopping flag. In response to the random access process being of the second type (e.g., not being of the first type), a value of the frequency hopping flag field of the uplink grant may indicate a frequency hopping flag and/or may not indicate the first parameter.

In an example, the field of the uplink grant may be a frequency resource allocation field. The second parameter may be a frequency resource allocation. In response to the random access process being of the second type (e.g., not being of the first type), a value of the frequency resource allocation field of the uplink grant may indicate a frequency allocation and/or may not indicate the first parameter.

In an example, the field of the uplink grant may be a time resource allocation field. The second parameter may be a time resource allocation. In response to the random access process being of the second type (e.g., not being of the first type), a value of the time resource allocation field of the uplink grant may indicate a time resource allocation and/or may not indicate the first parameter.

In an example, the field of the uplink grant may be a modulation and coding scheme (MCS) field. The second parameter may be an MCS. In response to the random access process being of the second type (e.g., not being of the first type), a value of the MCS field of the uplink grant may indicate a MCS and/or may not indicate the first parameter.

In an example, the field of the uplink grant may be a transmit power control (TPC) field. The second parameter may be a TPC. In response to the random access process being of the second type (e.g., not being of the first type), a value of the TPC field of the uplink grant may indicate a TPC and/or may not indicate the first parameter.

In an example, the field of the uplink grant may be a channel state information (CSI) request field. The second parameter may be a CSI request. In response to the random access process being of the second type (e.g., not being of the first type), a value of the CSI request field of the uplink grant may indicate a CSI request and/or may not indicate the first parameter.

In an example embodiment, a wireless device may receive one or more configuration parameters indicating that a first random access preamble/resource/occasion and a second random access preamble/resource/occasion are used together/jointly and/or are linked and/or are bundled in a random access process. In response to initiating a random access process: the wireless device may transmit the first random access preamble in the first random access occasion and/or via the first random access resource; and the wireless device may transmit the second random access preamble in the second random access occasion and/or via the second random access resource. The wireless device may receive a random access response.

In an example, the one or more configuration parameters may indicate a bundle/group of a plurality of random access preambles/resources/occasions comprising the first random access preamble/resource/occasion and the second random access preamble/resource/occasion.

In an example, the receiving the random access response may be in response to (e.g., after e.g., in a first/earliest downlink control channel occasion after) transmitting the first random access preamble and the second random access preamble. The receiving the random access response may not be before transmitting the first random access preamble and the second random access preamble. The receiving the random access response may be only after transmitting the first random access preamble and the second random access preamble.

In an example, the first random access occasion may be earlier than the second random access occasion. The receiving the random access response may be in response to (e.g., after e.g., in a first/earliest downlink control channel occasion after) transmitting the first random access preamble.

In an example the receiving the random access response may be based on (e.g., in response to) monitoring a control channel for one or more radio network temporary identifiers (RNTIs) (e.g., one or more random access RNTIs (RA-RNTIs)) during a random access response window.

In an example, the monitoring the control channel may be in response to (e.g., after e.g., in a first/earliest downlink control channel occasion after) transmitting the first random access preamble and the second random access preamble. The monitoring the control channel may not be before transmitting the first random access preamble and the second random access preamble. The monitoring the control channel may be only after transmitting the first random access preamble and the second random access preamble.

In an example, the first random access occasion may be earlier than the second random access occasion. The monitoring the control channel may be in response to (e.g., after e.g., in a first/earliest downlink control channel occasion after) transmitting the first random access preamble.

In an example, the second random access preamble may be a repetition of the first random access preamble. The second random access preamble may be the same as the first random access preamble.

In an example, the first random access preamble/resource/occasion and the second random access preamble/resource/occasion may be associated with (e.g., are for transmission via/based on) the same uplink beam (spatial filter/setting). In an example, the transmitting the first random access preamble and the transmitting the second random access preamble may be via/based on the same uplink beam (spatial filter/setting). In an example, the one or more configuration parameters may indicate that the first random access preamble/resource/occasion and the second random access preamble/resource/occasion are associated with (e.g., are for transmission via/based on) the same uplink beam (spatial filter/setting). In an example, the one or more configuration parameters may comprise one or more first parameters indicating that the first random access preamble/resource/occasion and the second random access preamble/resource/occasion are associated with (e.g., are for transmission via/based on) the same uplink beam (spatial filter/setting). In an example, the one or more configuration parameters may indicate an identifier of an uplink beam (spatial filter/setting) for transmission of the first random access preamble and transmission of the second random access preamble. In an example, the one or more configuration parameters may indicate an identifier of an uplink beam (spatial filter/setting), wherein the first random access preamble/resource/occasion and the second random access preamble/resource/occasion are associated with the uplink beam (spatial filter/setting). In an example, the wireless device may determine the uplink beam (spatial filter/setting), for transmission of the first random access preamble and transmission of the second random access preamble, based on the identifier. In an example, the uplink beam (spatial filter/setting) used for transmission of the first random access preamble and the second random access preamble may be determined based on the wireless device implementation. In an example, the wireless device may receive a downlink control information (via PDCCH) indicating an order/command for initiating the random access process, wherein the downlink control information may indicate the identifier of the uplink beam (spatial filter/setting) to be used for transmission of the first random access preamble and the second random access preamble.

In an example, the first random access preamble/resource/occasion may be for transmission via a first uplink beam (spatial filter/setting); and the second random access preamble/resource/occasion may be for transmission via a second uplink beam (spatial filter/setting). In an example, the one or more configuration parameters may indicate that: the first random access preamble/resource/occasion is for transmission via a first uplink beam (spatial filter/setting); and the second random access preamble/resource/occasion is for transmission via a second uplink beam (spatial filter/setting). In an example, the transmitting the first random access preamble may be via the first uplink beam (spatial filter/setting); and the transmitting the second random access preamble may be via the second uplink beam (spatial filter/setting). In an example, a bundle/group, comprising the first random access preamble/resource/occasion and the second random access preamble/resource/occasion, may be associated with a plurality of uplink beams (spatial filters/settings) comprising the first uplink beam (spatial filter/setting) and the second uplink beam (spatial filter/setting). In an example, the first uplink beam (spatial filter/setting) may be associated with a first identifier; and the second uplink beam (spatial filter/setting) may be associated with a second identifier. In an example, the wireless device may receive a downlink control information (via PDCCH) indicating an order/command for initiating the random access process. The downlink control information may indicate the first identifier of the first uplink beam (spatial filter/setting) to be used for transmission of the first random access preamble and the second identifier of the second uplink beam (spatial filter/setting) to be used for transmission of the second random access preamble.

In an example, the one or more configuration parameters may indicate the first identifier of the first uplink beam (spatial filter/setting) and the second identifier of the second uplink beam (spatial filter/setting). In an example, the one or more configuration parameters may comprise: one or more first parameters indicating the first identifier of the first uplink beam (spatial filter/setting); and one or more second parameters indicating the second identifier of the second uplink beam (spatial filter/setting). In an example, the first identifier and the second identifier may be based on relative timing of the first random access occasion and the second random access occasion. In an example, the first identifier may have a lower value than the second identifier in response to the first random access occasion being earlier than the second random access occasion. In an example, the wireless device may determine the first uplink beam (spatial filter/setting), for transmission of the first random access preamble, based on the first identifier; and the wireless device may determine the second uplink beam (spatial filter/setting), for transmission of the second random access preamble, based on the second identifier. In an example, the wireless device may determine, based on the wireless device implementation: the first uplink beam (spatial filter/setting) associated with the first random access preamble/resource/occasion (e.g., for transmission of the first random access preamble); and the second uplink beam (spatial filter/setting) associated with the second random access preamble/resource/occasion (e.g., for transmission of the second random access preamble).

In an example, the first random access preamble/resource/occasion may be associated with a first identifier; and the second random access preamble/resource/occasion may be associated with a second identifier. In an example, the first identifier may have a lower value than the second identifier in response to the first random access occasion being earlier than the second random access occasion. In an example, determining the first uplink beam (spatial filter/setting) may be based on the first identifier of the first random access occasion and/or determining the second the second uplink beam (spatial filter/setting) may be based on the second identifier of the second random access occasion.

In an example, the receiving the one or more configuration parameters may be based on/via one or more radio resource control (RRC) messages. The wireless device may receive one or more RRC messages comprising the one or more configuration parameters.

In an example, the receiving the one or more configuration parameters may be based on/via a broadcast message (e.g., a system information block (SIB) message). The wireless device may receive one or more broadcast (e.g., SIB) messages comprising the one or more configuration parameters.

In an example embodiment, a wireless device may receive one or more first configuration parameters indicating one or more sets of random access preambles/resources/occasions associated with random access processes of a first type. A random access process of a first type may comprise multiple random access preamble transmissions in response to initiating the random access process. The random access process of the first type may comprise multiple random access preamble transmissions in a random access preamble transmission attempt. The random access process of the first type may comprise multiple random access preamble transmissions for each preamble transmission counter value. The one or more sets may comprise a first set of one or more random access preambles/resources/occasions. In response to initiating a random access process: the wireless device may transmit a first random access preamble, from the first set of the one or more random access preambles, in a corresponding random access occasion and/or via a corresponding first random access resource; the wireless device may determine a second random access preamble/resource/occasion based on the first random access preamble/resource/occasion; and the wireless device may transmit a second random access preamble in the second random access occasion and/or via the second random access resource. The wireless device may receive a random access response.

In an example, the receiving the random access response may be in response to (e.g., after e.g., in a first/earliest downlink control channel occasion after) transmitting the first random access preamble and the second random access preamble. The receiving the random access response may not be before transmitting the first random access preamble and the second random access preamble. The receiving the random access response may be only after transmitting the first random access preamble and the second random access preamble.

In an example, the first random access occasion may be earlier than the second random access occasion. The receiving the random access response may be in response to (e.g., after e.g., in a first/earliest downlink control channel occasion after) transmitting the first random access preamble.

In an example the receiving the random access response may be based on (e.g., in response to) monitoring a control channel for one or more radio network temporary identifiers (RNTIs) (e.g., one or more random access RNTIs (RA-RNTIs)) during a random access response window.

In an example, the monitoring the control channel may be in response to (e.g., after e.g., in a first/earliest downlink control channel occasion after) transmitting the first random access preamble and the second random access preamble. The monitoring the control channel may not be before transmitting the first random access preamble and the second random access preamble. The monitoring the control channel may be only after transmitting the first random access preamble and the second random access preamble.

In an example, the first random access occasion may be earlier than the second random access occasion. The monitoring the control channel may be in response to (e.g., after e.g., in a first/earliest downlink control channel occasion after) transmitting the first random access preamble.

In an example, the second random access preamble may be a repetition of the first random access preamble. The second random access preamble may be the same as the first random access preamble.

In an example, the determining the second random access preamble/resource/occasion may be from the first set of the one or more random access preambles/resources/occasions.

In an example, the transmitting the first random access preamble may be via/based on an uplink beam (spatial filter/setting). The first random access preamble/resource/occasion may be associated with the uplink beam (spatial filter/setting). The transmitting the second random access preamble may be via/based on the uplink beam (spatial filter/setting). The second random access preamble/resource/occasion may be associated with the uplink beam (spatial filter/setting). In an example, the one or more configuration parameters may indicate that the first random access preamble/resource/occasion and the second random access preamble/resource/occasion are associated with the uplink beam (spatial filter/setting) (e.g., the same uplink beam (spatial filter/setting)). In an example, each set of random access preambles/resources/occasions, in the plurality of sets of random access preambles/resources/occasions, may be associated with a corresponding uplink beam (spatial filter/setting).

In an example, the transmitting the first random access preamble may be via/based on a first uplink beam (spatial filter/setting). The first random access preamble/resource/occasion may be associated with the first uplink beam (spatial filter/setting). The transmitting the second random access preamble may be via/based on a second uplink beam (spatial filter/setting). The second random access preamble/resource/occasion may be associated with the second uplink beam (spatial filter/setting). In an example, the wireless device may determine: the first uplink beam (spatial filter/setting) based on wireless device implementation; and the second uplink beam (spatial filter/setting) based on the first uplink beam (spatial filter/setting). In an example, the wireless device may determine, based on wireless device implementation, the first uplink beam (spatial filter/setting) and the second uplink beam (spatial filter/setting).

In an example, the wireless device may receive a downlink control information (via PDCCH) indicating an order/command for initiating the random access process. The downlink control information may indicate the first set of one or more random access preambles/resources/occasions in the one or more sets of random access preambles/resources/occasions.

In an example, the wireless device may further receive one or more second configuration parameters indicating one or more second random access preambles/resources/occasions associated with random access processes of a second type. A random access process of the second type may comprise a single random access preamble transmission in response to initiating the random access process. The random access process of the second type may comprise a single random access preamble transmission in a random access preamble transmission attempt. The random access process of the second type may comprise a single random access preamble transmission for each preamble transmission counter value.

In an example embodiment, a wireless device may receive an indication of a first number of random access preamble transmissions in random access processes of a first type. A random access process of a first type may comprise multiple random access preamble transmissions in response to initiating the random access process. The random access process of the first type may comprise multiple random access preamble transmissions in a random access preamble transmission attempt. The random access process of the first type may comprise multiple random access preamble transmissions for each preamble transmission counter value. In response to initiating a random access process, the wireless device may transmit a plurality of random access preambles. A number of the plurality of random access preambles may be based on the first number. The wireless device may receive a random access response.

In an example, the receiving the random access response may be in response to (e.g., after e.g., in a first/earliest downlink control channel occasion after) transmitting the first random access preamble and the second random access preamble. The receiving the random access response may not be before transmitting the first random access preamble and the second random access preamble. The receiving the random access response may be only after transmitting the first random access preamble and the second random access preamble.

In an example, the first random access occasion may be earlier than the second random access occasion. The receiving the random access response may be in response to (e.g., after e.g., in a first/earliest downlink control channel occasion after) transmitting the first random access preamble.

In an example the receiving the random access response may be based on (e.g., in response to) monitoring a control channel for one or more radio network temporary identifiers (RNTIs) (e.g., one or more random access RNTIs (RA-RNTIs)) during a random access response window.

In an example, the monitoring the control channel may be in response to (e.g., after e.g., in a first/earliest downlink control channel occasion after) transmitting the first random access preamble and the second random access preamble. The monitoring the control channel may not be before transmitting the first random access preamble and the second random access preamble. The monitoring the control channel may be only after transmitting the first random access preamble and the second random access preamble.

In an example, the first random access occasion may be earlier than the second random access occasion. The monitoring the control channel may be in response to (e.g., after e.g., in a first/earliest downlink control channel occasion after) transmitting the first random access preamble.

In an example, the plurality of random access preambles may be the same (e.g., may be repetitions of the same random access preamble).

In an example, the indication may be based on one or more configuration parameters (e.g., one or more RRC configuration parameters and/or one or more configuration parameters received via a broadcast message (e.g., a SIB message)). In an example, one or more received configuration parameters may indicate the first number.

In an example, the wireless device may receive a downlink control information (via PDCCH) indicating an order/command for initiating the random access process. The indication may be based on the downlink control information. In an example, the downlink control information may comprise a field with a value indicating the first number. In an example, a parameter associated with the downlink control information may indicate the first number.

In an example embodiment, a wireless device may initiate a random access process. The random access process may comprise transmitting a first random access preamble and a second random access preamble. The transmitting the first random access preamble may be via a first uplink beam (spatial filter/setting). The transmitting the second random access preamble may be via a second uplink beam (spatial filter/setting). The wireless device may receive a random access response (RAR). The RAR and/or a parameter associated with the RAR may indicate one of the first uplink beam (spatial filter/setting) and the second uplink beam (spatial filter/setting) for a subsequent uplink transmission. The wireless device may transmit the subsequent uplink transmission based on/via the uplink beam (spatial filter/setting) indicated by the RAR or indicated by the parameter associated with the RAR.

In an example, the receiving the random access response may be in response to (e.g., after e.g., in a first/earliest downlink control channel occasion after) transmitting the first random access preamble and the second random access preamble. The receiving the random access response may not be before transmitting the first random access preamble and the second random access preamble. The receiving the random access response may be only after transmitting the first random access preamble and the second random access preamble.

In an example, the first random access occasion may be earlier than the second random access occasion. The receiving the random access response may be in response to (e.g., after e.g., in a first/earliest downlink control channel occasion after) transmitting the first random access preamble.

In an example the receiving the random access response may be based on (e.g., in response to) monitoring a control channel for one or more radio network temporary identifiers (RNTIs) (e.g., one or more random access RNTIs (RA-RNTIs)) during a random access response window.

In an example, the monitoring the control channel may be in response to (e.g., after e.g., in a first/earliest downlink control channel occasion after) transmitting the first random access preamble and the second random access preamble. The monitoring the control channel may not be before transmitting the first random access preamble and the second random access preamble. The monitoring the control channel may be only after transmitting the first random access preamble and the second random access preamble.

In an example, the first random access occasion may be earlier than the second random access occasion. The monitoring the control channel may be in response to (e.g., after e.g., in a first/earliest downlink control channel occasion after) transmitting the first random access preamble.

In an example, the second random access preamble may be a repetition of the first second access preamble. The second random access preamble may be the same as the first second access preamble.

In an example, the random access process may be of a first type. A random access process of the first type may comprise multiple random access preamble transmissions in response to initiating the random access process. A random access process of the first type may comprise multiple random access preamble transmissions in a random access preamble transmission attempt. A random access process of the first type may comprise multiple random access preamble transmissions for each preamble transmission counter value.

In an example, the RAR comprises a field with a value indicating one of the first uplink beam (spatial filter/setting) and the second uplink beam (spatial filter/setting) for the subsequent uplink transmission. In an example, the RAR may comprise an uplink grant indicating one of the first uplink beam (spatial filter/setting) and the second uplink beam (spatial filter/setting) for the subsequent uplink transmission. In an example, the uplink grant may comprise a field with a value indicating one of the first uplink beam (spatial filter/setting) and the second uplink beam (spatial filter/setting) for the subsequent uplink transmission. In an example, the field of the uplink grant may be a frequency hopping flag field. In an example, the field of the uplink grant may be a frequency resource allocation field. In an example, the field of the uplink grant may be a time resource allocation field. In an example, the field of the uplink grant may be a modulation and coding scheme field. In an example, the field of the uplink grant may be a transmit power control field. In an example, the field of the uplink grant may be a channel state information (CSI) request field.

In an example, the value of the field may indicate an identifier of the one of the first uplink beam (spatial filter/setting) and the second uplink beam (spatial filter/setting) for the subsequent uplink transmission.

In an example, the transmitting the first random access preamble may be in a first timing and/or a first random access resource/ occasion for transmission of the first random access preamble may be in a first timing. The transmitting the second random access preamble may be in a second timing and/or a second random access resource/ occasion for transmission of the second random access preamble may be in a second timing. The value of the field may indicate one of the first timing and the second timing, wherein the uplink beam (spatial filter/setting) that was used for transmission of a random access preamble in the indicated timing may be for transmission of the subsequent uplink transmission. In an example, the value of the field may indicate an index of a timing in a time-ordered sequence of the first timing and the second timing.

In an example, the wireless device may determine/compute/calculate a first RNTI (e.g., a first RA-RNTI) associated with transmission of the first random access preamble via the first uplink beam (spatial filter/setting). The wireless device may determine/compute/calculate a second RNTI (e.g., a second RA-RNTI) associated with transmission of the second random access preamble via the second uplink beam (spatial filter/setting). An RNTI (e.g., an RA-RNTI) associated with the RAR may be one of the first RNTI (the first RA-RNTI) and the second RNTI (the second RA-RNTI). The RNTI (e.g., the RA-RNTI) associated with the RAR may indicate one of the first uplink beam (spatial filter/setting) and the second uplink beam (spatial filter/setting) for the subsequent uplink transmission. In an example, the transmitting the subsequent uplink transmission may be based on/via the first uplink beam (spatial filter/setting) in response to the RNTI (e.g., the RA-RNTI) associated with the RAR being the first RNTI (e.g., the first RA-RNTI); and the transmitting the subsequent uplink transmission may be based on/via the second uplink beam (spatial filter/setting) in response to the RNTI (e.g., the RA-RNTI) associated with the RAR being the second RNTI (e.g., the second RA-RNTI).

In an example, the wireless device may monitor, during a random access response window, a control channel for the first RNTI (e.g., the first RA-RNTI) and the second RNTI (e.g., the second RA-RNTI).

In an example, the receiving the RAR may be based on a downlink control channel. One or more reference signals associated with the downlink control channel may indicate one of the first uplink beam (spatial filter/setting) and the second uplink beam (spatial filter/setting) for the subsequent uplink transmission. In an example, the one or more reference signals may comprise a demodulation reference signal (DMRS).

In an example, the wireless device may receive a downlink control information comprising scheduling information for the RAR. In an example, the receiving the RAR may be based on/ via a search space or a control resource set (CORESET). The search space or the CORESET may indicate one of the first uplink beam (spatial filter/setting) and the second uplink beam (spatial filter/setting) for the subsequent uplink transmission.

In an example, the subsequent uplink transmission may be a Msg 3 of the random access process.

In an example, the subsequent uplink transmission may be after completing the random access process.

In an example embodiment, a wireless device may initiate a random access process. The random access process may comprise transmitting a first random access preamble and transmitting a second random access preamble. The transmitting the first random access preamble may be via a first uplink beam (spatial filter/setting) via a first random access resource and/or in a first random access occasion. The transmitting the second random access preamble may be via a second uplink beam (spatial filter/setting) via a second random access resource and/or in a second random access occasion. The wireless device may determine/calculate/compute a first RNTI and a second RNTI. The first RNTI (e.g., a first RA-RNTI) may be associated with/based on transmission of the first random access preamble via the first uplink beam (spatial filter/setting). The second RNTI (e.g., a second RA-RNTI) may be associated with/based on transmission of the second random access preamble via the second uplink beam (spatial filter/setting). The wireless device may monitor, in a time window, a control channel for the first RNTI (e.g., the first RA-RNTI) and the second RNTI (e.g., the second RA-RNTI). The wireless device may receive, in response to the monitoring, a random access response (RAR) that is associated with one of the first RNTI (e.g., the first RA-RNTI) and the second RNTI (e.g., the second RA-RNTI). The wireless device may determine, based on the RNTI (e.g., the RA-RNTI) associated with the received RAR, one of the first uplink beam (spatial filter/setting) and the second uplink beam (spatial filter/setting) for a subsequent uplink transmission. The wireless device may transmit the subsequent uplink transmission based on/via the determined uplink beam (spatial filter/setting).

In an example, the monitoring the control channel may be in response to (e.g., after e.g., in a first/earliest downlink control channel occasion after) transmitting the first random access preamble and the second random access preamble. The monitoring the control channel may not be before transmitting the first random access preamble and the second random access preamble. The monitoring the control channel may be only after transmitting the first random access preamble and the second random access preamble.

In an example, the random access process may be of a first type. A random access process of the first type may comprise multiple random access preamble transmissions in response to initiating the random access process. A random access process of the first type may comprise multiple random access preamble transmissions in a random access preamble transmission attempt. A random access process of the first type may comprise multiple random access preamble transmissions for each preamble transmission counter value.

In an example, the time window may be a RAR window.

In an example, the first uplink beam (spatial filter/setting) may be associated with a first identifier/index and the second uplink beam (spatial filter/setting) is associated with a second identifier/index. The determining/calculating/computing the first RA-RNTI may be based on the first identifier/index and the determining/calculating/computing the second RNTI may be based on the second identifier/index.

In an example, the first preamble/resource/occasion (or a first group comprising the first preamble/resource/occasion) may be associated with a first identifier/index and the second preamble/resource/occasion (or a second group comprising the second preamble/resource/occasion) may be associated with a second identifier/index. The determining/calculating/computing the first RA-RNTI may be based on the first identifier/index and the determining/calculating/computing the second RNTI may be based on the second identifier/index.

In an example embodiment, a wireless device may initiate a random access process comprising transmitting a first random access preamble and transmitting a second random access preamble. The transmitting the first random access preamble may be via a first uplink beam (spatial filter/setting). The transmitting the second random access preamble may be via a second uplink beam (spatial filter/setting). The wireless device may determine/calculate/compute an RNTI (e.g., an RA-RNTI) based on one of: transmission of the first random access preamble; and transmission of the second ransom access preamble. The wireless device may monitor a control channel for the RNTI (e.g., the RA-RNTI) in a time window. The wireless device may receive, in response to the monitoring, a random access response (RAR) associated with the RA-RNTI.

In an example, the RNTI (e.g., the RA-RNTI) may be associated with a bundle/group of random access occasions.

In an example, the monitoring the control channel may be in response to (e.g., after e.g., in a first/earliest downlink control channel occasion after) transmitting the first random access preamble and the second random access preamble. In an example, the monitoring the control channel may not be before transmitting the first random access preamble and the second random access preamble. In an example, the monitoring the control channel may be only after transmitting the first random access preamble and the second random access preamble.

In an example, the first random access occasion may be earlier than the second random access occasion. The monitoring the control channel may be in response to (e.g., after e.g., in a first/earliest downlink control channel occasion after) transmitting the first random access preamble.

In an example, the determining the RNTI (e.g., the RA-RNTI) may be based on the transmission of the first random access preamble in response to a first timing of the first random access preamble being earlier than a second timing of the second random access preamble.

In an example, the determining the RNTI (e.g., the RA-RNTI) may be based on the transmission of the first random access preamble in response to a first timing of the first random access preamble being later than a second timing of the second random access preamble.

In an example embodiment, a wireless device may initiate a random access process. The random access process may comprise transmitting a first random access preamble and transmitting a second random access preamble. The transmitting the first random access preamble may be via a first uplink beam (spatial filter/setting). The transmitting the second random access preamble may be via a second uplink beam (spatial filter/setting). The wireless device may determine/calculate/compute a random access radio network temporary identifier (RA-RNTI) based on a parameter/identifier/index associated with a bundle/group comprising the first random access preamble and the second random access preamble. The wireless device may monitor a control channel for the RA-RNTI in a time window. The wireless device may receive, in response to the monitoring, a random access response (RAR) associated with the RA-RNTI.

In an example, the monitoring the control channel may be in response to (e.g., after e.g., in a first/earliest downlink control channel occasion after) transmitting the first random access preamble and the second random access preamble. In an example, the monitoring the control channel may not be before transmitting the first random access preamble and the second random access preamble. In an example, the monitoring the control channel may be only after transmitting the first random access preamble and the second random access preamble.

In an example embodiment, a wireless device may receive one or more configuration parameters of a random access process of a first type. The random access process of the first type may comprise multiple random access preamble transmissions in response to initiating the random access process. The random access process of the first type may comprise multiple random access preamble transmissions in a random access preamble transmission attempt. The random access process of the first type may comprise multiple random access preamble transmissions for each preamble transmission counter value. The wireless device may initiate a random access process of the first type comprising transmitting a first random access preamble and a second random access preamble. The transmitting the first random access preamble may be in a first random access occasion and/or via a first random access resource. The transmitting the second random access preamble may be in a second random access occasion and/or via a second random access resource. The wireless device may determine a starting time of a random access response window. The wireless device may monitor a control channel in the random access response window based on the starting time.

In an example, the one or more configuration parameters may comprise a first parameter indicating a duration of the random access response window.

In an example, the starting time may be in a first/earliest control channel occasion after the earlier of the first random access occasion and the second random access occasion.

In an example, the starting time may be in a first/earliest control channel occasion after the later of the first random access occasion and the second random access occasion.

In an example, the transmitting the first random access preamble may be via a first uplink beam (spatial filter/setting). The transmitting the second random access preamble may be via a second uplink beam (spatial filter/setting). In an example, the starting time may be based on the first uplink beam (spatial filter/setting), used for transmission of the first random access preamble, and the second uplink beam (spatial filter/setting) used for transmission of the second random access preamble. In an example, the starting time may be in a first /earliest control channel occasion after the first random access occasion based on one or more parameters/criteria associated with the first uplink beam (spatial filter/setting) used for transmission of the first random access preamble. In an example, the one or more parameters/criteria associated with the first uplink beam (spatial filter/setting) may comprise an identifier/index of the first uplink beam (spatial filter/setting).

In an example embodiment, a wireless device may receive one or more configuration parameters of a search space associated with random access response reception. The search space may be one of a first search space and a second search space. The first search space may be associated with random access processes of a first type. The second search space may be associated with random access processes of a second type. The wireless device may initiate a random access process. The wireless device may monitor: the first search space in response to the random access process being of the first type; and the second search space in response to the random access process comprising being of the second type.

In an example, the first search space and the second search space may be common search spaces.

In an example, the search space may be a random access response search space.

In an example, a random access process of a first type may comprise multiple random access preamble transmissions in response to initiating the random access process. The random access process of the first type may comprise multiple random access preamble transmissions in a random access preamble transmission attempt. The random access process of the first type may comprise multiple random access preamble transmissions for each preamble transmission counter value. A random access process of a second type may comprise a single random access preamble transmission in response to initiating the random access process. The random access process of the second type may comprise a single random access preamble transmission in a random access preamble transmission attempt. The random access process of the second type may comprise a single random access preamble transmission for each preamble transmission counter value.

In an example, the wireless device may transmit a capability message comprising one or more capability IEs indicating whether the wireless device is capable of the second type of random access process comprising transmitting multiple random access preambles after initiating the random access process (e.g., in response to initiating the random access process or in a random access preamble transmission attempt or for each preamble transmission counter value).

In an example, the one or more capability IEs may indicate that the wireless device is capable of the first type of random access process. The random access process may comprise transmitting multiple random access preambles after initiating the random access process. The monitoring may be for the first search space.

In an example embodiment, a wireless device may transmit to a base station, one or more capability messages comprising one or more capability information elements associated with random access processes of a first type. In response to transmitting the one or more capability messages and based on values of the one or more capability IEs, the wireless device may initiate a random access process. The random access process may comprise transmitting a first random access preamble via a first uplink beam (spatial filter/setting); and transmitting a second random access preamble via a second uplink beam (spatial filter/setting). The wireless device may receive a random access response.

In an example, a random access process of a first type may comprise multiple random access preamble transmissions in response to initiating the random access process. The random access process of the first type may comprise multiple random access preamble transmissions in a random access preamble transmission attempt. The random access process of the first type may comprise multiple random access preamble transmissions for each preamble transmission counter value.

In an example, the values of the one or more capability IEs may indicate that the wireless device is capable of the random access processes of the first type. In an example, the wireless device may receive one or more random access configuration parameters associated with the random access processes of the first type. The reception of the one or more random access configuration parameters may be in response to the one or more capability IEs indicating that the wireless device is capable of the random access processes of the first type. In an example, the wireless device may receive one or more configuration parameters of a random access response search space used in reception of control information associated with (e.g., indicating scheduling information for) random access response in random access processes of the first type. The reception of the one or more configuration parameters may be in response to the one or more capability IEs indicating that the wireless device is capable of the random access processes of the first type.

In an example, the values of the one or more capability IEs may indicate that the wireless device is capable of supporting a random access response search space for reception of control information associated with (e.g., indicating scheduling information for) random access response in random access processes of the first type. In an example, the values of the one or more capability IEs may indicate that the wireless device is capable of multiple random access response search spaces. In an example, the multiple random access response search spaces may comprise: a first random access response search space for reception of control information associated with (e.g., indicating scheduling information for) random access response in random access processes of the first type; and a second random access response search space for reception of control information associated with (e.g., indicating scheduling information for) random access response in random access processes of a second type. In an example, a random access process of a second type may comprise a single random access preamble transmission in response to initiating the random access process. The random access process of the second type may comprise a single random access preamble transmission in a random access preamble transmission attempt. The random access process of the second type may comprise a single random access preamble transmission for each preamble transmission counter value. In an example, the wireless device may receive one or more configuration parameters of a random access response search space used in reception of control information associated with (e.g., indicating scheduling information for) random access response in random access processes of the first type. The receiving the one or more configuration parameters may be in response to the one or more capability IEs indicating that the wireless device is capable of supporting a random access response search space for reception of control information associated with (e.g., indicating scheduling information for) random access response in random access processes of the first type.

In an example embodiment, a wireless device may initiate a random access process that is of one of a first type and a second type. The wireless device may receive a RAR. The RAR may be of a first format in response to the random access process being of the first type. The RAR may be of a second format in response to the random access process being of the second type.

In an example, a random access process of a first type may comprise multiple random access preamble transmissions in response to initiating the random access process. The random access process of the first type may comprise multiple random access preamble transmissions in a random access preamble transmission attempt. The random access process of the first type may comprise multiple random access preamble transmissions for each preamble transmission counter value. A random access process of a second type may comprise a single random access preamble transmission in response to initiating the random access process. The random access process of the second type may comprise a single random access preamble transmission in a random access preamble transmission attempt. The random access process of the second type may comprise a single random access preamble transmission for each preamble transmission counter value.

In an example, a first number of fields in the RAR of the first format may be different from a second number of fields in the RAR of the second format.

In an example, a first number of bits in the RAR of the first format may be different from a second number of bits in the RAR of the second format.

In an example embodiment, a wireless device may initiate a random access process that is of one of a first type and a second type. The wireless device may receive a RAR. A value of a first field of the RAR may indicate a first parameter in response to the random access process being of the first type. A value of the first field of the RAR may indicate a second parameter and/or may not indicate the first parameter in response to the random access process being of the second type (e.g., not being of the first type).

In an example, a random access process of a first type may comprise multiple random access preamble transmissions in response to initiating the random access process. The random access process of the first type may comprise multiple random access preamble transmissions in a random access preamble transmission attempt. The random access process of the first type may comprise multiple random access preamble transmissions for each preamble transmission counter value.

In an example, a random access process of a second type may comprise a single random access preamble transmission in response to initiating the random access process. The random access process of the second type may comprise a single random access preamble transmission in a random access preamble transmission attempt. The random access process of the second type may comprise a single random access preamble transmission for each preamble transmission counter value.

In an example, the first field of the RAR may be a frequency hopping flag field. The second parameter may be a frequency hopping flag.

In an example, the first field of the RAR may be a frequency resource allocation field. The second parameter may be a frequency resource allocation.

In an example, the first field of the RAR may be a time resource allocation field. The second parameter may be a time resource allocation.

In an example, the first field of the RAR may be a modulation and coding scheme field. The second parameter may be a modulation and coding scheme indication.

In an example, the first field of the RAR may be a transmit power control field. The second parameter may be a transmit power control command.

In an example, the first field of the RAR may be a channel state information (CSI) request field. The second parameter may be a CSI request indication.

In an example, the first parameter may be an indication of uplink beam (spatial filter/setting) for a subsequent uplink transmission.

In an example, one or more bits of the first field may indicate the first parameter in response to the random access process being of the first type. In an example, the one or more bits are one or more most significant bits of the first field. In an example, the one or more bits are one or more least significant bits of the first field.

In accordance with various exemplary embodiments in the present disclosure, a device (e.g., a wireless device, a base station and/or alike) may include one or more processors and may include memory that may store instructions. The instructions, when executed by the one or more processors, cause the device to perform actions as illustrated in the accompanying drawings and described in the specification. The order of events or actions, as shown in a flow chart of this disclosure, may occur and/or may be performed in any logically coherent order. In some examples, at least two of the events or actions shown may occur or may be performed at least in part simultaneously and/or in parallel. In some examples, one or more additional events or actions may occur or may be performed prior to, after, or in between the events or actions shown in the flow charts of the present disclosure.

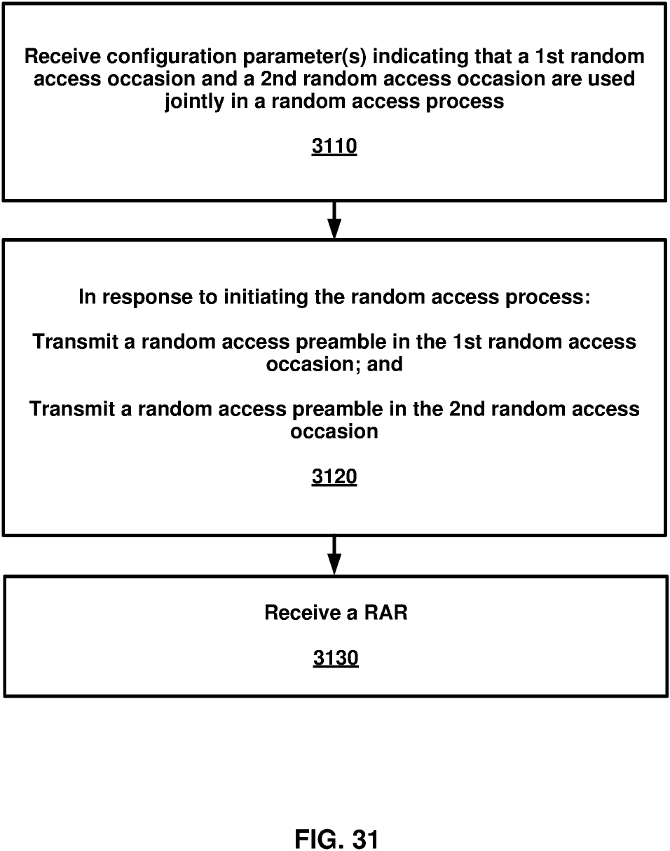

FIG. 31 shows an example flow diagram in accordance with several of various embodiments of the present disclosure. At 3110, a wireless device may receive one or more configuration parameters indicating that a first random access occasion and a second random access occasion are used jointly in a random access process. At 3120, in response to initiating the random access process, the wireless device may: transmit a random access preamble in the first random access occasion; and transmit a random access preamble in the second random access occasion. At 3130, the wireless device may receive a random access response.

In an example embodiment, the transmitting, at 3120, the random access preamble in the first random access occasion and the transmitting, at 3120, the random access preamble in the second random access occasion may be based on the one or more configuration parameters, received at 3110, indicating that the first random access occasion and the second random access occasion are used jointly in the random access process.

In an example embodiment, the transmitting, at 3120, the random access preamble in the first random access occasion and the transmitting, at 3120, the random access preamble in the second random access occasion may be via the same transmit beam.

In an example embodiment, the first random access occasion and the second random access occasion may be in the same random access occasion group. In an example embodiment, the random access occasion group may comprise a plurality of random access occasions comprising the first random access occasion and the second random access occasion. The configuration parameters may indicate the plurality of random access occasions.

In an example embodiment, the random access preamble transmitted, at 3120, in the first random access occasion may be the same as the random access preamble transmitted, at 3120, in the second random access occasion.

In an example embodiment, the first random access occasion may be associated with a first transmit beam (e.g., a first spatial filter/setting). The second random access occasion may be associated with a second transmit beam (e.g., a second spatial filter/setting). In an example embodiment, the one or more configuration parameters, received at 3110, may indicate that: the first random access occasion is associated with a first transmit beam (e.g., a first spatial filter/setting); and the second random access occasion is associated with a second transmit beam (e.g., a second spatial filter/setting). In an example embodiment, the first transmit beam (e.g., the first spatial filter/setting) may be associated with a first identifier; and the second transmit beam (e.g., the second spatial filter/setting) may be associated with a second identifier. In an example embodiment, the one or more configuration parameters, received at 3110, may indicate that: the first transmit beam (e.g., the first spatial filter/setting) is associated with a first identifier; and the second transmit beam (e.g., the second spatial filter/setting) is associated with a second identifier. In an example embodiment, the transmitting, at 3120, the random access preamble in the first random access occasion may be via the first spatial filter/setting. The transmitting, at 3120, the random access preamble in the second random access occasion may be via the second spatial filter/setting. In an example embodiment, a bundle/group, comprising the first random access occasion and the second random access occasion, may be associated with a plurality of transmit beams (e.g., spatial filters/settings) comprising the first transmit beam (e.g., the first spatial filter/setting) and the second transmit beam (e.g., the second spatial filter/setting). In an example embodiment, the first transmit beam (e.g., the first spatial filter/setting) may be associated with a first identifier; and the second transmit beam (e.g., the second spatial filter/setting) may be associated with a second identifier. In an example embodiment, the wireless device may receive a downlink control information (via PDCCH) indicating an order/command for initiating the random access process, wherein the downlink control information may indicate the first identifier of the first transmit beam (e.g., the first spatial filter/setting) used for transmission of the random access preamble in the first random access occasion and the second identifier of the second transmit beam (e.g., the second spatial filter/setting) used for transmission of the random access preamble in the second random access occasion. In an example embodiment, the one or more configuration parameters, received at 3110, may indicate the first identifier of the first transmit beam (e.g., the first spatial filter/setting) and the second identifier of the second transmit beam (e.g., the second spatial filter/setting). In an example embodiment, the one or more configuration parameters, received at 3110, may comprise: one or more first parameters indicating the first identifier of the first transmit beam (e.g., the first spatial filter/setting); and one or more second parameters indicating the second identifier of the second uplink beam (e.g., the second spatial filter/setting). In an example embodiment, the first identifier and the second identifier may be based on relative timing of the first random access occasion and the second random access occasion. In an example embodiment, the first identifier may have a lower value than the second identifier in response to the first random access occasion being earlier than the second random access occasion. In an example embodiment, the wireless device may determine the first transmit beam (e.g., the first spatial filter/setting), for transmission of the random access preamble in the first random access occasion, based on the first identifier. The wireless device may determine the second transmit beam (e.g., the second spatial filter/setting), for transmission of the random access preamble in the second random access occasion, based on the second identifier. In an example embodiment, the wireless device may determine, based on the wireless device implementation, the first transmit beam (e.g., the first spatial filter/setting) associated with the first random access occasion. The wireless device may determine, based on the wireless device implementation, the first transmit beam (e.g., the first spatial filter/setting) for transmission of the random access preamble in the first random access occasion.

In an example embodiment, the first random access occasion and the second random access occasion may be at different time instances.

In an example embodiment, the receiving the random access response, at 3130, may be in response to (e.g., after e.g., in a first/earliest downlink control channel occasion after) the transmitting, at 3120, the random access preamble in the first random access occasion and the transmitting, at 3120, the random access preamble in the second random access occasion. The receiving the random access response, at 3130, may not be before the transmitting both of the random access preamble in the first random access occasion and the random access preamble in the second random access occasion. The receiving the random access response, at 3130, may only be after the transmitting, at 3120, the random access preamble in the first random access occasion and the transmitting, ay 3120, the random access preamble in the second random access occasion.

In an example embodiment, the first random access occasion may be earlier than the second random access occasion. The receiving the random access response, at 3130, may be in response to (e.g., after e.g., in a first/earliest downlink control channel occasion after) transmitting the random access preamble in the first random access occasion.

In an example embodiment, the receiving the random access response, at 3130, may be based on (e.g., in response to) monitoring a control channel for one or more radio network temporary identifiers (RNTIs) (e.g., one or more random access RNTIs (RA-RNTIs)) during a random access response window. In an example embodiment, the monitoring the control channel may be in response to (e.g., after e.g., in a first/earliest downlink control channel occasion after) the transmitting, at 3120, the random access preamble in the first random access occasion and the transmitting, at 3120, the random access preamble in the second random access occasion. The monitoring the control channel may not be before transmitting both of the random access preamble in the first random access occasion and the transmitting the second random access preamble in the second random access occasion. The monitoring the control channel may only be after the transmitting the random access preamble in the first random access occasion and the transmitting the random access preamble in the second random access occasion. In an example embodiment, the first random access occasion may be earlier than the second random access occasion. The monitoring of the control channel may be in response to (e.g., after e.g., in a first/earliest downlink control channel occasion after) transmitting the random access preamble in the first random access occasion.

In an example embodiment, the random access preamble transmitted at 3120 in the second random access occasion may be a repetition of (e.g., the same as) the random access preamble transmitted at 3120 in the first random access occasion.

In an example embodiment, the first random access occasion and the second random access occasion may be associated with (e.g., for transmission via/based on) the same transmit beam (spatial filter/setting). In an example embodiment, the transmitting the random access preamble in the first random access occasion at 3120 and the transmitting the random access preamble in the second random access occasion at 3120 may be based on the same spatial filter/setting. In an example embodiment, the one or more configuration parameters, received at 3110, may indicate that the first random access occasion and the second random access occasion are associated with (e.g., for transmission via/based on) the same transmit beam (spatial filter/setting). In an example embodiment, the one or more configuration parameters, received at 3110, may comprise one or more first parameters indicating that the first random access occasion and the second random access occasion are associated with (e.g., for transmission via/based on) the same transmit beam (spatial filter/setting). In an example embodiment, the one or more configuration parameters, received at 3110, may indicate an identifier of a transmit beam (e.g., spatial filter/setting) for transmission of the random access preamble in the first random access occasion and transmission of the random access preamble in the second random access occasion. The first random access occasion and the second random access occasion may be associated with the transmit beam (spatial filter/setting). In an example embodiment, the wireless device may determine the transmit beam (e.g., spatial filter/setting), for transmission, at 3120, of the random access preamble in the first random access occasion and transmission, at 3120, of the random access preamble in the second random access occasion, based on the identifier. In an example, the transmit beam (e.g., spatial filter/setting) used for transmission, at 3120, of the random access preamble in the first random access occasion and transmission, at 3120, of the random access preamble in the second random access preamble may be determined based on the wireless device implementation. In an example embodiment, the wireless device may receive a downlink control information (via PDCCH) indicating an order/command for initiating the random access process, wherein the downlink control information may indicate the identifier of the transmit beam (e.g., spatial filter/setting) used for transmission, at 3120, of the random access preamble in the first random access occasion and transmission, at 3120, of the random access preamble in the second random access occasion.

In an example embodiment, the first random access occasion may be associated with a first identifier; and the second random access occasion may be associated with a second identifier. In an example embodiment, the first identifier may have a lower value than the second identifier in response to the first random access occasion being earlier than the second random access occasion. In an example embodiment, determining the first transmit beam (e.g., the first spatial filter/setting) may be based on the first identifier of the first random access occasion and/or determining the second the second transmit beam (spatial filter/setting) may be based on the second identifier of the second random access occasion.

In an example embodiment, the receiving the one or more configuration parameters, at 3110, may be based on/via one or more radio resource control (RRC) messages. The wireless device may receive one or more RRC messages comprising the one or more configuration parameters.

In an example embodiment, the receiving the one or more configuration parameters, at 3110, may be based on/via a broadcast message (e.g., a system information block (SIB) message). The wireless device may receive one or more broadcast messages (e.g., SIB) comprising the one or more configuration parameters.

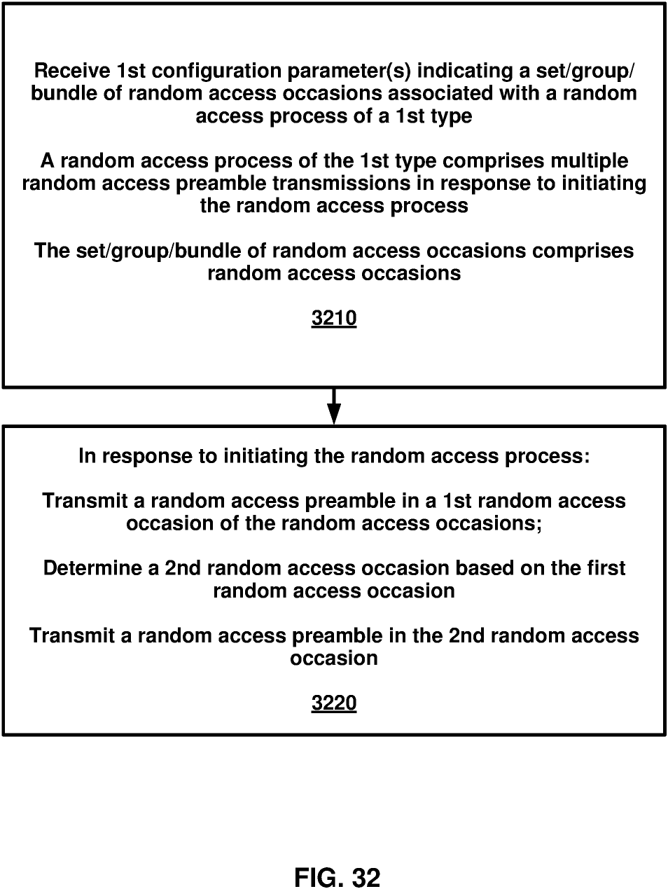

FIG. 32 shows an example flow diagram in accordance with several of various embodiments of the present disclosure. At 3210, a wireless device may receive one or more first configuration parameters indicating a set/group/bundle of random access occasions associated with a random access process of a first type. A random access process of the first type may comprise multiple random access preamble transmissions in response to initiating the random access process. A random access process of the first type may comprise multiple random access preamble transmissions in a random access preamble transmission attempt. A random access process of the first type may comprise multiple random access preamble transmissions for each preamble transmission counter value. The set/group/bundle of random access occasions may comprise a plurality of random access occasions. At 3220, in response to initiating a random access process, the wireless device may: transmit a random access preamble in a first random access occasion of the plurality of random access occasions; determine a second random access occasion based on the first random access occasion; and transmit a random access preamble in the second random access occasion.

In an example embodiment, the wireless device may receive a random access response. In an example embodiment, the receiving the random access response may be in response to (e.g., after e.g., in a first/earliest downlink control channel occasion after) transmitting, at 3220, the random access preamble in the first random access occasion and transmitting, at 3220, the random access preamble in the second random access occasion. The receiving the random access response may not be before transmitting both of the random access preamble in the first random access occasion and the random access preamble in the second random access occasion. The receiving the random access response may be only after transmitting the random access preamble in the first random access occasion and transmitting the random access preamble in the second random access occasion. In an example embodiment, the first random access occasion may be earlier than the second random access occasion. The receiving the random access response may be in response to (e.g., after e.g., in a first/earliest downlink control channel occasion after) transmitting the random access preamble in the first random access occasion. In an example embodiment, the receiving the random access response may be based on (e.g., in response to) monitoring a control channel for one or more radio network temporary identifiers (RNTIs) (e.g., one or more random access RNTIs (RA-RNTIs)) during a random access response window. In an example embodiment, the monitoring the control channel may be in response to (e.g., after e.g., in a first/earliest downlink control channel occasion after) transmitting, at 3220, the random access preamble in the first random access occasion and transmitting, at 3220, the random access preamble in the second random access occasion. The monitoring the control channel may not be before transmitting both of the random access preamble in the first random access occasion and transmitting the random access preamble in the second random access occasion. The monitoring the control channel may only be after transmitting the random access preamble in the first random access occasion and transmitting the random access preamble in the second random access occasion. In an example embodiment, the first random access occasion may be earlier than the second random access occasion. The monitoring the control channel may be in response to (e.g., after e.g., in a first/earliest downlink control channel occasion after) transmitting the random access preamble in the first random access occasion.

In an example embodiment, the random access preamble transmitted in the second random access occasion may be a repetition of (e.g., the same as) the random access preamble transmitted in the first random access occasion.

In an example embodiment, the determining the second random access occasion at 3220 may be from the set/group/bundle of random access occasions.

In an example embodiment, the transmitting the random access preamble in the first random access occasion at 3220 may be via/based on a transmit beam (e.g., spatial filter/setting). The first random access occasion may be associated with a transmit beam (e.g., spatial filter/setting). The transmitting the random access preamble in the second random access occasion at 3220 may be via/based on the transmit beam (e.g., spatial filter/setting). The second random access occasion may be associated with the transmit beam (e.g., spatial filter/setting). In an example embodiment, the one or more first configuration parameters may indicate that the first random access occasion and the second random access occasion are associated with the same transmit beam (e.g., spatial filter/setting). In an example embodiment, the set/group/bundle of random access occasions may be associated with a corresponding transmit beam (e.g., spatial filter/setting).

In an example embodiment, the transmitting the random access preamble in the first random access occasion at 3220 may be via/based on a first transmit beam (e.g., spatial filter/setting). The first random access occasion may be associated with a first transmit beam (e.g., spatial filter/setting). The transmitting the random access preamble in the second random access occasion at 3220 may be via/based on a second transmit beam (e.g., spatial filter/setting). The second random access occasion may be associated with a second transmit beam (e.g., spatial filter/setting). In an example embodiment, the wireless device may determine: the first transmit beam (e.g., spatial filter/setting) based on wireless device implementation; and may determine the second transmit beam (e.g., spatial filter/setting) based on the first transmit beam (e.g., spatial filter/setting). In an example embodiment, the wireless device may determine, based on wireless device implementation, the first transmit beam (e.g., spatial filter/setting) and the second transmit beam (e.g., spatial filter/setting).

In an example embodiment, the wireless device may receive a downlink control information (via PDCCH) indicating an order/command for initiating the random access process, wherein the downlink control information may indicate the set/group/bundle of the random access occasions.

In an example embodiment, the wireless device may receive one or more second configuration parameters indicating one or more second random access occasions associated with random access processes of a second type, wherein a random access process of a second type may comprise single random access preamble transmission (in response to initiating the random access process) (in a random access preamble transmission attempt) (for each preamble transmission counter value).

In an example embodiment, the random access preamble transmitted in the second random access occasion at 3220 may be different from the random access preamble transmitted in the first random access occasion at 3220.

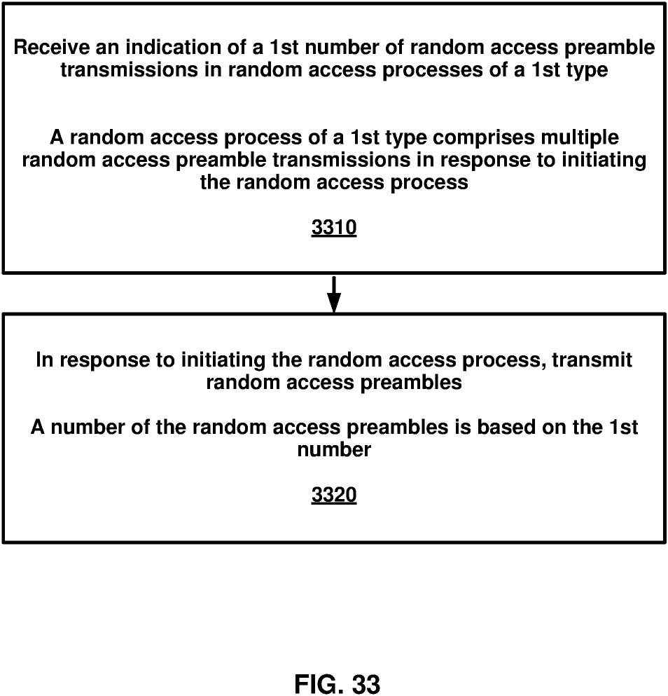

FIG. 33 shows an example flow diagram in accordance with several of various embodiments of the present disclosure. At 3310, a wireless device may receive an indication of a first number of random access preamble transmissions in random access processes of a first type. A random access process of a first type may comprise multiple random access preamble transmissions in response to initiating the random access process. A random access process of a first type may comprise multiple random access preamble transmissions in a random access preamble transmission attempt. A random access process of a first type may comprise multiple random access preamble transmissions for each preamble transmission counter value. At 3320, in response to initiating a random access process, the wireless device may transmit a plurality of random access preambles, wherein a number of the plurality of random access preambles may be based on the first number.

In an example embodiment, the wireless device may receive a random access response. In an example embodiment, the receiving the random access response may be in response to (e.g., after e.g., in a first/earliest downlink control channel occasion after transmitting the plurality of random access preambles. The receiving the random access response may not be before transmitting the plurality of random access preamble. The receiving the random access response may only be after transmitting the plurality of random access preambles. In an example embodiment, the receiving the random access response may be in response to (e.g., after e.g., in a first/earliest downlink control channel occasion after)) transmitting a first random access preamble that is an earliest random access preamble in the plurality of random access preambles. In an example embodiment, the receiving the random access response may be based on (e.g., in response to) monitoring a control channel for one or more radio network temporary identifiers (RNTIs) (e.g., one or more random access RNTIs (RA-RNTIs)) during a random access response window. In an example embodiment, the monitoring the control channel may be in response to (e.g., after e.g., in a first/earliest downlink control channel occasion after) transmitting the plurality of random access preambles. The monitoring the control channel may not be before transmitting the plurality of random access preambles. The monitoring the control channel may only be after transmitting the plurality of random access preambles. In an example embodiment, the monitoring the control channel may be in response to (e.g., after e.g., in a first/earliest downlink control channel occasion after) transmitting an earliest random access preamble in the plurality of random access preambles.

In an example embodiment, the plurality of random access preambles may be the same (e.g., repetitions of the same random access preamble).

In an example embodiment, the indication, received at 3310, may be based on one or more configuration parameters (e.g., one or more RRC configuration parameters and/or one or more configuration parameters received via a broadcast message (e.g., a SIB message)). In an example embodiment, one or more received configuration parameters may indicate the first number.

In an example embodiment, the wireless device may receive a downlink control information (via PDCCH) indicating an order/command for initiating the random access process, wherein the indication, received at 3310, may be based on the downlink control information. In an example embodiment, the downlink control information may comprise a field with a value indicating the first number. In an example embodiment, a parameter associated with the downlink control information may indicate the first number.

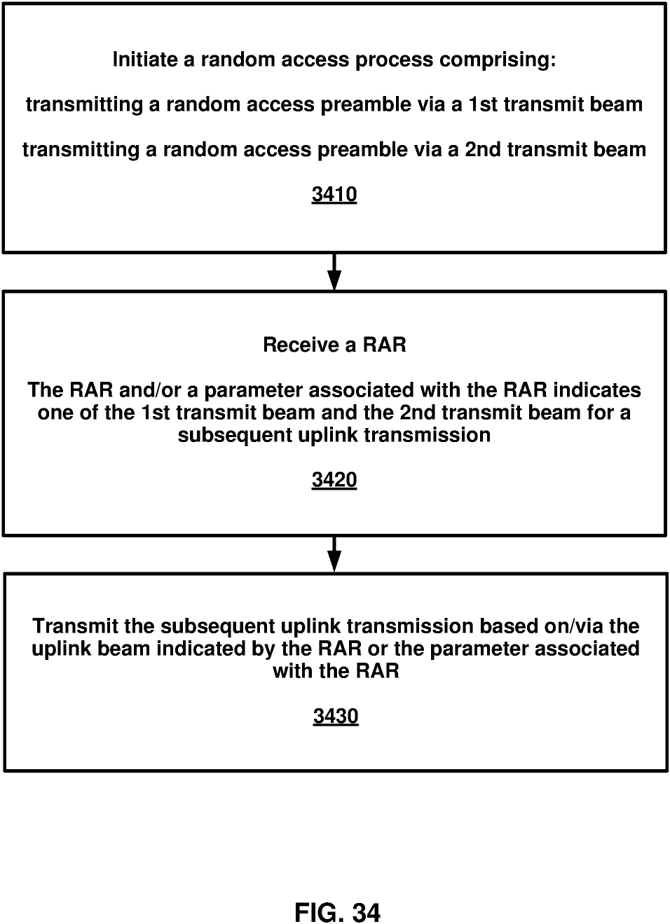

FIG. 34 shows an example flow diagram in accordance with several of various embodiments of the present disclosure. At 3410, a wireless device may initiate a random access process comprising: transmitting a random access preamble via a first transmit beam (spatial filter/setting); and transmitting a random access preamble via a second transmit beam (spatial filter/setting). At 3420, the wireless device may receive a random access response (RAR), wherein the RAR (and/or a parameter associated with the RAR) may indicate one of the first transmit beam (spatial filter/setting) and the second transmit beam (spatial filter/setting) for a subsequent uplink transmission. At 3430, the wireless device may transmit the subsequent uplink transmission based on/via the uplink beam (spatial filter/setting) indicated by the RAR or the parameter associated with the RAR.

In an example embodiment, the receiving the random access response, at 3420, may be in response to (e.g., after e.g., in a first/earliest downlink control channel occasion after) transmitting the random access preamble via the first transmit beam at 3410 and the random access preamble via the second transmit beam at 3410. The receiving the random access response may not be before transmitting both of the random access preamble via the first transmit beam and transmitting the random access preamble via the second transmit beam. The receiving the random access response may only be after transmitting the random access preamble via the first transmit beam and transmitting the random access preamble via the second transmit beam. In an example embodiment, a first random access occasion of the transmitting the random access preamble via the first transmit beam may be earlier than a second random access occasion of the transmitting the random access preamble via the second transmit beam. The receiving the random access response, at 3420, may be in response to (e.g., after e.g., in a first/earliest downlink control channel occasion after) transmitting the random access preamble via the first transmit beam.

In an example embodiment, the receiving the random access response, at 3420, may be based on (e.g., in response to) monitoring a control channel for one or more radio network temporary identifiers (RNTIs) (e.g., one or more random access RNTIs (RA-RNTIs)) during a random access response window. In an example embodiment, the monitoring the control channel may be in response to (e.g., after e.g., in a first/earliest downlink control channel occasion after) transmitting the random access preamble via the first transmit beam at 3410 and transmitting the random access preamble via the second transmit beam at 3410. The monitoring the control channel may not be before transmitting both of the random access preamble via the first transmit beam and the random access preamble via the second transmit beam. The monitoring the control channel may only be after transmitting the random access preamble via the first beam and transmitting the random access preamble via the second transmit beam.

In an example embodiment, the random access preamble transmitted via the first transmit beam at 3410 may be a repetition of (e.g., the same as) the random access preamble transmitted via the second transmit beam at 3410.

In an example embodiment, the random access preamble transmitted via the first transmit beam at 3410 may be different from the random access preamble transmitted via the second transmit beam at 3410.

In an example embodiment, the random access process, in 3410, may be of a first type. A random access process of a first type may comprise multiple random access preamble transmissions in response to initiating the random access process. A random access process of a first type may comprise multiple random access preamble transmissions in a random access preamble transmission attempt. A random access process of a first type may comprise multiple random access preamble transmissions in for each preamble transmission counter value.

In an example embodiment, the RAR, received at 3420, may comprise a field with a value indicating one of the first transmit beam (e.g., spatial filter/setting) and the second transmit beam (e.g., spatial filter/setting) for the subsequent uplink transmission.

In an example embodiment, the RAR, received at 3420, may comprise an uplink grant indicating one of the first transmit beam (e.g., spatial filter/setting) and the second transmit beam (e.g., spatial filter/setting) for the subsequent uplink transmission. In an example embodiment, the uplink grant may comprise a field with a value indicating one of the first transmit beam (e.g., spatial filter/setting) and the second transmit beam (e.g., spatial filter/setting) for the subsequent uplink transmission. In an example embodiment, the field of the uplink grant may be a frequency hopping flag field. In an example embodiment, the field of the uplink grant may be a frequency resource allocation field. In an example embodiment, the field of the uplink grant may be a time resource allocation field. In an example embodiment, the field of the uplink grant may be a modulation and coding scheme field. In an example embodiment, the field of the uplink grant may be a transmit power control field. In an example embodiment, the field of the uplink grant may be a channel state information (CSI) request field. In an example embodiment, the value of the field may indicate an identifier of the one of the first transmit beam (e.g., spatial filter/setting) and the second transmit beam (e.g., spatial filter/setting) for the subsequent uplink transmission. In an example embodiment, the transmitting the random access preamble via the first transmit beam may be in a first timing. A first random access resource/ occasion for transmission of the random access preamble via the first transmit beam may be in a first timing. The transmitting the random access preamble via the second transmit beam may be in a second timing. A second random access resource/ occasion for transmission of the random access preamble via the second transmit beam may be in a second timing. The value of the field may indicate one of the first timing and the second timing, wherein the transmit beam (e.g., spatial filter/setting) that was used for transmission of a random access preamble in the indicated timing may be for transmission of the subsequent uplink transmission. In an example embodiment, the value of the field may indicate an index of a timing in a time-ordered sequence of the first timing and the second timing.

In an example embodiment, the wireless device may determine/compute/calculate a first RNTI (e.g., a first RA-RNTI) associated with transmission of the random access preamble via the first transmit beam (e.g., spatial filter/setting). The wireless device may determine/compute/calculate a second RNTI (e.g., a second RA-RNTI) associated with transmission of the random access preamble via the second transmit beam (e.g., spatial filter/setting). An RNTI (e.g., an RA-RNTI) associated with the RAR may be one of the first RNTI (the first RA-RNTI) and the second RNTI (the second RA-RNTI). The RNTI (e.g., the RA-RNTI) associated with the RAR may indicate one of the first transmit beam (e.g., the first spatial filter/setting) and the second transmit beam (e.g., the second spatial filter/setting) for the subsequent uplink transmission. In an example embodiment, the transmitting the subsequent uplink transmission, at 3430, may be based on/via the first transmit beam (e.g., the first spatial filter/setting) in response to the RNTI (e.g., the RA-RNTI) associated with the RAR being the first RNTI (e.g., the first RA-RNTI). The transmitting the subsequent uplink transmission, at 3430, may be based on/via the second transmit beam (e.g., the second spatial filter/setting) in response to the RNTI (the RA-RNTI) associated with the RAR being the second RNTI (e.g., the second RA-RNTI).

In an example embodiment, the wireless device may monitor, during a random access response window, a control channel for the first RNTI (e.g., the first RA-RNTI) and the second RNTI (e.g., the second RA-RNTI).

In an example embodiment, the receiving the RAR, at 3420, may be based on a downlink control channel. One or more reference signals associated with the downlink control channel may indicate one of the first transmit beam (spatial filter/setting) and the second transmit beam (spatial filter/setting) for the subsequent uplink transmission. In an example embodiment, the one or more reference signals may comprise a demodulation reference signal (DMRS).

In an example embodiment, the wireless device may receive a downlink control information comprising scheduling information for the RAR. In an example embodiment, the receiving the downlink control information may be based on/ via a search space and/or a control resource set (CORESET). The search space and/or the CORESET may indicate one of the first transmit beam (e.g., the first spatial filter/setting) and the second transmit beam (e.g., the second spatial filter/setting) for the subsequent uplink transmission.

In an example embodiment, the subsequent uplink transmission, in 3430, may be a Msg 3 of the random access process.

In an example embodiment, the subsequent uplink transmission, in 3430, may be after completing the random access process.

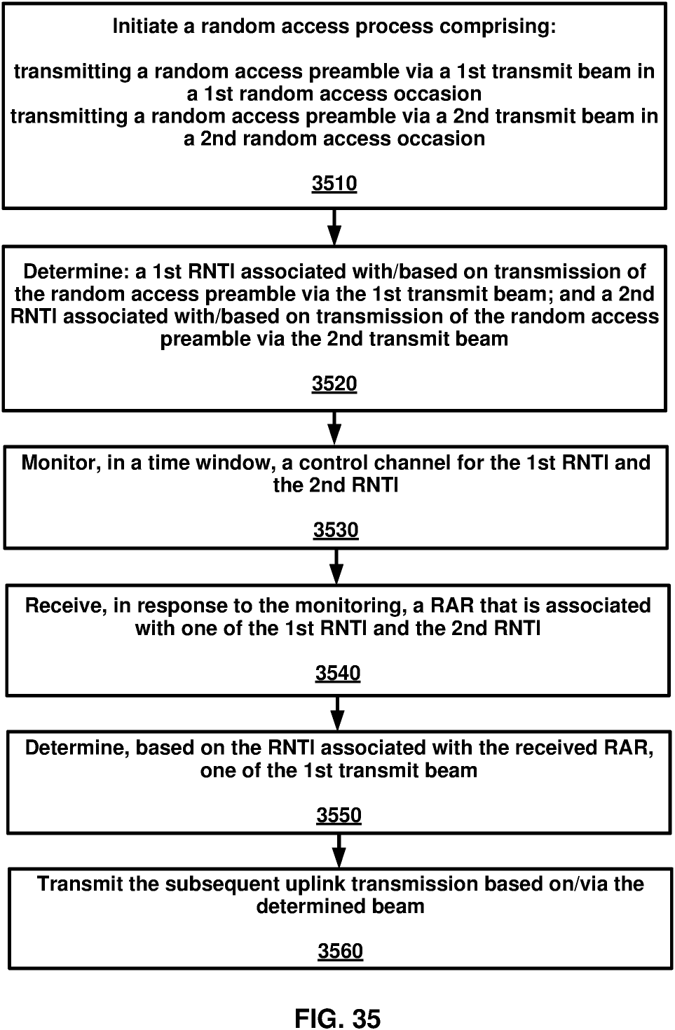

FIG. 35 shows an example flow diagram in accordance with several of various embodiments of the present disclosure. At 3510, a wireless device may initiate a random access process comprising: transmitting a random access preamble via a first transmit beam (spatial filter/setting) in a first random access occasion; and transmitting a random access preamble via a second transmit beam (spatial filter/setting) in a second random access occasion. At 3520, the wireless device may determine/calculate/compute: a first RNTI (e.g., a first RA-RNTI) associated with/based on transmission of the random access preamble via the first transmit beam (spatial filter/setting); and a second RNTI (e.g., a second RA-RNTI) associated with/based on transmission of the random access preamble via the second transmit beam (spatial filter/setting). At 3530, the wireless device may monitor, in a time window, a control channel for the first RNTI (e.g., the first RA-RNTI) and the second RNTI (e.g., the second RA-RNTI). At 3540, the wireless device may receive, in response to the monitoring, a random access response (RAR) that is associated with one of the first RNTI (e.g., the first RA-RNTI) and the second RNTI (e.g., the second RA-RNTI). At 3550, the wireless device may determine, based on the RNTI (e.g., the RA-RNTI) associated with the received RAR, one of the first transmit beam (spatial filter/setting) and the second transmit beam (spatial filter/setting) for a subsequent uplink transmission. At 3560, the wireless device may transmit the subsequent uplink transmission based on/via the determined uplink beam (spatial filter/setting).

In an example embodiment, the random access process, in 3510, may of a first type. A random access process of a first type may comprise multiple random access preamble transmissions in response to initiating the random access process. A random access process of a first type may comprise multiple random access preamble transmissions in a random access preamble transmission attempt. A random access process of a first type may comprise multiple random access preamble transmissions for each preamble transmission counter value.

In an example embodiment, the time window, in 3530, may be a RAR window.

In an example embodiment, the first transmit beam (e.g., the first spatial filter/setting) may be associated with a first identifier/index and the second transmit beam (e.g., the second spatial filter/setting) may be associated with a second identifier/index. The determining/calculating/computing, at 3520, the first RA-RNTI may be based on the first identifier/index and the determining/calculating/computing, at 3520, the second RNTI may be based on the second identifier/index.

In an example embodiment, the first random access occasion (and/or a first group comprising the first random access occasion) may be associated with a first identifier/index and the second random access occasion (and/or a second group comprising the second random access occasion) may be associated with a second identifier/index. The determining/calculating/computing the first RA-RNT, at 3520, may be based on the first identifier/index and the determining/calculating/computing the second RNTI, at 3520, may be based on the second identifier/index.

In an example embodiment, the random access preamble transmitted via the first transmit beam (e.g., the first spatial filter/setting) in the first random access occasion may be the same as (repetition of) the random access preamble transmitted via the second transmit beam (e.g., the second spatial filter/setting) in the second random access occasion.

In an example embodiment, the random access preamble transmitted via the first transmit beam (e.g., the first spatial filter/setting) in the first random access occasion may be different from the random access preamble transmitted via the second transmit beam (e.g., the second spatial filter/setting) in the second random access occasion.

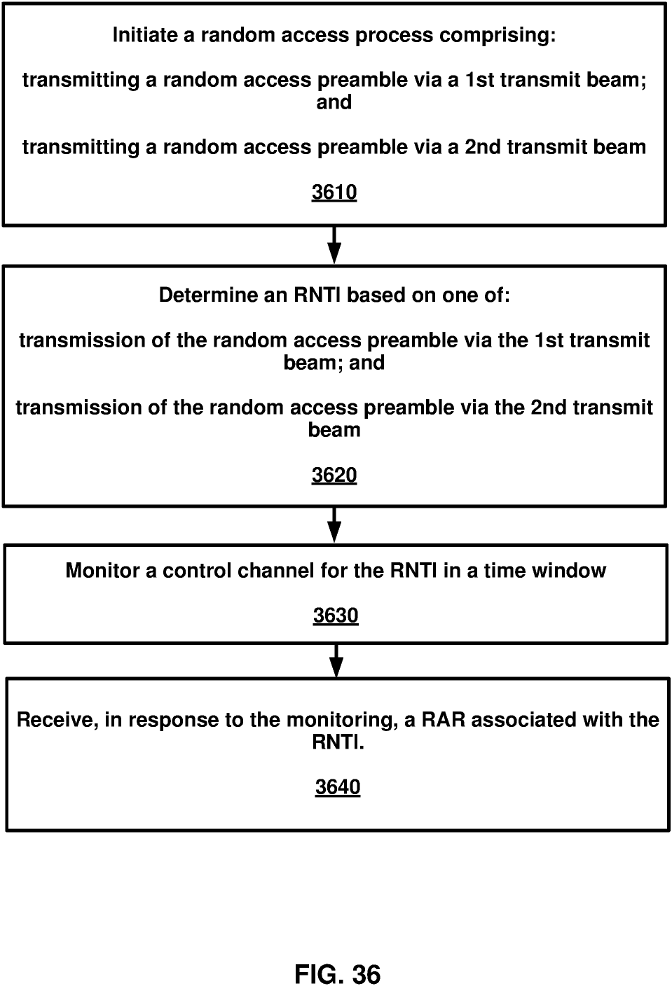

FIG. 36 shows an example flow diagram in accordance with several of various embodiments of the present disclosure. At 3610, a wireless device may initiate a random access process comprising: transmitting a random access preamble via a first transmit beam (spatial filter/setting); and transmitting a random access preamble via a second transmit beam (spatial filter/setting). At 3620, the wireless device may determine/calculate/compute an RNTI (e.g., an RA-RNTI) based on one of: transmission of the random access preamble via the first transmit beam (spatial filter/setting); and transmission of the random access preamble via the second transmit beam (spatial filter/setting). At 3630, the wireless device may monitor a control channel for the RNTI (e.g., the RA-RNTI) in a time window. At 3640, the wireless device may receive, in response to the monitoring, a random access response (RAR) associated with the RA-RNTI.

In an example embodiment, the RNTI (e.g., the RA-RNTI), determined/calculated/computed at 3620, may be associated with a bundle/group of random access occasions.

In an example embodiment, the monitoring the control channel, at 3630, may be in response to (e.g., after e.g., in a first/earliest downlink control channel occasion after) the transmitting the random access preamble via the first transmit beam (e.g., the first spatial filter/setting) at 3610 and the transmitting the random access preamble via the second transmit beam (e.g., the second spatial filter/setting) at 3610. The monitoring the control channel may not be before transmitting both of the random access preamble via the first transmit beam (e.g., the first spatial filter/setting) and the random access preamble via the second transmit beam (e.g., the second spatial filter/setting). The monitoring the control channel may only be after transmitting the random access preamble via the first transmit beam (e.g., the first spatial filter/setting) and the transmitting the random access preamble via the second transmit beam (e.g., the second spatial filter/setting).

In an example embodiment, a first random access occasion used for transmission of the random access preamble via the first transmit beam (e.g., the first spatial filter/setting) may be earlier than a second random access occasion used for transmission of the random access preamble via the second transmit beam (e.g., the second spatial filter/setting). The monitoring the control channel, at 3630, may be in response to (e.g., after e.g., in a first/earliest downlink control channel occasion after) transmitting the random access preamble via the first transmit beam (spatial filter/setting).

In an example embodiment, the random access preamble transmitted via the first transmit beam at 3610 may be the same as (e.g., repetition of) the random access preamble transmitted via the second transmit beam at 3610.

In an example embodiment, the random access preamble transmitted via the first transmit beam at 3610 may be different from the random access preamble transmitted via the second transmit beam at 3610.

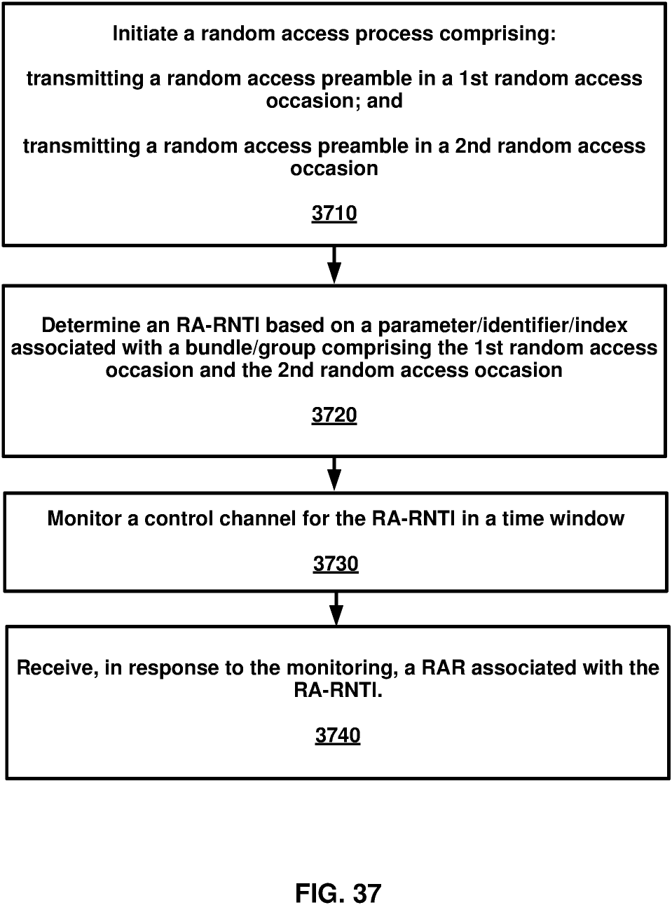

FIG. 37 shows an example flow diagram in accordance with several of various embodiments of the present disclosure. At 3710, a wireless device may initiate a random access process comprising: transmitting a random access preamble in a first random access occasion; and transmitting a random access preamble in a second random access occasion. At 3720, the wireless device may determine/calculate/compute a random access radio network temporary identifier (RA-RNTI) based on a parameter/identifier/index associated with a bundle/group comprising the first random access occasion and the second random access occasion. At 3730, the wireless device may monitor a control channel for the RA-RNTI in a time window. At 3740, the wireless device may receive, in response to the monitoring, a random access response (RAR) associated with the RA-RNTI.

In an example embodiment, the monitoring the control channel, at 3730, may be in response to (e.g., after e.g., in a first/earliest downlink control channel occasion after) transmitting the random access preamble in the first random access occasion and the random access preamble in the second random access occasion. The monitoring the control channel may not be before transmitting both of the random access preamble in the first random access occasion and the random access preamble in the second random access occasion. The monitoring the control channel may only be after transmitting the random access preamble in the first random access occasion and the random access preamble in the second random access occasion.

In an example embodiment, the random access preamble transmitted in the first random access occasion at 3710 may be the same as (e.g., repetition of) the random access preamble transmitted in the second random occasion at 3710.

In an example embodiment, the random access preamble transmitted in the first random access occasion at 3710 may be different from the random access preamble transmitted in the second random occasion at 3710.

In an example embodiment, the random access preamble transmitted in the first random access occasion at 3710 may be via a first transmit beam (e.g., a first spatial filter/setting) and the random access preamble transmitted in the second random occasion at 3710 may be via a second transmit beam (e.g., a second spatial filter/setting).

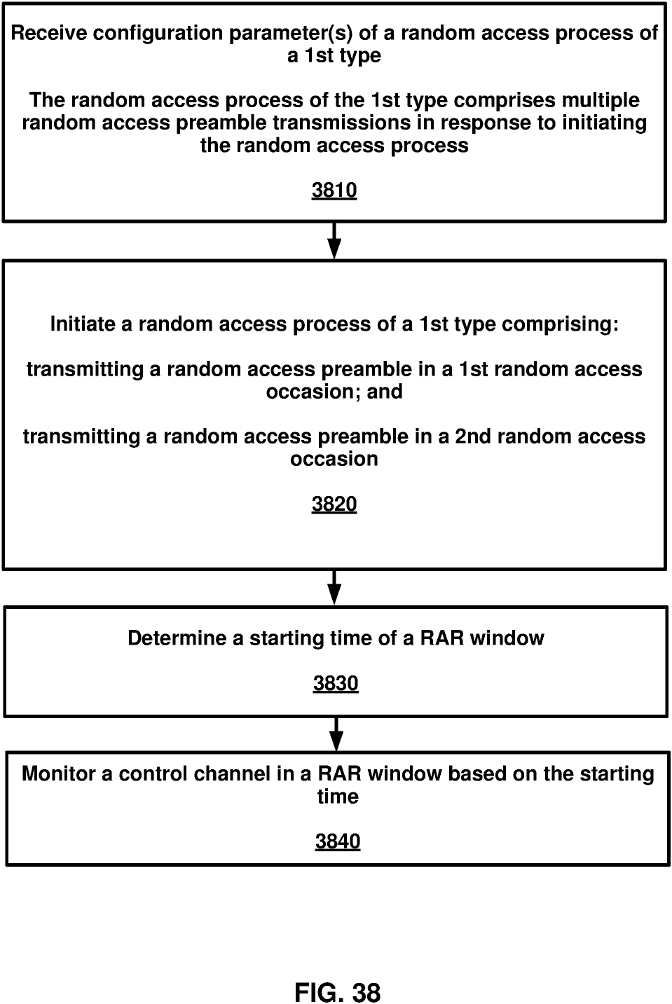

FIG. 38 shows an example flow diagram in accordance with several of various embodiments of the present disclosure. At 3810, a wireless device may receive one or more configuration parameters of a random access process of a first type. The random access process of the first type may comprise multiple random access preamble transmissions in response to initiating the random access process. The random access process of the first type may comprise multiple random access preamble transmissions in a random access preamble transmission attempt. The random access process of the first type may comprise multiple random access preamble transmissions for each preamble transmission counter value. At 3820, the wireless device may initiate a random access process of the first type comprising: transmitting a random access preamble in a first random access occasion; and transmitting a random access preamble in a second random access occasion. At 3830, the wireless device may determine a starting time of a random access response window. At 3840, the wireless device may monitor a control channel in the random access response window based on the starting time.

In an example embodiment, the one or more configuration parameters, received at 3810, may comprise a first parameter indicating a duration of the random access response window.

In an example embodiment, the starting time, determined at 3830, may be in a first/earliest control channel occasion after the earlier of the first random access occasion and the second random access occasion.

In an example embodiment, the starting time, determined at 3830, may be in a first/earliest control channel occasion after the later of the first random access occasion and the second random access occasion.

In an example embodiment, the transmitting the random access preamble in the first random access occasion, at 3810, may be via a first transmit beam (e.g., a first spatial filter/setting). The transmitting the random access preamble in the second random access occasion, at 3810, may be via a second transmit beam (e.g., a second spatial filter/setting). In an example embodiment, the starting time, determined at 3830, may be based on the first transmit beam (e.g., the first spatial filter/setting), used for transmission of the random access preamble in the first random access occasion, and the second transmit beam (e.g., the second spatial filter/setting) used for transmission of the random access preamble in the second random access occasion. In an example embodiment, the starting time, determined at 3810, may be in a first /earliest control channel occasion after the first random access occasion based on one or more parameters/criteria associated with the first transmit beam (e.g., the first spatial filter/setting) used for transmission of the random access preamble in the first random access occasion. In an example embodiment, the one or more parameters/criteria associated with the first transmit beam (e.g., the first spatial filter/setting) may be based on an identifier/index of the first transmit beam (e.g., the first spatial filter/setting).

In an example embodiment, the random access preamble transmitted in the first random access occasion, at 3820, may be the same as (e.g., repetition of) the random access preamble transmitted in the second random occasion at 3820.

In an example embodiment, the random access preamble transmitted in the first random access occasion, at 3820, may be different from the random access preamble transmitted in the second random occasion at 3820.

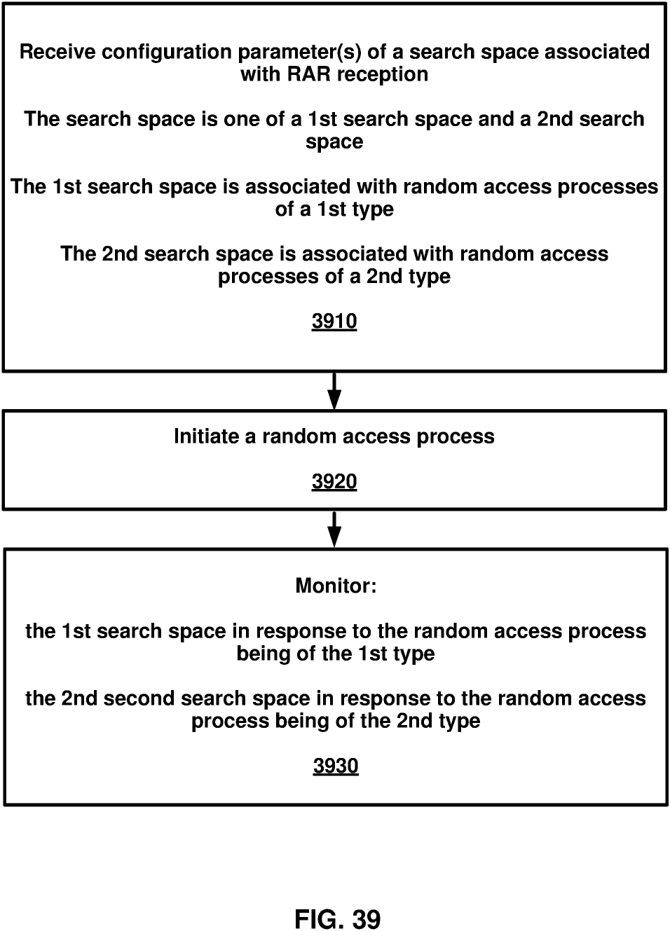

FIG. 39 shows an example flow diagram in accordance with several of various embodiments of the present disclosure. At 3910, a wireless device may receive one or more configuration parameters of a search space associated with random access response reception. The search space may be one of a first search space and a second search space. The first search space may be associated with random access processes of a first type. The second search space may be associated with random access processes of a second type. At 3920, the wireless device may initiate a random access process. At 3930, the wireless device may monitor: the first search space in response to the random access process being of the first type; and the second search space in response to the random access process being of the second type.

In an example embodiment, the first search space and the second search space may be common search spaces.

In an example embodiment, the search space may be a random access response search space.

In an example embodiment, a random access process of a first type may comprise multiple random access preamble transmissions in response to initiating the random access process. A random access process of a first type may comprise multiple random access preamble transmissions in a random access preamble transmission attempt. A random access process of a first type may comprise multiple random access preamble transmissions for each preamble transmission counter value. A random access process of a second type may comprise a single random access preamble transmission in response to initiating the random access process. A random access process of a second type may comprise a single random access preamble transmission in a random access preamble transmission attempt. A random access process of a second type may comprise a single random access preamble transmission for each preamble transmission counter value.

In an example embodiment, the wireless device may transmit a capability message comprising one or more capability IEs indicating whether the wireless device is capable of the first type of random access process comprising transmitting multiple random access preambles after initiating the random access process (and/or before monitoring for a random access response). In an example embodiment, the one or more capability IEs may indicate that the wireless device is capable of the first type of random access process. The random access process may comprise transmitting multiple random access preambles after initiating the random access process. The monitoring may be for the first search space.

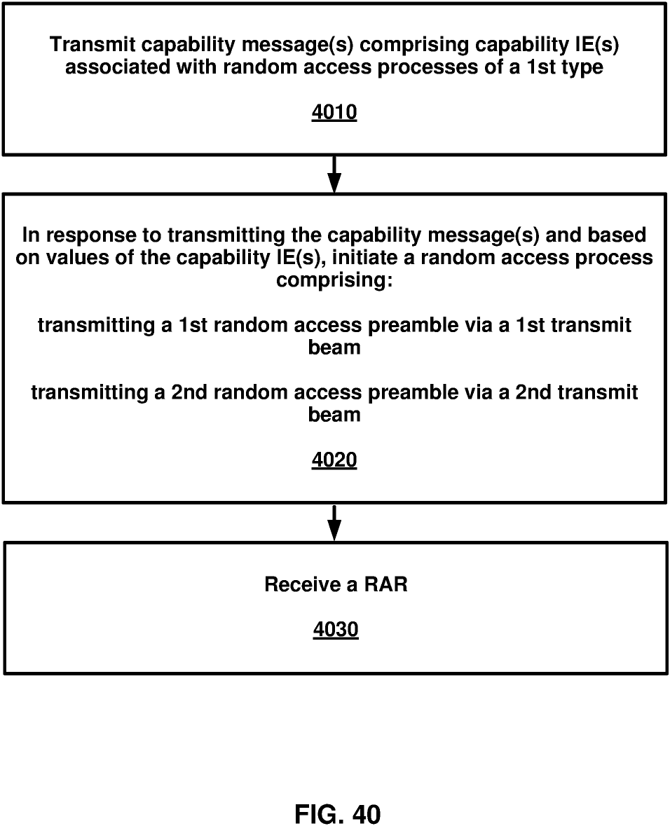

FIG. 40 shows an example flow diagram in accordance with several of various embodiments of the present disclosure. At 4010, a wireless device may transmit one or more capability messages comprising one or more capability information elements (IEs) associated with random access processes of a first type. At 4020, in response to transmitting the one or more capability messages and based on values of the one or more capability IEs, initiating a random access process comprising: transmitting a first random access preamble via a first uplink beam (spatial filter/setting); and transmitting a second random access preamble via a second uplink beam (spatial filter/setting). At 4030, the wireless device may receive a random access response.

In an example embodiment, a random access process of a first type may comprise multiple random access preamble transmissions in response to initiating the random access process. A random access process of a first type may comprise multiple random access preamble transmissions in a random access preamble transmission attempt. A random access process of a first type may comprise multiple random access preamble transmissions for each preamble transmission counter value.

In an example embodiment, the values of the one or more capability IEs, transmitted at 4010, may indicate that the wireless device is capable of the random access processes of the first type. In an example embodiment, the wireless device may receive one or more random access configuration parameters associated with the random access processes of the first type in response to the one or more capability IEs, transmitted at 4010, indicating that the wireless device is capable of the random access processes of the first type. In an example embodiment, the wireless device may receive one or more configuration parameters of a random access response search space used in reception of control information associated with random access response in random access processes of the first type in response to the one or more capability IEs indicating that the wireless device is capable of the random access processes of the first type.

In an example embodiment, the one or more values of the one or more capability IEs, transmitted at 4010, may indicate that the wireless device is capable of supporting a random access response search space for reception of control information associated with random access response in random access processes of the first type. In an example embodiment, the one or more values of the one or more capability IEs may indicate that the wireless device is capable of multiple random access response search spaces. In an example embodiment, the multiple random access response search spaces may comprise: a first random access response search space for reception of control information associated with random access response in random access processes of the first type; and a second random access response search space for reception of control information associated with random access response in random access processes of a second type. In an example embodiment, a random access process of a second type may comprise a single random access preamble transmission in response to initiating the random access process. A random access process of a second type may comprise a single random access preamble transmission in a random access preamble transmission attempt. A random access process of a second type may comprise a single random access preamble transmission for each preamble transmission counter value. In an example embodiment, the wireless device may receive one or more configuration parameters of a random access response search space used in reception of control information associated with random access response in random access processes of the first type in response to the one or more capability IEs indicating that the wireless device is capable of supporting a random access response search space for reception of control information associated with random access response in random access processes of the first type.

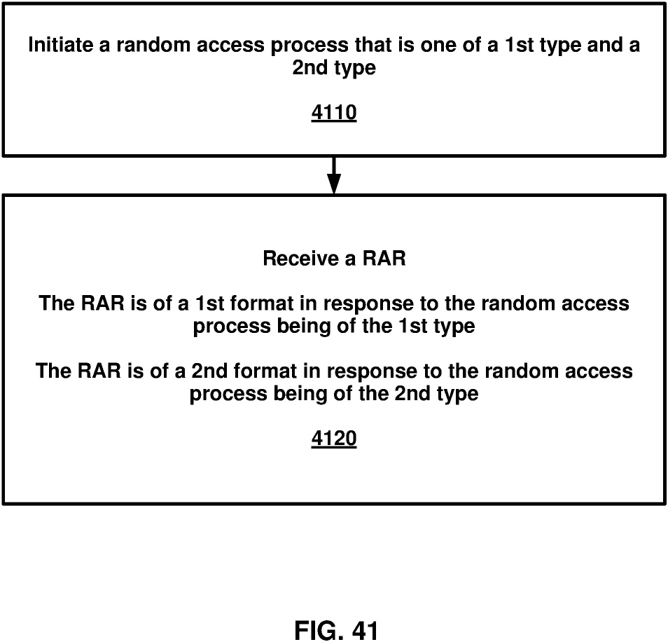

FIG. 41 shows an example flow diagram in accordance with several of various embodiments of the present disclosure. At 4110, a wireless device may initiate a random access process that is of one of a first type and a second type. At 4120, the wireless device may receive a random access response (RAR). The RAR may be of a first format in response to the random access process being of the first type. The RAR may be of a second format in response to the random access process being of the second type.

In an example embodiment, a random access process of a first type may comprise multiple random access preamble transmissions in response to initiating the random access process. A random access process of a first type may comprise multiple random access preamble transmissions in a random access preamble transmission attempt. A random access process of a first type may comprise multiple random access preamble transmissions for each preamble transmission counter value. A random access process of a second type may comprise a single random access preamble transmission in response to initiating the random access process. A random access process of a second type may comprise a single random access preamble transmission in a random access preamble transmission attempt. A random access process of a second type may comprise a single random access preamble transmission for each preamble transmission counter value.

In an example embodiment, a first number of fields in the RAR of the first format may be different from a second number of fields in the RAR of the second format.

In an example embodiment, a first number of bits in the RAR of the first format may be different from a second number of bits in the RAR of the second format.

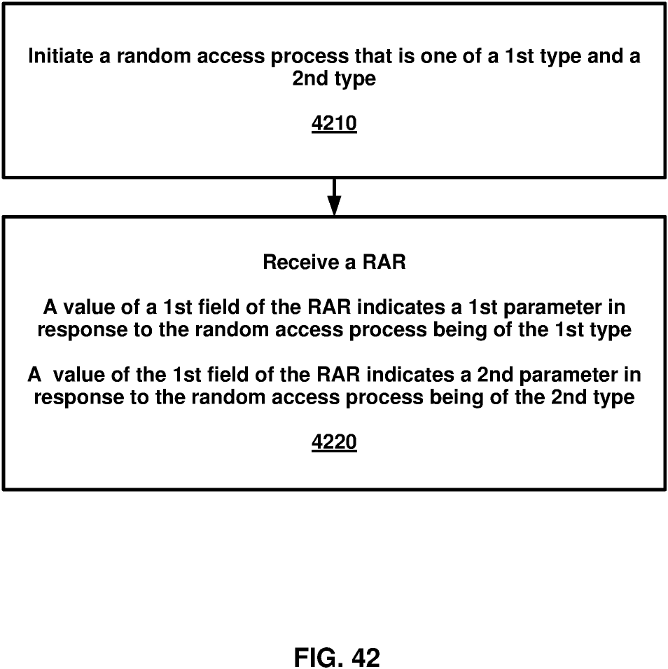

FIG. 42 shows an example flow diagram in accordance with several of various embodiments of the present disclosure. At 4210, a wireless device may initiate a random access process that is of one of a first type and a second type. At 4220, the wireless device may receive a random access response (RAR). A value of a first field of the RAR may indicate a first parameter in response to the random access process being of the first type. A value of the first field of the RAR may indicate a second parameter and/or may not indicate the first parameter in response to the random access process being of the second type (e.g., not being of the first type).

In an example embodiment, a random access process of a first type may comprise multiple random access preamble transmissions in response to initiating the random access process. A random access process of a first type may comprise multiple random access preamble transmissions in a random access preamble transmission attempt. A random access process of a first type may comprise multiple random access preamble transmissions for each preamble transmission counter value.

In an example embodiment, a random access process of a second type may comprise a single random access preamble transmission in response to initiating the random access process. A random access process of a second type may comprise a single random access preamble transmission in a random access preamble transmission attempt. A random access process of a second type may comprise a single random access preamble transmission for each preamble transmission counter value.

In an example embodiment, the first field of the RAR, received at 4220, may be a frequency hopping flag field. In an example embodiment, the second parameter may be a frequency hopping flag.

In an example embodiment, the first field of the RAR, received at 4220, may be a frequency resource allocation field. In an example embodiment, the second parameter may be a frequency resource allocation.

In an example embodiment, the first field of the RAR, received at 4220, may be a time resource allocation field. In an example embodiment, the second parameter may be a time resource allocation.

In an example embodiment, the first field of the RAR, received at 4220, may be a modulation and coding scheme field. In an example embodiment, the second parameter may be a modulation and coding scheme indication.

In an example embodiment, the first field of the RAR, received at 4220, may be a transmit power control field. In an example embodiment, the second parameter may be a transmit power control command.

In an example embodiment, the first field of the RAR, received at 4220, may be a channel state information (CSI) request field. In an example embodiment, the second parameter may be a CSI request indication.

In an example embodiment, the first parameter may be an indication of transmit beam (spatial setting/filter) for a subsequent uplink transmission.

In an example embodiment, one or more bits of the first field of the RAR, received at 4220, may indicate the first parameter in response to the random access process being of the first type. In an example embodiment, the one or more bits may be one or more most significant bits of the first field. In an example embodiment, the one or more bits may be one or more least significant bits of the first field.

Various exemplary embodiments of the disclosed technology are presented as example implementations and/or practices of the disclosed technology. The exemplary embodiments disclosed herein are not intended to limit the scope. Persons of ordinary skill in the art will appreciate that various changes can be made to the disclosed embodiments without departure from the scope. After studying the exemplary embodiments of the disclosed technology, alternative aspects, features and/or embodiments will become apparent to one of ordinary skill in the art. Without departing from the scope, various elements or features from the exemplary embodiments may be combined to create additional embodiments. The exemplary embodiments are described with reference to the drawings. The figures and the flowcharts that demonstrate the benefits and/or functions of various aspects of the disclosed technology are presented for illustration purposes only. The disclosed technology can be flexibly configured and/or reconfigured such that one or more elements of the disclosed embodiments may be employed in alternative ways. For example, an element may be optionally used in some embodiments or the order of actions listed in a flowchart may be changed without departure from the scope.

An example embodiment of the disclosed technology may be configured to be performed when deemed necessary, for example, based on one or more conditions in a wireless device, a base station, a radio and/or core network configuration, a combination thereof and/or alike. For example, an example embodiment may be performed when the one or more conditions are met. Example one or more conditions may be one or more configurations of the wireless device and/or base station, traffic load and/or type, service type, battery power, a combination of thereof and/or alike. In some scenarios and based on the one or more conditions, one or more features of an example embodiment may be implemented selectively.

In this disclosure, the articles “a” and “an” used before a group of one or more words are to be understood as “at least one” or “one or more” of what the group of the one or more words indicate. The use of the term “may” before a phrase is to be understood as indicating that the phrase is an example of one of a plurality of useful alternatives that may be employed in an embodiment in this disclosure.

In this disclosure, an element may be described using the terms “comprises”, “includes” or “consists of” in combination with a list of one or more components. Using the terms “comprises” or “includes” indicates that the one or more components are not an exhaustive list for the description of the element and do not exclude components other than the one or more components. Using the term “consists of” indicates that the one or more components is a complete list for description of the element. In this disclosure, the term “based on” is intended to mean “based at least in part on”. The term “based on” is not intended to mean “based only on”. In this disclosure, the term “and/or” used in a list of elements indicates any possible combination of the listed elements. For example, “X, Y, and/or Z” indicates X; Y; Z; X and Y; X and Z; Y and Z; or X, Y, and Z.

Some elements in this disclosure may be described by using the term “may” in combination with a plurality of features. For brevity and ease of description, this disclosure may not include all possible permutations of the plurality of features. By using the term “may” in combination with the plurality of features, it is to be understood that all permutations of the plurality of features are being disclosed. For example, by using the term “may” for description of an element with four possible features, the element is being described for all fifteen permutations of the four possible features. The fifteen permutations include one permutation with all four possible features, four permutations with any three features of the four possible features, six permutations with any two features of the four possible features and four permutations with any one feature of the four possible features.

Although mathematically a set may be an empty set, the term set used in this disclosure is a nonempty set. Set B is a subset of set A if every element of set B is in set A. Although mathematically a set has an empty subset, a subset of a set is to be interpreted as a non-empty subset in this disclosure. For example, for set A={subcarrier1, subcarrier2}, the subsets are {subcarrier1}, {subcarrier2} and {subcarrier1, subcarrier2}.

In this disclosure, the phrase “based on” may be used equally with “based at least on” and what follows “based on” or “based at least on” indicates an example of one of plurality of useful alternatives that may be used in an embodiment in this disclosure. The phrase “in response to” may be used equally with “in response at least to” and what follows “in response to” or “in response at least to” indicates an example of one of plurality of useful alternatives that may be used in an embodiment in this disclosure. The phrase “depending on” may be used equally with “depending at least on” and what follows “depending on” or “depending at least on” indicates an example of one of plurality of useful alternatives that may be used in an embodiment in this disclosure. The phrases “employing” and “using” and “employing at least” and “using at least” may be used equally in this in this disclosure and what follows “employing” or “using” or “employing at least” or “using at least” indicates an example of one of plurality of useful alternatives that may be used in an embodiment in this disclosure.

The example embodiments disclosed in this disclosure may be implemented using a modular architecture comprising a plurality of modules. A module may be defined in terms of one or more functions and may be connected to one or more other elements and/or modules. A module may be implemented in hardware, software, firmware, one or more biological elements (e.g., an organic computing device and/or a neurocomputer) and/or a combination thereof and/or alike. Example implementations of a module may be as software code configured to be executed by hardware and/or a modeling and simulation program that may be coupled with hardware. In an example, a module may be implemented using general-purpose or special-purpose processors, digital signal processors (DSPs), microprocessors, microcontrollers, application-specific integrated circuits (ASICs), programmable logic devices (PLDs) and/or alike. The hardware may be programmed using machine language, assembly language, high-level language (e.g., Python, FORTRAN, C, C++ or the like) and/or alike. In an example, the function of a module may be achieved by using a combination of the mentioned implementation methods.

What is claimed is:

1. A method comprising:
receiving, by a wireless device, one or more configuration parameters indicating that a first random access occasion and a second random access occasion are used jointly in a random access process;
in response to initiating the random access process and based on the one or more configuration parameters indicating that the first random access occasion and the second random access occasion are used jointly in the random access process:
transmitting a random access preamble in the first random access occasion; and
transmitting a random access preamble in the second random access occasion; and
receiving a random access response.

2. The method of claim 1, wherein the transmitting the random access preamble in the first random access occasion and the transmitting the random access preamble in the second random access occasion are via the same transmit beam.

3. The method of claim 1, wherein the first random access occasion and the second random access occasion are in the same random access occasion group.

4. The method of claim 3, wherein:
the random access occasion group comprises a plurality of random access occasions comprising the first random access occasion and the second random access occasion; and
the configuration parameters indicate the plurality of random access occasions in the random access occasion group.

5. The method of claim 1, wherein the random access preamble transmitted in the first random access occasion is the same as the random access preamble transmitted in the second random access occasion.

6. The method of claim 1, wherein:
the first random access occasion is associated with a first transmit beam; and
the second random access occasion is associated with a second transmit beam.

7. The method of claim 6, wherein the one or more configuration parameters indicate that:
the first random access occasion is associated with a first transmit beam; and
the second random access occasion is associated with a second transmit beam.

8. The method of claim 6, wherein:
the first transmit beam is associated with a first identifier; and
the second transmit beam is associated with a second identifier.

9. The method of claim 8, wherein the one or more configuration parameters indicate that:
the first transmit beam is associated with a first identifier; and
the second transmit beam is associated with a second identifier.

10. The method of claim 1, wherein the first random access occasion and the second random access occasion are at different time instances.

11. A wireless device comprising:
one or more processors; and
memory storing instructions that, when executed by the one or more processors, cause the wireless device to:
receive one or more configuration parameters indicating that a first random access occasion and a second random access occasion are used jointly in a random access process;
in response to initiating the random access process and based on the one or more configuration parameters indicating that the first random access occasion and the second random access occasion are used jointly in the random access process:
transmit a random access preamble in the first random access occasion; and
transmit a random access preamble in the second random access occasion; and
receive a random access response.

12. The wireless device of claim 11, wherein the transmitting the random access preamble in the first random access occasion and the transmitting the random access preamble in the second random access occasion are via the same transmit beam.

13. The wireless device of claim 11, wherein the first random access occasion and the second random access occasion are in the same random access occasion group.

14. The wireless device of claim 13, wherein:
the random access occasion group comprises a plurality of random access occasions comprising the first random access occasion and the second random access occasion; and
the configuration parameters indicate the plurality of random access occasions in the random access occasion group.

15. The wireless device of claim 11, wherein the random access preamble transmitted in the first random access occasion is the same as the random access preamble transmitted in the second random access occasion.

16. The wireless device of claim 11, wherein:
the first random access occasion is associated with a first transmit beam; and
the second random access occasion is associated with a second transmit beam.

17. The wireless device of claim 16, wherein the one or more configuration parameters indicate that:
the first random access occasion is associated with a first transmit beam; and
the second random access occasion is associated with a second transmit beam.

18. The wireless device of claim 16, wherein:
the first transmit beam is associated with a first identifier; and
the second transmit beam is associated with a second identifier.

19. The wireless device of claim 11, wherein the first random access occasion and the second random access occasion are at different time instances.

20. A system comprising:
a base station; and
a wireless device comprising: one or more processors; and memory storing instructions that, when executed by the one or more processors, cause the wireless device to: receive, from the base station, one or more configuration parameters indicating that a first random access occasion and a second random access occasion are used jointly in a random access process; in response to initiating the random access process and based on the one or more configuration parameters indicating that the first random access occasion and the second random access occasion are used jointly in the random access process: transmit a random access preamble in the first random access occasion; and transmit a random access preamble in the second random access occasion; and receive a random access response.
